(19) United States
(12) Patent Application Publication
(10) Pub. No.: US 2023/0249351 A1
(43) Pub. Date: Aug. 10, 2023

(54) FASTENER SYSTEM AND METHOD

(71) Applicant: Transportation IP Holdings, LLC, Norwalk, CT (US)

(72) Inventors: Huan Tan, Niskayuna, NY (US); John Michael Lizzi, Wilton, NY (US); Charles Burton Theurer, Alplaus, NY (US); Balajee Kannan, Niskayuna, NY (US); Romano Patrick, Atlanta, GA (US); Mark Bachman, Albia, IA (US); Michael VanderLinden, Knoxville, IA (US); Mark Bradshaw Kraeling, Melbourne, FL (US); Norman Wellings, Agency, IA (US); Eric Kuiper, Norwalk, CT (US); Dan Derosia, Norwalk, CT (US); Julio Payan, Norwalk, CT (US); James Maki, Norwalk, CT (US); Matthew Orvedahl, Caledonia, WI (US); Ozan Emsun, Milwaukee, WI (US); Mark David, Milwaukee, WI (US)

(21) Appl. No.: 18/299,517

(22) Filed: Apr. 12, 2023

Related U.S. Application Data
Application No. 17/461,930 is a continuation-in-part of application No. 16/692,784, filed on Nov. 22, 2019, now Pat. No. 11,312,018.
Application No. 16/692,784 is a continuation-in-part of application No. 16/411,788, filed on May 14, 2019, now Pat. No. 11,358,615.
Application No. 16/411,788 is a continuation-in-part of application No. 16/379,976, filed on Apr. 10, 2019, now Pat. No. 11,660,756.
Application No. 16/379,976 is a continuation-in-part of application No. 16/114,318, filed on Aug. 28, 2018, now Pat. No. 10,300,601.
Application No. 16/114,318 is a continuation-in-part of application No. 15/198,673, filed on Jun. 30, 2016, now Pat. No. 10,065,317.
Application No. 15/198,673 is a continuation-in-part of application No. 15/399,313, filed on Jan. 5, 2017, now Pat. No. 10,493,629.
Application No. 15/399,313 is a continuation-in-part of application No. 15/183,850, filed on Jun. 16, 2016, now Pat. No. 10,105,844.
Application No. 15/183,850 is a continuation-in-part of application No. 15/872,582, filed on Jan. 16, 2018, now Pat. No. 10,739,770.
Application No. 15/872,582 is a continuation-in-part of application No. 15/809,515, filed on Nov. 10, 2017, now abandoned.
Application No. 15/809,515 is a continuation-in-part of application No. 15/804,767, filed on Nov. 6, 2017, now Pat. No. 10,761,526.
Application No. 15/804,767 is a continuation-in-part of application No. 15/585,502, filed on May 3, 2017, now Pat. No. 10,521,960.
Application No. 15/585,502 is a continuation-in-part of application No. 15/587,950, filed on May 5, 2017, now Pat. No. 10,633,093.
Application No. 15/587,950 is a continuation-in-part of application No. 15/473,384, filed on Mar. 29, 2017, now Pat. No. 10,518,411.
Application No. 15/473,384 is a continuation-in-part of application No. 14/541,370, filed on Nov. 14, 2014, now Pat. No. 10,110,795.
Application No. 14/541,370 is a continuation-in-part of application No. 15/584,995, filed on May 2, 2017, now abandoned.
Application No. 15/584,995 is a continuation-in-part of application No. 15/473,345, filed on Mar. 29, 2017, now Pat. No. 10,618,168.
Application No. 16/114,318 is a continuation-in-part of application No. 15/058,494, filed on Mar. 2, 2016, now Pat. No. 10,093,022.
Application No. 15/058,494 is a continuation-in-part of application No. 17/815,341, filed on Jul. 27, 2022.
Application No. 17/815,341 is a continuation-in-part of application No. 17/461,930, filed on Aug. 30, 2021.
(60) Provisional application No. 62/343,615, filed on May 31, 2016.
(60) Provisional application No. 62/336,332, filed on May 13, 2016.
(60) Provisional application No. 62/269,523, filed on Dec. 18, 2015.
(60) Provisional application No. 62/269,425, filed on Dec. 18, 2015.
(60) Provisional application No. 62/269,377, filed on Dec. 18, 2015.
(60) Provisional application No. 62/269,481, filed on Dec. 18, 2015.
(60) Provisional application No. 63/072,586, filed on Aug. 31, 2020.
(60) Provisional application No. 63/377,643, filed on Sep. 29, 2022.
(60) Provisional application No. 63/407,954, filed on Sep. 19, 2022.

(51) Int. Cl. B25J 9/16; G06V 20/10

(52) U.S. Cl. CPC B25J 9/1687; G06V 20/188

(57) ABSTRACT

A fastener system and method includes a controller having one or more processors that obtain image information associated with a tie plate. The tie plate includes one or more holes, and each hole is configured to receive a fastener. A fastener driving unit drives the fastener into at least one of the one or more holes. The controller controls movement of the fastener driving unit to move the fastener driving unit to a location corresponding to the at least one hole, and the controller controls movement of the fastener driving unit to drive the fastener into the at least one hole.

### CROSS-REFERENCE TO RELATED APPLICATIONS

This application is a continuation-in-part of U.S. patent application Ser. No. 17/726,594, filed 22 Apr. 2022, which is a continuation-in-part of U.S. patent application Ser. No. 16/692,784, filed 22 Nov. 2019 and issued as U.S. Pat. No. 11,312,018 on 26 Apr. 2022, which is a continuation-in-part of U.S. patent application Ser. No. 16/411,788, filed 14 May 2019 and issued as U.S. Pat. No. 11,358,615 on 14 Jun. 2022, which is a continuation-in-part of U.S. patent application Ser. No. 16/379,976, filed 10 Apr. 2019, which is a continuation of U.S. patent application Ser. No. 16/114,318 (“the '318 application”), filed on 28 Aug. 2018 and issued as U.S. Pat. No. 10,300,601 on 25 May 2019.

The '318 application is a continuation-in-part of patented U.S. application Ser. No. 15/198,673, filed on 30 Jun. 2016 and issued as U.S. Pat. No. 10,065,317 on 4 Sep. 2018; and is a continuation-in-part of U.S. application Ser. No. 15/399,313, filed on 5 Jan. 2017 and issued as U.S. Pat. No. 10,493,629 on 3 Dec. 2019; and is a continuation-in-part of U.S. application Ser. No. 15/183,850, filed on 16 Jun. 2016 and issued as U.S. Pat. No. 10,105,844 on 23 Oct. 2018; and is a continuation-in-part of U.S. application Ser. No. 15/872,582, filed on 16 Jan. 2018 and issued as U.S. Pat. No. 10,739,770 on 11 Aug. 2020; and is a continuation-in-part of abandoned U.S. application Ser. No. 15/809,515, filed on 10 Nov. 2017; and is a continuation-in-part of U.S. application Ser. No. 15/804,767, filed on 6 Nov. 2017 and issued as U.S. Pat. No. 10,761,526 on 1 Sep. 2020; and is a continuation-in-part of U.S. application Ser. No. 15/585,502, filed on 3 May 2017 and issued as U.S. Pat. No. 10,521,960 on 31 Dec. 2019; and is a continuation-in-part of U.S. application Ser. No. 15/587,950, filed on 5 May 2017 and issued as U.S. Pat. No. 10,633,093 on 28 Apr. 2020; and is a continuation-in-part of U.S. application Ser. No. 15/473,384, filed on 29 Mar. 2017 and issued as U.S. Pat. No. 10,518,411 on 31 Dec. 2019; and is a continuation-in-part of patented U.S. application Ser. No. 14/541,370, filed on 14 Nov. 2014 and issued as U.S. Pat. No. 10,110,795 on 23 Oct. 2018; and is a continuation-in-part of U.S. application Ser. No. 15/584,995, filed on 2 May 2017; and is a continuation-in-part of U.S. application Ser. No. 15/473,345, filed on 29 Mar. 2017 and issued as U.S. Pat. No. 10,618,168 on 14 Apr. 2020, which claims priority to U.S. Provisional Application No. 62/343,615, filed on 31 May 2016 and to U.S. Provisional Application No. 62/336,332, filed on 13 May 2016.

The '318 application is also a continuation-in-part of U.S. application Ser. No. 15/058,494, filed on 2 Mar. 2016 and issued as U.S. Pat. No. 10,093,022 on 9 Oct. 2018, which claims priority to U.S. Provisional Application Nos. 62/269,523, 62/269,425, 62/269,377, and 62/269,481, all of which were filed on 18 Dec. 2015.

This application is also a continuation-in-part of U.S. patent application Ser. No. 17/815,341, filed 27 Jul. 2022, which is a continuation-in-part of U.S. application Ser. No. 17/461,930, filed on 30 Aug. 2021, which claims priority to U.S. Provisional Application No. 63/072,586, filed on 31 Aug. 2020.

This application also claims priority to U.S. Provisional Application No. 63/377,643, filed on 29 Sep. 2022.

This application also claims priority to U.S. Provisional Application No. 63/407,954, filed on 19 Sep. 2022.

All the applications above are herein incorporated by reference in their entireties, including the drawings, for all purposes.

### BACKGROUND

### Technical Field

The subject matter described herein may relates to a system for performing tasks, such as maintenance tasks, positioning and/or fastening operations and associated methods.

### Discussion of Art

In some situations, the use of human operators may be undesirable but automated systems may pose problems as well. It may be desirable to have a system that differs from those systems that are currently available.

In some situations, vegetation growth is a dynamic aspect for routes such as paths, tracks, roads, etc. Over time, vegetation may grow in such a way as to interfere with travel over the route and must be managed. Vegetation management may be time and labor intensive. For both in-vehicle and wayside camera systems, these camera systems may capture information relating to the state of vegetation relative to a route, but that information is not actionable. It may be desirable to have a system and method for vegetation control that differs from those that are currently available.

In some situations, spikes have been used to secure tie plates to rail ties. Various types may include cut spikes, lag screws, hairpin spikes, and other types of rail fasteners. During railroad maintenance work, old rail fasteners may be removed to facilitate replacement of rail ties, tie plates, or rails. Once the desired maintenance is complete, the rail fasteners may be reinstalled. Such rail fastener driving machines may include a frame which is either self-propelled or towable along a track, a rail fastener driving apparatus with a fastener driving mechanism such as a fluid power cylinder provided with a reciprocating element for impacting a fastener and driving it into a tie, a fastener magazine that may accommodate a plurality of rail fasteners and feeding them sequentially for driving by the element, and a fastener feeder mechanism that may convey fasteners sequentially from the magazine to a location in operational relationship to the driving element.

An operator located in a cab on the frame may control the movement of the fastener driving mechanism using a control apparatus. Controlling the movement of the fastener driving mechanism can include, for instance, visually detecting the location of a target area, such as an area that includes a designated hole in the tie plate, positioning the fastener driving mechanism over the target area, such as by moving the entire rail fastener driving machine over the target area as a gross adjustment, and then using a fine adjustment such as a spotting carriage. The operator can then trigger an application process so that the fastener is properly driven into the wooden tie through the hole in the tie plate. The operator may have to accurately position the rail fastener driving machine over the target area, which may include moving the driving machine over forward and/or reverse directions several times. This increases cycle time, reducing operator productivity. It may be desirable to have a system and method that differs from those that are currently available.

In some situations, rail vehicles may be equipped with positioning systems that include hydraulic hammers used to drive railroad spikes into apertures or holes of plates disposed along the rail track. A first hydraulic hammer may drive fasteners into holes disposed on a first side of a first rail of a track, and a second hydraulic hammer may drive fasteners into holes on disposed on a second side of the first rail of the track. A cylinder may control spacing of the first hydraulic hammer from the second hydraulic hammer. Movement of the first hydraulic hammer may cause movement of the second hydraulic hammer. It may be desirable to have a positioning system and method that is different than existing positioning systems and methods.

### BRIEF DESCRIPTION

According to one embodiment or example, a system includes a task manager having one or more processors that can determine capability requirements to perform a task on a target object. The task has an associated series of sub-tasks, with the sub-tasks having one or more capability requirements. The task manager can select a first robotic machine of plural robotic machines, and assign a first sequence of sub-tasks to the first robotic machine. The first robotic machine has a first set of capabilities for interacting with the target object and operates according to a first mode of operation. The task manager can select a second robotic machine of the plural robotic machines and assign a second sequence of sub-tasks to the second robotic machine. The second robotic machine has a second set of capabilities for interacting with the target object and operates according to a second mode of operation. The task manager selects the first robotic machine based at least in part on the first set of capabilities and the first mode of operation of the first robotic machine, and selects the second robotic machine based on the second set of capabilities and the second mode of operation.

According to another embodiment or example, a method includes determining capability requirements to perform a task on a target object. The task includes an associated series of sub-tasks, with the sub-tasks having one or more capability requirements. A first robotic machine may be selected from plural robotic machines, and a first sequence of sub-tasks may be assigned to the first robotic machine. The first robotic machine has a first set of capabilities for interacting with the target object and can operate according to a first mode of operation. The first robotic machine is selected based at least in part on the first set of capabilities and the first mode of operation of the first robotic machine. A second robotic machine may be selected from plural robotic machines, and a second sequence of sub-tasks may be assigned to the second robotic machine. The second robotic machine has a second set of capabilities for interacting with the target object and can operate according to a second mode of operation. The second robotic machine is selected based at least in part on the second set of capabilities and the second mode of operation of the second robotic machine.

According to another embodiment or example, a system includes a task manager having one or more processors that can determine capability requirements to perform a task on the target object. The task has an associated series of sub-tasks, with the sub-tasks having one or more capability requirements. The system includes plural robotic machines with corresponding capability descriptions. The task manager can assign a first sequence of sub-tasks to a first robotic machine of the plural robotic machines. The first robotic machine has a first set of capabilities for interacting with the target object and operates according to a first mode of operation. The task manager can assign a second sequence of sub-tasks to a second robotic machine of the plural robotic machines. The second robotic machine has a second set of capabilities for interacting with the target object and operates according to a second mode of operation. The task manager selects the first robotic machine based at least in part on the first set of capabilities and the first mode of operation of the first robotic machine, and selects the second robotic machine based on the second set of capabilities and the second mode of operation.

According to another example or aspect, a system may include an imaging device to obtain image data from a field of view outside of a vehicle and a controller to analyze the image data and identify one or more vegetation features of a target vegetation within the field of view. The vegetation features may be one or more of a type of vegetation, a quantity of vegetation, a distance or a size of vegetation. The system may include a directed energy system to direct one or more directed energy beams toward the target vegetation responsive to the controller identifying the one or more vegetation features.

According to another example or aspect, a method may include analyzing image data from a field of view adjacent to a vehicle and determining one or more vegetation features of target vegetation within the field of view to be removed. The method may include directing one or more directed energy beams onto the target vegetation, and the one or more directed energy beams are controlled based at least in part on the one or more vegetation features.

According to another example or aspect, a system may include one or more imaging devices onboard one or more vehicles to obtain image data from one or more fields of view adjacent to the one or more vehicles and one or more controllers in communication with the one or more imaging devices to analyze the image data and determine one or more vegetation features of target vegetation within the one or more fields of view. The system may include one or more directed energy systems onboard the one or more vehicles to generate and direct one or more energy beams onto the target generation in response to the controller analysis of the vegetation features.

According to another example or aspect, a positioning system is provided that includes a first shaft, a second shaft, a first discharge device, a second discharge device, one or more first links, and one or more second links. The first shaft may be coupled with a frame of a vehicle system. The first shaft may be elongated from a first end to an opposite second end along a first axis. The second shaft may be coupled with the frame of the vehicle system. The second shaft may be elongated from a third end to a fourth end along a second axis. The first discharge device may be coupled with the first shaft and may move in at least first and second directions toward a first target location. The second discharge device may be coupled with the second shaft and may move in at least a third and fourth directions toward a second target location. The one or more first links may be operably coupled with the first discharge device. The one or more first links may control movement of the first discharge device in the first and second directions. The one or more second links may be operably coupled with the second discharge device. The one or more second links may control movement of the second discharge device in the third and fourth directions. The one or more first links may allow movement of the first discharge device in the first direction separately of movement of the first discharge device in the second direction and separately of movement of the second discharge device. The one or more second links may allow movement of the second discharge device in the third direction separately of movement of the second discharge device in the fourth direction and separately of movement of the first discharge device.

According to another example or aspect, a method is provided that includes controlling movement of a first discharge device in at least first and second directions toward a first target location. The first discharge device operably coupled with a first shaft, the first shaft may be elongated from a first end to an opposite second end along a first axis. The first shaft may be coupled with a frame of a vehicle system. The method may include controlling movement of a second discharge device in at least third and fourth directions toward a second target. The second discharge device may be operably coupled with a second shaft. The second shaft may be elongated from a third end to an opposite fourth end along a second axis. The second shaft may be coupled with the frame of the vehicle system. The first discharge device may move in the first direction separately of movement of the first discharge device in the second direction and separately of movement of the second discharge device. The second discharge device may move in the third direction separately of movement of the second discharge device in the fourth direction and separately of movement of the first discharge device.

According to another example or aspect, a positioning system for use with a frame of a vehicle system is provided. The vehicle system may move along a vehicle route and may include a means for controlling movement of a first discharge device in at least first and second directions toward a first target location with one or more first links operably coupled with the first discharge device. The first discharge device may be operably coupled with a first shaft and the one or more first links. The first shaft may be elongated from a first end to an opposite second end along a first axis and the first shaft may be coupled with a frame of a vehicle system. The system may further include a means for controlling movement of a second discharge device in at least third and fourth directions toward a second target location with one or more second links operably coupled with the second discharge device. The second discharge device may be operably coupled with a second shaft and the one or more second links. The second shaft may be elongated from a third end to an opposite fourth end along a second axis. The second shaft may be coupled with the frame of the vehicle system and the one or more first links may allow movement of the first discharge device in the first direction separately of movement of the first discharge device in the second direction and separately of movement of the second discharge device. The one or more second links may allow movement of the second discharge device in the third direction separately of movement of the second discharge device in the fourth direction and separately of movement of the first discharge device.

According to another example or aspect, a fastener system includes a controller including one or more processors configured to obtain image information associated with a tie plate. The tie plate includes one or more holes, and each of the one or more holes is configured to receive a fastener. A fastener driving unit drives the fastener into at least one of the one or more holes of the tie plate. The controller controls movement of the fastener driving unit to move the fastener driving unit to a location corresponding to the tie plate, and the controller controls movement of the fastener driving unit to drive the fastener into the at least one hole.

According to another example or aspect, a method includes obtaining image information associated with a tie plate having one or more holes. Each of the one or more holes is configured to receive a fastener. Movement of a fastener driving unit is controlled in order to move the fastener driving unit to a location corresponding to at least one hole of the one or more holes. Movement of the fastener driving unit is controlled to drive the fastener into the at least one hole of the one or more holes of the tie plate.

According to another example or aspect, a method includes initiating performance of a task on an object. The task has an associated series of sub-tasks, and the sub-tasks have one or more capability requirements. A first robotic machine is assigned a first sequent of sub-tasks within the associated series of sub-tasks. The first robotic machine operates according to a first mode of operation. A second robotic machine is assigned a second sequence of sub-tasks within the associated series of sub-tasks. The second robotic machine operates according to a second mode of operation. The first robotic machine is operated in the first mode of operation and the second robotic machine is operated in the second mode of operation. The first robotic machine may be a vehicle system, the second robotic machine is a fastener driving unit, and the target object is a tie plate. The vehicle system is configured to move the fastener driving unit towards the tie plate and the fastener driving unit is configured to drive a fastener into at least hole of the tie plate.

### BRIEF DESCRIPTION OF THE DRAWINGS

The subject matter described herein may be understood from reading the following description of non-limiting embodiments, with reference to the attached drawings, wherein below:

FIG. 1 schematically illustrates a vehicle system, a first robotic machine, and a second robotic machine according to one embodiment;

FIG. 2 illustrates one embodiment of the first robotic machine shown in FIG. 1;

FIG. 3 is a schematic block diagram of a control system for controlling first and second robotic machines to collaborate to perform an assigned task on a vehicle;

FIG. 4 is a flow diagram showing interactions of a task manager and the first and second robotic machines of FIG. 3 to control and coordinate the performance of an assigned task by the robotic machines on a vehicle according to an embodiment;

FIG. 5 is a block flow diagram showing a first sequence of sub-tasks assigned to a first robotic machine and a second sequence of sub-tasks assigned to a second robotic machine for performance of an assigned task on a vehicle according to an embodiment;

FIG. 6 is a perspective view of two robotic machines collaborating to perform an assigned task on a vehicle according to another embodiment;

FIG. 7 is a perspective view of two robotic machines collaborating to perform an assigned task on a first vehicle according to yet another embodiment;

FIG. 8 schematically illustrates a portable system for capturing and communicating transportation data related to vehicle systems or otherwise to a transportation system according to one embodiment;

FIG. 9 schematically illustrates an environmental information capture system according to one embodiment;

FIG. 10 schematically illustrates a camera system according to one embodiment;

FIG. 11 schematically illustrates a camera system according to one embodiment;

FIG. 12 schematically illustrates a camera system according to one embodiment;

FIG. 13 schematically illustrates a vehicle system according to one embodiment;

FIG. 14 schematically illustrates a vehicle system according to one embodiment;

FIG. 15 schematically illustrates a vehicle system according to one embodiment;

FIG. 16 schematically illustrates a camera system according to one embodiment;

FIG. 17 illustrates an embodiment of a spray system, according to one embodiment;

FIG. 18 schematically illustrates an environmental information acquisition system according to one embodiment;

FIG. 19 schematically illustrates a side view of the system shown in FIG. 18

FIG. 20 schematically illustrates a top view of the system shown in FIG. 18;

FIG. 21 schematically illustrates an image analysis system according to one embodiment;

FIG. 22 schematically illustrates a method according to one embodiment;

FIG. 23 schematically illustrates a vehicle system according to one embodiment;

FIG. 24 schematically illustrates a maintenance of way system according to one embodiment;

FIG. 25 schematically illustrates a directed energy system according to one embodiment;

FIG. 26 schematically illustrates a machine learning model according to one embodiment;

FIG. 27 schematically illustrates a method according to one embodiment;

FIG. 28 illustrates a side elevation view of a fastener driving machine according to one embodiment;

FIG. 29 illustrates a fragmentary top perspective view of the fastener driving machine shown in FIG. 28;

FIG. 30 illustrates a reverse fragmentary top perspective view of the present fastener driving machine shown in FIG. 28;

FIG. 31 illustrates an exploded perspective view of a fastener feeder mechanism of the fastener driving machine of FIG. 29;

FIG. 32 is a fragmentary perspective view of a cylinder of the fastener feeder mechanism of FIG. 31;

FIG. 33 is an enlarged side view of a fastener holder of the fastener feeder mechanism of FIG. 31;

FIG. 34 illustrates a set of examples of tie plates, according to one embodiment;

FIG. 35 illustrates an example for subdividing a tie plate image into spiking zones using zone dividers, according to one embodiment;

FIG. 36 illustrates another example for subdividing a tie plate image into spiking zones using zone dividers, according to one embodiment;

FIG. 37 illustrates another example for subdividing a tie plate image into spiking zones using zone dividers, according to one embodiment;

FIG. 38 illustrates another example for subdividing a tie plate image into spiking zones using zone dividers, according to one embodiment;

FIG. 39 illustrates an example of a graphical interface for adjusting spiking zones of a tie plate, according to one embodiment;

FIG. 40 illustrates an example of a graphical interface for spiking order selection, according to one embodiment;

FIG. 41 illustrates another example of a graphical interface for spiking order selection, according to one embodiment;

FIG. 42 illustrates another example of a graphical interface for spiking order selection, according to one embodiment;

FIG. 43 illustrates an example of a graphical interface for customizing a spiking pattern based on track features, according to one embodiment;

FIG. 44 illustrates a flowchart of a method for controlling operation of a fastener driving machine, according to one embodiment;

FIG. 45 illustrates an example of a tie plate image of a tie plate hole pattern, according to one embodiment;

FIG. 46A illustrates a flowchart of a method for initiating a spiking operation, according to one embodiment;

FIGS. 46B-46D illustrate a flowchart of a method for controlling operation of a fastener driving machine, according to one embodiment;

FIG. 47 illustrates a perspective view of a positioning system in accordance with one embodiment;

FIG. 48 illustrates a top view of the positioning system shown in FIG. 47, in accordance with one embodiment;

FIG. 49 illustrates a front view of the positioning system shown in FIG. 47, in accordance with one embodiment;

FIG. 50 illustrates a perspective partial top view of the positioning system shown in FIG. 47, in accordance with one embodiment;

FIG. 51 illustrates a magnified view of a portion of the positioning system shown in FIG. 47, in accordance with one embodiment;

FIG. 52 illustrates a flowchart of one example of a method of controlling movement of the positioning system shown in FIG. 47, in accordance with one embodiment;

FIG. 53 illustrates a perspective view of a positioning system in accordance with one embodiment;

FIG. 54 illustrates a perspective view of a positioning system in accordance with one embodiment;

FIG. 55 illustrates a perspective view of a positioning system in accordance with one embodiment;

FIG. 56 illustrates a perspective view of a positioning system in accordance with one embodiment;

FIG. 57 illustrates a perspective view of a positioning system in accordance with one embodiment;

FIG. 58 illustrates a perspective view of a positioning system in accordance with one embodiment; and

FIG. 59 illustrates a perspective view of a positioning system in accordance with one embodiment.

### DETAILED DESCRIPTION

The systems and methods described herein can be used to perform an assigned task using robotic machines that may collaborate to accomplish the assigned task. In some embodiments, the equipment or target object used to demonstrate aspects of this invention can be a vehicle or stationary equipment. In one embodiment, the equipment may be characterized as infrastructure, including adjacent supporting infrastructure. The nature of the equipment may require specific configuration of the inventive system, but each system may be selected to address application specific parameters. These selected features may include sensor packages, size and scale, implements, mobility platforms for one or more the multiple automated robotic machines, and the like. Further, the internal mechanisms of the robotic machines may be selected based on application specific parameters. Suitable mechanisms may be selected with regard to the range of torque, type of fuel or energy, environmental tolerances, and the like. Adjacent infrastructure may include areas adjacent to travel routes, for example. These route-adjacent areas may be referred to as the ‘wayside’, and related assigned tasks may include maintenance of wayside areas (MoW).

The assigned task may involve at least one of the robotic machine assemblies approaching, engaging, modifying, and manipulating (e.g., moving) a target object on the equipment. For example, a first robotic machine may perform at least a portion of the assigned task by grasping a lever and pulling a lever with a specific force (e.g., torque) in a specific direction and for a specific distance, before releasing the lever or returning the lever to a starting position. A second robotic machine may collaborate with the first robotic machine in the performance of the assigned task by at least one of inspecting a position of the brake lever on the equipment, carrying the first robotic machine to the equipment, lifting the first robotic machine toward the lever, verifying that the assigned task has been successfully completed, and the like. Thus, the multiple robotic machines work together to perform the assigned task. Each robotic machine performs at least one sub-task, and the assigned task may be completed upon the robotic machines completing the sub-tasks. In order to collaborate successfully, the robotic machines may communicate directly with each other or may communicate with a single controller, depending on the end use requirements.

The robotic machines may perform the same or similar tasks on multiple items of equipment in a larger equipment system. The robotic machines may perform the same or similar tasks on different types of the equipment and/or on different the equipment systems. Although two robotic machines may be described in the example above, more than two robotic machines may collaborate with each other to perform an assigned task in another embodiment. For example, one robotic machine may fly along the equipment to inspect a position of a lever or valve, a second robotic machine may lift a third robotic machine to the lever, and the third robotic machine may grasp and manipulate the lever to change the lever position. In one use case, an example of an assigned task may be to release air from a hydraulic or a compressed air system on the equipment. If the compressed air system is a vehicle air brake system, the task may be referred to herein as brake bleeding.

In one or more embodiments, multiple robotic machines may be controlled to work together (e.g., collaborate) to perform different tasks to the equipment. The robotic machines may be automated, such that the tasks may be performed autonomously without direct, immediate control of the robotic machines by a human operator as the robotic machines operate. The multiple robotic machines that collaborate with each other to perform an assigned task may be not identical (e.g., like copies). The robotic machines have different capabilities or affordances relative to each other. The robotic machines may be controlled to collaborate with each other to perform a given assigned task because the task cannot be completed by one of the robotic machines acting alone and/or the task can be completed by one of the robotic machines acting alone but not in a timely or cost-effective manner relative to multiple robotic machines acting together to accomplish the assigned task. For example, in a rail yard, some tasks include brake bleeding, actuating (e.g., setting or releasing) hand brakes on two adjacent rail vehicles, connecting air hoses between the two adjacent rail vehicles (referred to herein as hose lacing), and the like. As another example, some tasks may include moving an energy storage or energy generating device to within a determined distance of a target object, coupling the energy storage or energy generating device to a battery-powered vehicle, determining when the battery of the vehicle is charged, decoupling the energy storage or energy generating device, and moving to a new location or seeking a new target object. In one embodiment, the sub-task may involve moving the target object into a desired orientation, unlocking access to the target object, and the like, if such capability is present.

In one embodiment a system includes a first robotic machine having a first set of capabilities for interacting with a target object. A second robotic machine has a second set of capabilities for interacting with the target object. A task manager has one or more processors and can determine capability requirements to perform a task on the target object. The task has an associated series of sub-tasks having one or more capability requirements. The task manager may assign a first sequence of sub-tasks to the first robotic machine for performance by the first robotic machine based at least in part on the first set of capabilities and a second sequence of sub-tasks to the second robotic machine for performance by the second robotic machine based at least in part on the second set of capabilities. The first and second robotic machines may coordinate performance of the first sequence of sub-tasks by the first robotic machine with performance of the second sequence of sub-tasks by the second robotic machine to accomplish the task.

Suitable first and second sets of capabilities of the first and second robotic machines may include least one of flying, driving, diving, lifting, imaging, grasping, rotating, tilting, extending, retracting, pushing, and/or pulling. Other suitable first and second sets of capabilities of the first and second robotic machines may include at least one of imaging, grasping, rotating, tilting, extending, retracting, and fastening. Fastening may be done, for example, by driving a rail spike through an aperture in a rail tie plate into a rail tie. Other suitable capabilities may include extending a boom and positioning one or more spray nozzles to dispense a spray onto the target object. Other suitable capabilities may include scooping ballast material into or out of a routeway and laying or removing rail ties. Suitable capabilities of the second set of the second robotic machine may include at least one capability that differs from the first set of capabilities of the first robotic machine. For example, one or more of the second set of capabilities of the second robotic machine may be capabilities that the first robotic machine lacks and one or more of the first set of capabilities of the first robotic machine may be capabilities that the other lacks.

During operation, the first and second robotic machines may coordinate performance of the first sequence of sub-tasks by the first robotic machine with the performance of the second sequence of sub-tasks by the second robotic machine by communicating directly with each other. The first robotic machine may notify the second robotic machine, directly or indirectly, that the corresponding sub-task is completed and the second robotic machine responds to the notification by completing a corresponding sub-task in the second sequence. The first robotic machine may provide to the second robotic machine, directly or indirectly, a sensor signal having information about the target object, and the task manager makes a decision whether the second robotic machine proceeds with a sub-task of the second sequence based at least in part on the sensor signal. At least some of the sub-tasks may be sequential such that the second robotic machine begins performance of a dependent sub-task in the second sequence responsive to receiving a notification from the first robotic machine that the first robotic machine has completed a specific sub-task in the first sequence. The first robotic machine may perform at least one of the sub-tasks in the first sequence concurrently with performance of at least one of the sub-tasks in the second sequence by the second robotic machine.

The task manager may access a database that stores capability descriptions corresponding to each of plural robotic machines in a group of robotic machines. (For example, the group of robotic machines may comprise robotic machines that are available for selective use in a given facility or other location.) The task manager may select from the group the first and second robotic machines appropriate to perform the task instead of other robotic machines in the group based on a suitability of the capability descriptions of the first and second robotic machines to the task or corresponding sub-task.

In one example, the first robotic machine performs one or more of the first sequence of sub-tasks by coupling to and lifting the second robotic machine from a starting location to a lifted location such that the second robotic machine in the lifted location is positioned relative to the target object to complete one or more of the second sequence of sub-tasks than when the second robotic machine is in the starting location. (For example, it may be the case that the second robotic machine cannot complete the one or more of the second sequence of the sub-tasks when in the starting location.) In another embodiment, the first robotic machine performs the first sequence of sub-tasks by flying, and the first robotic machine identifies the target object and determines at least two of a position of the target object, a position of the first robotic machine, and/or a position of the second robotic machine. The second robotic machine performs the second sequence of sub-tasks by one or more of modifying the target object, manipulating the target object, observing the target object, interacting with the target object, and/or releasing the target object.

The first robotic machine, having been assigned a sequence of sub-tasks by the task manager, may determine to travel a determined path from a first location to a second location of the first robotic machine, and then signals to the second robotic machine, to the task manager, or both the second robotic machine and the task manager information including the determined path, the act of using the capability, or both. Additionally or alternatively, the first robotic machine may determine to act using a capability of the first set of capabilities, or both determines to travel the intended path and determines to act using the capability.

In one embodiment, the second robotic machine, responsive to the signal from the first robotic machine, initiates a confirmatory receipt signal back to the first robotic machine. This may act as a “ready” signal to initiate a sub-task. Suitable sub-tasks may include moving the robotic machine, moving an implement of the robotic machine, transferring information or data, evaluating a sensor signal, and the like.

The first robotic machine and the second robotic machine each may generate one or more of time indexing signals associated with one or both of the first sequence of sub-tasks and/or the second sequence of sub-tasks, position indexing signals for locations of one or both of the first robotic machine and/or the second robotic machine, and/or orientation indexing signals for one or more tools to implement one or both of the first set of capabilities of the first robotic machine and the second set of capabilities of the second robotic machine.

At least one of the first robotic machine and/or the second robotic machine may have a plurality of moving operational modes. In one embodiment, the machine may have a first mode of operation that is a gross movement mode and a second mode of operation that is a fine movement mode. Suitable robotic machines may include one or more of one or more of a stabilizer, an outrigger, or a clamp. In one embodiment, suitable modes may include a transition in operation from the first mode to the second mode that includes deploying and setting the stabilizer, outrigger, or clamp. In another embodiment, there may be a fast-close operation that moves one or more robotic machines proximate to the target object quickly, followed by a transition to a slower movement mode that carefully moves the robotic machine from proximate the target object to contact with the target object. (A slow speed is a speed that is slower than a fast speed, which is a speed that is faster than the slow speed; i.e., they are slower or faster relative to one another.) The first mode of operation may include moving at least one of the first robotic machine and the second robotic machine to determined locations proximate to the target object and to each other; and the second mode of operation may include actuating one or more tools of at least one of the first robotic machine and the second robotic machine to accomplish the task.

In one embodiment, a first robotic machine has a first set of capabilities for interacting with a surrounding environment, where the first robotic machine may receive a first sequence of sub-tasks related to the first set of capabilities of the first robotic machine; and a second robotic machine has a second set of capabilities for interacting with the surrounding environment. The second robotic machine may receive a second sequence of sub-tasks related to the second set of capabilities of the second robotic machine. The first and second robotic machines may perform the first and second sequences of sub-tasks, respectively, to accomplish a task that involves at least one of manipulating or inspecting a target object that is separate from the first and second robotic machines. The first and second robotic machines may coordinate performance of the first sequence of sub-tasks by the first robotic machine with performance of the second sequence of sub-tasks by the second robotic machine.

At least some of the sub-tasks may be sequential such that the second robotic machine may begin performance of a corresponding sub-task in the second sequence responsive to receiving a notification from the first robotic machine that the first robotic machine has completed a specific sub-task in the first sequence.

During operation, the system may include the first robotic machine having a first set of capabilities for interacting with a surrounding environment, the first robotic machine configured to receive a first sequence of sub-tasks related to the first set of capabilities of the first robotic machine, and a second robotic machine having a second set of capabilities for interacting with the surrounding environment, the second robotic machine configured to receive a second sequence of sub-tasks related to the second set of capabilities of the second robotic machine. The system may perform the first and second sequences of sub-tasks to accomplish a task comprising at least one of manipulating or inspecting a target object, and may coordinate performance of the first sequence of sub-tasks by the first robotic machine with performance of the second sequence of sub-tasks by the second robotic machine.

While one or more embodiments are described in connection with a rail vehicle system, not all embodiments are limited to rail vehicle systems. Unless expressly disclaimed or stated otherwise, the inventive subject matter described herein extends to multiple types of vehicle systems. These vehicle types may include automobiles, trucks (with or without trailers), buses, marine vessels, aircraft, mining vehicles, agricultural vehicles, or other off-highway vehicles. The vehicle systems described herein (rail vehicle systems or other vehicle systems that do not travel on rails or tracks) can be formed from a single vehicle or multiple vehicles. With respect to multi-vehicle systems, the vehicles can be mechanically coupled with each other (e.g., by couplers) or logically coupled but not mechanically coupled. By logically coupled, the plural items of mobile equipment are controlled so that controls to move one of the items causes a corresponding movement in the other items in consist, such as by wireless command. For example, vehicles may be logically but not mechanically coupled when the separate vehicles communicate with each other to coordinate movements of the vehicles with each other so that the vehicles travel together as a group. Vehicle groups may be referred to as a convoy, consist, swarm, fleet, platoon, and train. In one or more embodiments, the vehicles may communicate via an Ethernet over multiple units (eMU) system that may include, for example, a communication system for use transmitting data from one vehicle to another in the consist (e.g., an Ethernet network over which data is communicated between two or more vehicles).

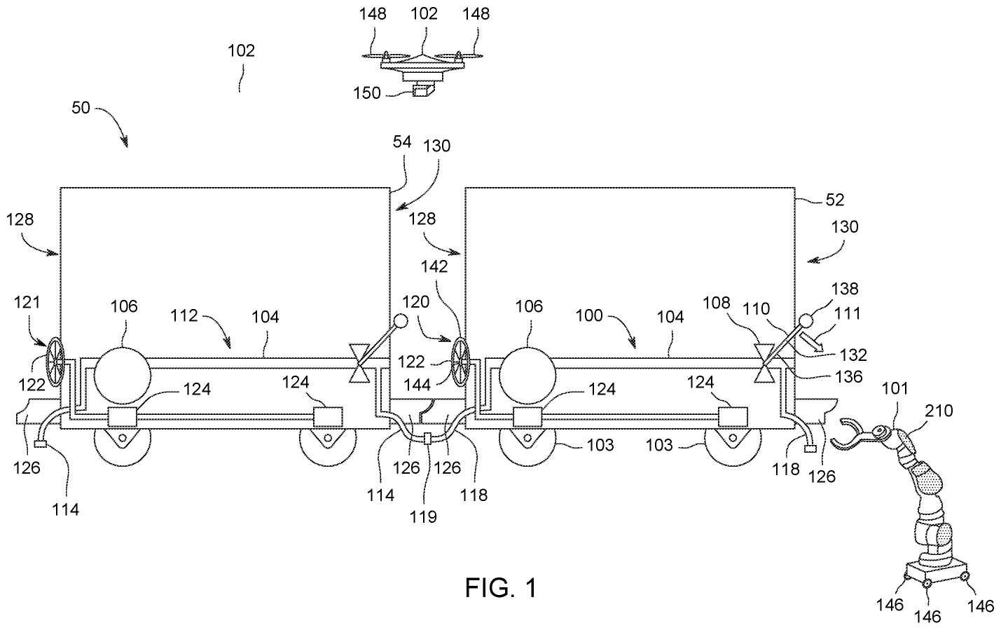

FIG. 1 schematically illustrates an equipment system 50, a first robotic machine 101, and a second robotic machine 102 according to one embodiment. The equipment system may include first equipment 52 and second equipment 54 that may be mechanically interconnected to travel together along a route. The second equipment may be disposed in front of the first equipment in a direction of movement of the equipment system. In an alternative embodiment, the equipment system may include more than two interconnected pieces or items of equipment or only one item of equipment. The first and second equipment are rail vehicles in the illustrated embodiment. In other embodiments, suitable mobile equipment may include automobiles, off-road equipment, or the like. In other embodiments, suitable stationary equipment may include railroad tracks, roads, bridges, buildings, stacks, stationary machines, and the like. The first and second robotic machines may perform an assigned task on the equipment. The first and second robotic machines collaborate (e.g., work together) to accomplish the assigned task. The first and second robotic machines perform various sub-tasks semi-autonomously, autonomously (without direct control and/or supervision of a human operator), or manually under remote control of an operator. For example, the robotic machines may act based on instructions received prior to beginning the sub-tasks. The assigned task may be completed upon the completion of the sub-tasks by the robotic machines. Whether the task is manual, semi-auto, or autonomous is based in part on the sub-task, the capabilities of the robotic machines, the target object, and the like. Further, inspection of a target object may determine whether the sub-task should be performed in a manual, semi-auto, or autonomous manner.

In the illustrated embodiment, the first equipment has an air brake system 100 disposed onboard. The air brake system engages corresponding wheels 103 and may operate on a pressure differential within one or more conduits 104 of the air brake system. When the pressure of a fluid, such as air, in the conduits is above a designated threshold or when the pressure increases by at least a designated amount, air brakes 106 engage corresponding wheels of the first equipment. (In certain equipment, such as certain rail vehicles, the air brakes may be configured to engage when the pressure of the fluid (e.g., air) in the conduits drops below a designated threshold.) Although only one air brake is shown in FIG. 1, the air brake system may include several air brakes. The conduit connects with a valve 108 that closes to retain the fluid (and fluid pressure) within the conduit. The valve can be opened to release (e.g., bleed) the fluid out of the conduit and the air brake system. (As noted, in certain equipment, once the pressure of the fluid in the conduit and air brake system drops by or below a designated amount, the air brake engages the wheels.) The first equipment may freely roll while the air brake is disengaged, but is held fast while the air brake is engaged.

The valve can be actuated by manipulating (e.g., moving) a brake lever 110. The brake lever can be pulled or pushed in a direction 111 to open and close the valve. The brake lever is an example of a target object. In an embodiment, releasing the brake lever may cause the valve to close. For example, the brake lever may move under the force of a spring or other biasing device to return to a starting position and force the valve closed. In another embodiment, the brake lever may require an operator or an automated system to return the brake lever to the starting position to close the valve after bleeding the air brake system.

The second equipment may include its own air brake system 112 that may be identical, or at least substantially similar, to the air brake system of the first equipment. The second equipment may include a first hose 114 (referred to herein as an air hose) that may fluidly connect to the conduit of the air brake system. The first equipment may include a second hose 118 that may be fluidly connected to the same conduit. The second hose extends from a front 128 of the first equipment, and the first hose extends from a rear 130 of the second equipment. The hoses may connect to each other at a separable interface 119 to provide a fluid path between the air brake system of the first equipment and the air brake system of the second equipment. Fluid may be allowed to flow between the air brake systems when the hoses may be connected. Fluid cannot flow between the air brake systems when the hoses are disconnected. The first equipment has another second air hose at the rear end 130 thereof, and the second equipment has another first air hose at the front end thereof.

The first equipment may include a hand brake system 120 disposed onboard the first equipment. The hand brake system may include a brake wheel 122 that may be rotated manually by an operator or an automated machine. The brake wheel is mechanically linked to friction-based hand brakes 124 (e.g., shoes or pads) on the first equipment. Rotation of the brake wheel in a first direction causes the hand brakes to move towards and engage the wheels, setting the hand brakes. Rotation of the brake wheel in an opposite, second direction causes the hand brakes to move away from and disengage the wheels, releasing the hand brakes. In an alternative embodiment, the hand brake system may include a lever or another actuatable device instead of the brake wheel. In the illustrated embodiment, the second equipment may include a hand brake system 121 that may be identical, or at least substantially similar, to the hand brake system of the first equipment.

The first and second equipment may include mechanical couplers at both the front ends and the rear ends of the equipment. The mechanical coupler at the rear end of the second equipment mechanically engages and connect to the mechanical coupler at the front end of the first equipment to interconnect or couple the equipment to each other. The first equipment may be uncoupled from the second equipment by disconnecting the mechanical couplers 126 that extend between the first and second equipment.

The robotic machines may be discrete from the equipment system such that neither robotic machine is integrally connected to the equipment system. The robotic machines may move relative to the equipment system to interact with at least one of the first and/or second equipment. Each of the robotic machines has a specific set of affordances or capabilities for interacting with the surrounding environment. Some examples of capabilities include flying, driving (or otherwise traversing along the ground), lifting other objects, imaging (e.g., generating images and/or videos of the surrounding environment), grasping an object, rotating, tilting, extending (or telescoping), retracting, pushing, pulling, or the like. The first robotic machine has a first set of capabilities, and the second robotic machine has a second set of capabilities.

In the illustrated embodiment, the first robotic machine may be different than the second robotic machine, and has at least some different capabilities than the first robotic machine. Thus, the second set of capabilities of the second robotic machine may include at least one capability that differs from the first set of capabilities of the first robotic machine or vice-versa. For example, the first robotic machine in the illustrated embodiment has the capability to drive on the ground via the use of multiple wheels 146. The first robotic machine also has the capabilities to grasp and manipulate a target object 132 on a designated the equipment, such as the first equipment, using a robotic arm 210. The robotic arm may have the capabilities to rotate, tilt, lift, extend, retract, push, and/or pull the target object 132. The first robotic machine may be referred to herein as a grasping robotic machine. In the illustrated embodiment, the target object 132 may be identified as the brake lever, but the target object 132 may be a different device on the first equipment depending on the assigned task that may be performed by the robotic machines.

The second robotic machine in the illustrated embodiment is an aerial robotic machine (e.g., a drone) that has the capability to fly in the air above and/or along a side of the equipment system via the use of one or more propellers 148. Although not shown, the robotic machine may include wings that provide lift. The second robotic machine in FIG. 1 may be referred to as an aerial robotic machine. The aerial robotic machine may include an imaging device 150 that may be configured to generate imaging data. Imaging data may include still images and/or video of the surrounding environment in the visual frequency range, the infrared frequency range, or the like. Suitable imaging devices may include an infrared camera, a stereoscopic 2D or 3D camera, a digital video camera, or the like. Using the imaging device, the aerial robotic machine has the capability to visually inspect designated equipment, including a target object thereof, such as to determine a position or status of the target object. The aerial robotic machine may not have the capability to drive on the ground or grasp and manipulate a target object like a grounded grasping robotic machine. The grounded robotic machine, on the other hand, may not have the capability to fly.

The robotic machines may perform an assigned task on one or both of the first and/or second equipment. For example, the robotic machines may perform the assigned task on the first equipment, and then may subsequently perform an assigned task on the second equipment. The equipment system may include more than just the two items of equipment shown in FIG. 1. The robotic machines may move along the equipment system from one location or region of interest to another, and may designate new equipment and new target objects on which to perform assigned tasks. Alternatively, the robotic machines may perform the assigned task on the first equipment and not on the second equipment, or vice-versa. The grasping and aerial robotic machines work together and collaborate to complete the assigned task. The assigned task involves at least one of the robotic machines engaging and manipulating the target object 132 on the designated equipment. In the illustrated embodiment, the grasping robotic machine may engage and manipulate the brake lever which defines the target object. The aerial robotic machine may fly above the equipment system and inspect the target object using the imaging device. The aerial robotic machine also may use the imaging device to detect the presence of obstructions between the grasping robotic machine and the target object. As discussed further herein, in one embodiment the imaging device may be used to help locate and navigate the aerial robotic machine.

The aerial robotic machine and the grasping robotic machine shown in FIG. 1 are only examples. The first and second robotic machines may have other shapes and/or capabilities or affordances in other embodiments, as shown and described herein. For example, the robotic machines in one or more other embodiments may both be land-based and/or may both have robotic arms 210 for grasping, pulling, driving, moving, welding, and the like.

One assigned task may be for the robotic machines to bleed the air brake systems of the respective equipment in the equipment system. Prior to the equipment system starting to move from a stationary position, the air brake systems of each of the first and second equipment must be manipulated to release the air brake. The brake lever is identified as the target object. The grasping and aerial robotic machines collaborate to perform the assigned task. For example, the aerial robotic machine may fly above the first equipment, locating and identifying the brake lever, and determining that the brake lever is in a non-actuated position requiring manipulation to release the air brake. The aerial robotic machine informs the grasping robotic machine of the location and/or status (e.g., non-actuated) of the target object and, optionally, the distance and orientation of the second robotic machine, or the arm of the second robotic machine relative to the target object. Since the grasping robotic machine traverses on the ground, the robotic machine may be susceptible to obstructions blocking its path. The aerial robotic machine optionally may inspect the path ahead of the ground robotic machine and notify the ground robotic machine of any detected obstacles between it and the target object (e.g., brake lever). The grasping robotic machine receives and processes the information transmitted from the aerial robotic machine. The grasping robotic machine moves toward the brake lever, engages the brake lever, and manipulates the brake lever by pulling or pushing the brake lever. The grasping robotic machine and/or the aerial robotic machine determine whether the brake lever has been moved fully to the actuated position. Upon confirmation that the air brake is released, the grasping robotic machine releases the brake lever. It may then move to the next item of equipment (e.g., the second equipment) in the equipment system to repeat the brake bleeding task. Optionally, the robotic machines may implement one or more follow up actions responsive to determining that the air brake system has or has not been released, such as by communicating with one or more human operators, attempting to release the air brake system again, or identifying the first equipment having the air brake system that may be not released as requiring inspection, maintenance, or repair. As discussed herein, at least one of the robotic machines may confirm completion of the sub-task using an acoustic sensor.

The robotic machines may perform additional or different tasks other than brake bleeding. For example, the robotic machines may be assigned the task of setting and/or releasing the hand brakes of one or both of the first equipment and second equipment. The hand brakes may be set as a back-up to the air brake. When the equipment system stops, human operators may decide to set the hand brakes on only some of the equipment, such as the hand brakes on every fourth item of equipment along the length of the equipment system. One assigned task may be to release the hand brakes on the equipment to allow the equipment system to move along the route. In an embodiment, the aerial robotic machine may fly along the equipment system to detect which of the various equipment has hand brakes that need to be released, if any. The aerial robotic machine may inspect the hand brakes along the equipment and/or the positions of the brake wheels to determine which equipment needs to have the hand brakes released. For example, the aerial robotic machine may determine that the hand brake of the second equipment needs to be released, but the hand brake of the first equipment is not set. The aerial robotic machine notifies the grasping robotic machine to actuate the brake wheel of the second equipment, but not the brake wheel of the first equipment. The aerial robotic machine may provide other information to the grasping robotic machine, such as distance from the grasping robotic machine to the target object, the type and location of obstacles detected in the path of the grasping robotic machine, and the configuration of the target object itself (not all items of equipment may be identical).

Upon receiving the communication from the aerial robotic machine, the grasping robotic machine may move past the first equipment to the front end of the second equipment. The grasping robotic machine manipulates the brake wheel, which represents the target object, by extending the robotic arm to the brake wheel, grasping the brake wheel, and then rotating the brake wheel in a designated direction to release the hand brakes. After one or both robotic machines confirm that the hand brakes of the second equipment are released, the assigned task is designated as complete. The robotic machines may move to other the equipment (not shown) in the equipment system to perform an assigned task on other equipment.

In another embodiment, the robotic machines may be assigned the task of coupling or uncoupling the first equipment relative to the second equipment. The robotic machines may both be land-based (instead of the aerial machine shown in FIG. 1) and may perform the task by engaging and manipulating the mechanical couplers of the equipment which represent target objects. For example, the first robotic machine may engage the coupler at the front of the first equipment, and the second robotic machine may engage the coupler at the rear of the second equipment. The robotic machines collaborate during the performance of the assigned task in order to couple or uncouple the first equipment relative to each other.

Yet another potential assigned task that may be assigned to the robotic machines may be hose lacing. Hose lacing involves connecting (or disconnecting) air hoses of the first equipment to each other to fluidly connect the air brake systems to itself. This closes an otherwise open fluidic circuit. For example, both robotic machines may have robotic arms like the robotic arm of the grasping robotic machine shown in FIG. 1. The first robotic machine may grasp an end of the second hose at the front end of the first equipment, and the second robotic machine grasps an end of the first hose at the rear end of the second equipment. The robotic machines communicate and collaborate to index and align (e.g., tilt, rotate, translate, or the like) the hoses of the two the first equipment with each other and then move the hoses relative to each other to connect the hoses at the separable interface. Although potential tasks for the robotic machines to perform on the equipment may be described with reference to FIG. 1, the robotic machines may perform various other tasks on other equipment systems that involve manipulating and/or inspecting a target object.

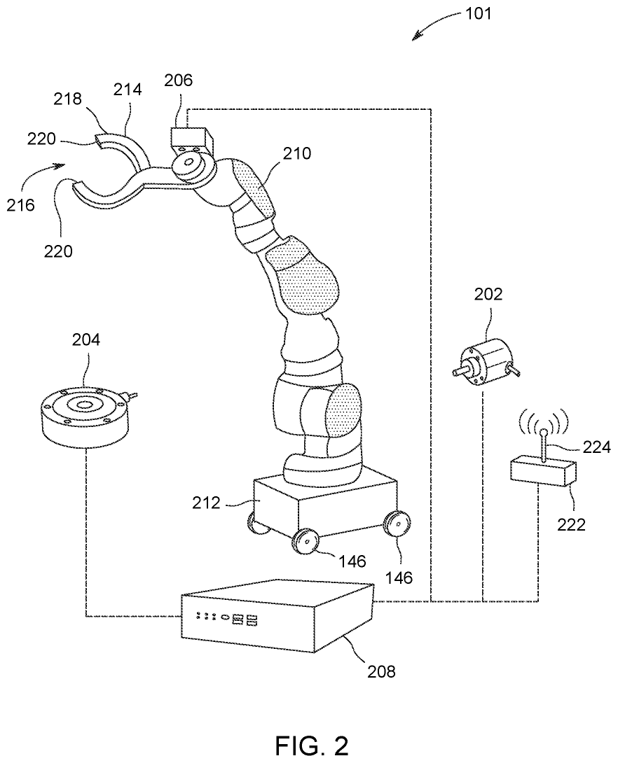

FIG. 2 illustrates an embodiment of the first robotic machine shown in FIG. 1. The grasping robotic machine is shown in a partially exploded view with several components (e.g., 202, 204, 208, and 222) displayed spaced apart from the robotic arm. The robotic arm may be mounted on a mobile base 212 that includes wheels. The mobile base moves the robotic arm towards the target object of the equipment and transports the arm from place to place. The robotic arm may move in multiple different directions and planes relative to the base under the control of a task manager via a controller 208. The controller drives the robotic arm to move toward the corresponding target object (e.g., the brake lever shown in FIG. 1) to engage the target object and manipulate the target object to perform the assigned task. For example, the controller may convey commands in the form of electrical signals to actuators, motors, and/or other devices of the robotic arm that provide a kinematic response to the received commands.

The controller, particularly as the task manager, represents hardware circuitry that may include, represent, and/or may be connected with one or more processors (e.g., microprocessors, field programmable gate arrays, integrated circuits, or other electronic logic-based devices). The controller may include and/or be communicatively connected with one or more digital memories, such as computer hard drives, computer servers, removable hard drives, etc. The controller may be communicatively coupled with the robotic arm and the mobile base by one or more wired and/or wireless connections that allow the controller to dictate how and where the grasping robotic machine moves. Although shown as a separate device that may be not attached to the robotic arm or the mobile base, the controller may be mounted on the robotic arm and/or the mobile base.

The robotic arm may include an end effector 214 at a distal end 216 of the robotic arm relative to the mobile base. The end effector may directly engage the target object on the equipment to manipulate the target object. For example, the end effector may grasp the brake lever (shown in FIG. 1) to hold the lever such that subsequent movement of the robotic arm moves the brake lever with the arm. In the illustrated embodiment, the end effector has a claw 218 that may be controllable to adjust a width of the claw to engage and at least partially enclose the target object. The claw has two fingers 220 that may be movable relative to each other. For example, at least one of the fingers may be movable relative to the other finger to adjust the width of the claw and allow the claw to grasp the target object. The end effector may have other shapes in other embodiments.

The grasping robotic machine may include a communication circuit 222. The communication circuit operably connects to the controller. Suitable circuits may include hardware and/or software that may be used to communicate with other devices and/or systems, such as another robotic machine (e.g., the second robotic machine shown in FIG. 1) configured to collaborate with the robotic machine to perform the assigned task, remote servers, computers, satellites, and the like. The communication circuit may include a transceiver and associated circuitry (e.g., an antenna 224) for wireless bi-directional communication of various types of messages, such as task command messages, notification messages, reply messages, feedback messages, or the like. The communication circuit may transmit messages to specific designated receivers and/or broadcast messages indiscriminately. In an embodiment, the communication circuit may receive and convey messages to the controller prior to and/or during the performance of an assigned task. As described in more detail herein, the information received by the communication circuit from remote sources, such as another robotic machine collaborating with the robotic machine, may be used by the controller to control the timing and movement of the robotic arm during the performance of the assigned task. Although the communication circuit is illustrated as a box-shaped device that may be separate from the robotic arm and the mobile base, the communication circuit may be mounted on the robotic arm and/or the mobile base.

The grasping robotic machine may include one or more sensors 202, 204, 206 that monitor operational parameters of the grasping robotic machine and/or the target object that the robotic machine manipulates. The operational parameters may be communicated from the respective sensors to the controller. The controller examines the parameters to make determinations regarding the control of the robotic arm, the mobile base, and the communication circuit. In the illustrated example, the robotic machine may include an encoder sensor that converts rotary and/or linear positions of the robotic arm into one or more electronic signals. The encoder sensor can include one or more transducers that generate the electronic signals as the arm moves. The electronic signals can represent displacement and/or movement of the arm, such as a position, velocity, and/or acceleration of the arm at a given time. The position of the arm may refer to a displaced position of the arm relative to a reference or starting position of the arm, and the displacement may indicate how far the arm has moved from the starting position. Although shown separated from the robotic arm and mobile base in FIG. 2, the encoder sensor may be mounted on the robotic arm and/or the mobile base in an embodiment.

The grasping robotic machine may also include an imaging sensor 206 that may be installed on the robotic arm. In an embodiment, the imaging sensor may be mounted on or at least proximate to the end effector. For example, the imaging sensor may include a field of view that encompasses at least a portion of the end effector. The imaging sensor moves with the robotic arm as the robotic arm moves toward the brake lever. The imaging sensor acquires perception information of a working environment of the robotic arm. The perception information may include images and/or video of the target object in the working environment. The perception information may be conveyed to the controller as electronic signals. The controller may use the perception information to identify and locate the target object relative to the robotic arm during the performance of the assigned task. Optionally, the perception information may be three-dimensional data used for mapping and/or modeling the working environment. For example, the imaging sensor may include an infrared (IR) emitter that generates and emits a pattern of IR light into the environment, and a depth camera that analyzes the pattern of IR light to interpret perceived distortions in the pattern. The imaging sensor may also include one or more color cameras that operate in the visual wavelengths. The imaging sensor may acquire the perception information at an acquisition rate based at least in part on the end use requirements. In one embodiment, the rate may be at least 15 Hz, such as approximately 30 Hz. A suitable imaging sensor may be a Kinect™ sensor available from Microsoft.

Suitable imaging sensors may include video camera units for capturing and communicating video data. As used herein, a camera is a device for capturing and/or recording visual images. Suitable images may be in the form of still shots, analog video signals, or digital video signals. The signals, particularly the digital video signals, may be subject to compression/decompression algorithms, such as MPEG or HEVC. A suitable camera may capture and record in a determined band of wavelengths of light or energy. For example, in one embodiment the camera may sense wavelengths in the visible spectrum and, in another, the camera may sense wavelengths in the infrared spectrum. Multiple sensors may be combined in a single camera and may be used selectively based on the application. Further, stereoscopic and 3D cameras are contemplated for at least some embodiments described herein. These cameras may assist in determining distance, velocity, and vectors to predict (and thereby avoid) collision and damage. For example, the camera may be deployed onboard a robotic machine to capture video data, for storage for later use. The robotic machine may act as a powered camera supporting object, such that the camera may be mobile. That is, the camera unit and its supporting object may be capable of moving independent or separate from movement of an operator or another robotic machine. The supporting object may be a robotic machine, or an implement of the robotic machine. Suitable implements may include an extendable mast.

The camera unit may be connected or otherwise disposed onboard an aerial robotic machine (e.g., a drone, helicopter, or airplane) to allow the camera unit to fly, or the camera unit may be connected with or otherwise disposed onboard another ground-based or aquatic robotic machine to allow the robot and camera relative movement. In one embodiment, the camera supporting object is the first robotic machine capable of at least one of remote control or autonomous movement relative to the second robotic machine. The first robotic machine may travel along a route ahead of the second robotic machine and may transmit the image data back to the second robotic machine. This may provide an operator of the second robotic machine a view of the route well in advance of the arrival of the second robotic machine. For very high speed second robotic machines, the stopping distance may be beyond the visibility provided from the vantage of the second robotic machine. The view from the first vehicle, then, may extend or supplement that visible range. In addition, the camera itself may be repositionable and may have the ability to pan left, right, up and down, as well as the ability to zoom in and out.

The camera unit or the supporting robotic machine can include a locator device that generates data used to determine its location. The locator device can represent one or more hardware circuits or circuitry that include and/or are connected with one or more processors (e.g., controllers, microprocessors, or other electronic logic-based devices). In one example, the locator device represents a global positioning system (GPS) receiver that determines a location of the camera unit, a beacon or other communication device that broadcasts or transmits a signal that is received by another component (e.g., the transportation system receiver) to determine how far the camera unit is from the component that receives the signal (e.g., the receiver), a radio frequency identification (RFID) tag or reader that emits and/or receives electromagnetic radiation to determine how far the camera unit is from another RFID reader or tag (e.g., the receiver), or the like. The receiver can receive signals from the locator device to determine the location of the locator device relative to the receiver and/or another location (e.g., relative to a vehicle or vehicle system). Additionally or alternatively, the locator device can receive signals from the receiver (e.g., which may include a transceiver capable of transmitting and/or broadcasting signals) to determine the location of the locator device relative to the receiver and/or another location (e.g., relative to a vehicle or vehicle system).

The robotic machine may include a force sensor 204 that monitors forces applied by the robotic arm on the target object during the performance of the assigned task as the robotic arm manipulates the target object. As used herein, the term “force” encompasses torque, such that the forces applied by the robotic arm on the target object described herein may or may not result in the target object twisting or rotating. The force sensor may communicate electronic signals to the controller that represent the forces exerted by the robotic arm on the target object, as monitored by the force sensor. The forces may represent forces applied by the claw of the end effector on the target object. The sensed forces may represent those forces applied on various joints of the robotic arm for moving and maneuvering the arm.

Optionally, the robotic machine may include one or more other sensors in addition to, or instead of one or more of, the sensors shown in FIG. 2. For example, the robotic machine may include an acoustic sensor that detects sounds generated during actuation of the brake lever (shown in FIG. 1) to determine whether the brake lever has been actuated to release the air brake system. The acoustic sensor may detect contact between implements of one robotic machine and one or more of another robotic machine, an implement of another robotic machine, another implement of the first robotic machine, a portion of the target object, or another object that is neither a robotic machine (or its implements) or the target object. Feedback from the acoustic sensor may be used to calibrate an implement's location and/or speed and/or force. For example, the sensing function may correlate a contact sound to indicate when a grip has been moved far enough to contact the target object. At that moment, the task manager may index the robotic machine's implement (or the robotic machine's location) relative to the target object or another object. The task manager may base task instruction on such index information. If the sub-task commanded an implement to contact an object, that sub-task may be considered to be fulfilled so that the sequentially next sub-task may start. The magnitude of the acoustic signal may correlate to the force of impact of the implement with the target object. Adjustments to movement speed and movement force may be made based at least in part on the signal magnitude. An operating mode may be initiated if the task manager is unsure of location of an implement or robotic machine to intentionally make contact to generate an acoustic signal, and therefore ascertain relative locations or verify locations.

The robotic machine may include one or more other sensors that may function similarly to the uses set forth for the acoustic sensor, as modified by the application and the sensor type. Suitable sensors may monitor the speed of the mobile robotic machine and/or the speed at which an implement, such as a robotic arm, moves relative to the robotic machine base. In one embodiment, at least one robotic machine may define a plurality of zones of movement for an implement. Such zones may be designated in such a way that the task manager, or the robotic machine, may behave differently based on triggers or activities associated with one of the zones that differs from behavior in other zones. In one example, a zone may be a potential contact zone insofar as an implement of a robotic machine may be operating in such potential contact zone and that if there is an object, such as a target object or an obstacle, in such potential contact zone the implement may impact or act on that object. The task manager may be apprised of, via one or more sensors, the presence or absence of such an object in such a zone.

In one embodiment, differences in acoustic signals are modeled and associated with various types of activities. A human voice that is sensed may indicate the presence of a human within a potential contact zone. As such, the task manager may preclude some sub-tasks, such as movement of the robotic machine or its implement, until verification can be made that no human is located in the potential contact zone. Verification might be made by a manual indication that all persons have vacated such potential contact zone. Or, a second set of sensors may confirm that, for example, a signaling tag worn by a person is not present in such potential contact zone prior to allowing movement of an implement in such potential contact zone. Alternatively, a lock out system may be employed such that if a lock out tag, or equivalent, is set for a particular zone the robotic machine may not move or may not move an implement into or through such potential contact zone until a corresponding lock out tag is removed.

Movement in other zones may be allowed even while other zones have one or more tasks and activities constrained. In one embodiment, if a robotic machine has four lateral zones defined as forward, rearward, left and right and an obstacle or equivalent (such as a lock out tag, or a detected human (via voice or image)) is sensed in the forward zone, the robotic machine may move itself and/or an implement into one of the three remaining zones while avoiding movement or activity in the forward zone.

In one embodiment, the task includes an inspection plan including the virtual 3D travel path of and/or about an asset. In a first operating mode, one or more robotic machine may travel to a location proximate to the target object in the real world based on, for example, global positioning system (GPS) coordinates of the asset in comparison to GPS coordinates of the robot and, on arrival, align or index to a virtually created 3D model. In a second travel mode, the robotic machine may travel and align with the target object based on sensor input (other than GPS) relative to the 3D model. That is, once a robotic machine has arrived at a desired start location the robotic machine may move along the real travel path from the start location to an end location in an autonomous or semi-autonomous fashion based at least in part on the 3D model and environmental sensors. This may be useful where the target object is very large, e.g., a section of road, a railway, a bridge, or a building. Specific areas of interest about the target object may be monitored and evaluated dynamically by the robotic machine.

During travel, the robotic machine may stop, pause, slow down, speed-up, maintain speed, etc., capture images, as well as sense for other data (e.g., temperature, humidity, pressure, etc.) at various regions of interest (ROI) designated by the task manager. For each ROI, the virtual 3D model may include three-dimensional coordinates (e.g., X, Y, and Z axis coordinates) at which the robotic machine is to be located for performing a particular sub-task. In addition to a location in three dimensional space, each ROI may include a perspective with respect to a surface of the target object at which the sub-task may dictate the capture of data or images, field of view of a camera, orientation, and the like. To execute sub-tasks, the robotic machine may use multiple models. Suitable models may include a model of the world for safe autonomous navigation to and from a work site, and another model of the target object which contains the location of regions of interest. Based on the model of the world the task manager may determine how to orient the first robotic machine or the second robotic machine relative to each other, the target object, and/or the surrounding environment. Based on the model of the asset, each robotic machine can execute sub-tasks at regions of interest. The first and second robotic machines may move as a consist.

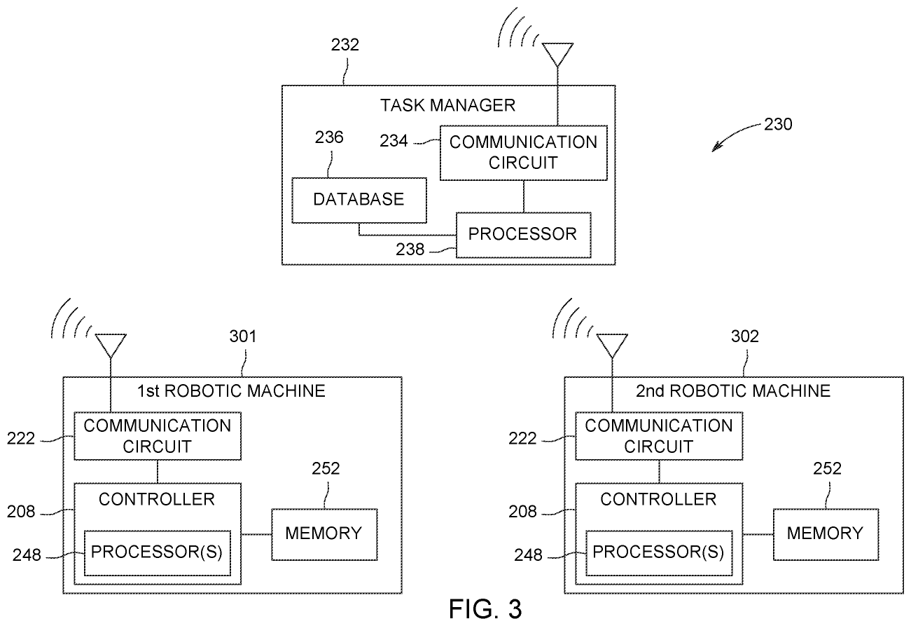

FIG. 3 is a schematic block diagram of a control system 230 for controlling first and second robotic machines 301, 302 to collaborate in performing an assigned task on the equipment. The control system may include the first and second robotic machines and a task manager 232. The task manager may be located remote from the first robotic machine and/or the second robotic machine. The task manager may communicate with the robotic machines to provide instructions to the robotic machines regarding the performance of an assigned task that involves manipulating and/or inspecting a target object on the equipment. The first and second robotic machines may use the information received from the task manager to plan and execute the assigned task.

The first and second robotic machines may or may not be the grasping robotic machine and the aerial robotic machine, respectively, of the embodiment shown in FIG. 1. For simplicity of description, FIG. 3 does not illustrate all of the components of the robotic machines, such as the robotic arm and the propellers (both shown in FIG. 1). Each of the robotic machines may include a communication circuit and a controller as described with reference to FIG. 2. Each of the controllers may include one or more processors 248. The controllers may be optionally operatively connected to respective digital memory devices 252.

The task manager may include a communication circuit 234, at least one processor 238, and a digital database 236, which may represent or be contained in a digital memory device (not shown). The processor may be operatively coupled to the database and the communication circuit. The task manager may be or include a computer, a server, an electronic storage device, or the like. The database may be, or may be contained in, a tangible and non-transitory (e.g., not a transient signal) computer readable storage medium. The database stores information corresponding to multiple robotic machines in a group of robotic machines that may include the first and second robotic machines. For example, the database may include a list identifying the robotic machines in the group and providing capabilities or affordances associated with each of the robotic machines in the list. The database may also include information related to one or more potential assigned tasks, such as a sequence of sub-tasks to be performed in order to accomplish or complete the assigned task. Optionally, the database may include information about one or more items of equipment on which an assigned task is to be performed, such as information about types and locations of various potential target objects on the equipment to be manipulated in the performance of an assigned task. The processor may access the database to retrieve information specific to an assigned task, the equipment on which the assigned task is to be performed, and/or a robotic machine that may be assigned to perform the task. Although shown as a single, unitary hardware device, the task manager may include multiple difference hardware devices communicatively connected to one another. For example, in an embodiment, the task manager may be one or more servers located at a data center, a railroad dispatch location, a control center, or the like.

The task manager may communicate with the first and second robotic machines via the transmission of messages from the communication circuit to the communication circuits of the robotic machines. For example, the task manager may communicate messages wirelessly in the form of electromagnetic radio frequency signals. The first and second robotic machines may transmit messages to the task manager via the respective communication circuits. The robotic machines may be also able to communicate with each other using the communication circuits. For example, the robotic machines may transmit status-containing notification messages back and forth as the robotic machines collaborate to perform an assigned task in order to coordinate the actions of the robotic machines to perform the assigned task correctly and efficiently. Time sensitive networks may be used to coordinate activities requiring a high degree of precision and/or timing in the coordination.

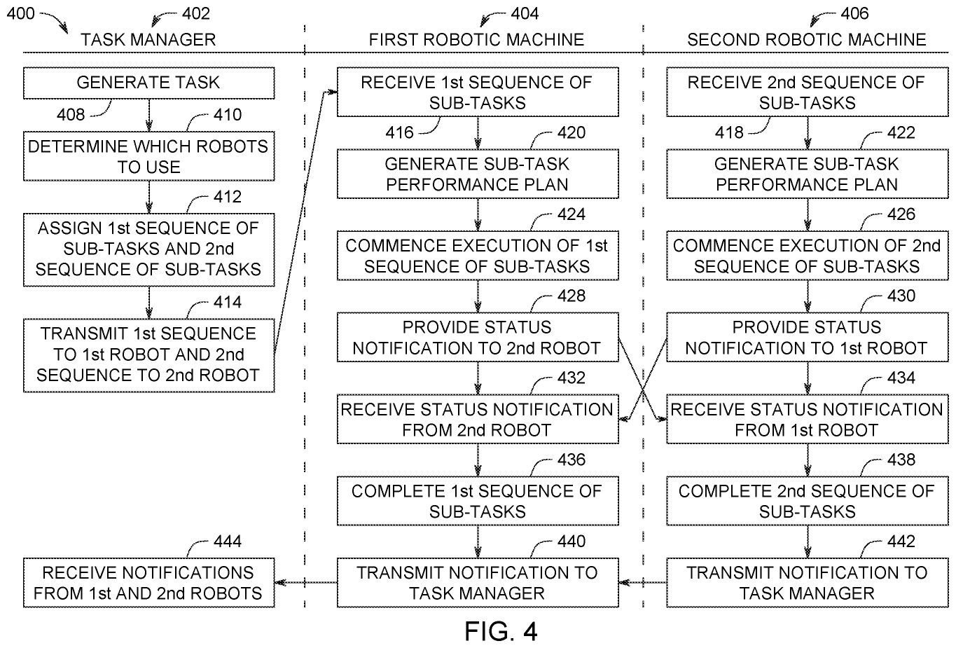

FIG. 4 illustrates a flow diagram 400 showing interactions of the task manager and the first and second robotic machines of FIG. 3 to control and coordinate the performance of an assigned task by the robotic machines on the equipment according to an embodiment. The flow diagram is divided into a first column 402 listing actions or steps taken by the task manager, a second column 404 listing actions or steps taken by the first robotic machine, and a third column 406 listing actions or steps taken by the second robotic machine. At step 408, the task manager generates a task that step involves manipulating and/or inspecting a target object on the equipment. Various example tasks may be described above with reference to FIG. 1, including brake bleeding of an air brake system, setting or releasing a hand brake, inspecting a position of a brake actuator (e.g., a lever, a wheel, or the like), mechanically coupling or uncoupling the equipment relative to another the equipment, hose lacing to connect or disconnect an air hose of the equipment to an air hose of another the equipment, or the like. Optionally, the task may be a scheduled task, and the task manager generates a sub-task responsive to the task being due to be performed. Alternatively, the task manager may generate a sub-task upon receiving a request that step the task be performed, such as from a user interface connected to the task manager or from a remote source via a communicated message.

At step 410, the task manager determines which robotic machines (e.g., robots, drones) to employ to work together to perform the designated task. For example, the database of the task manager shown in FIG. 3 may store information about the designated task, including which sub-goals or sub-tasks may be required or at step least helpful to accomplish the designated task efficiently. The sub-tasks may be steps in the process of performing the task, such as moving toward a target object, engaging a certain portion of the target object, and applying a specific force on the target object to move the target object for a specified distance in a specified direction. The database may also store information about a group of multiple robotic machines including, but not limited to, the first and second robotic machines shown in FIG. 3. The information about the robotic machines may include capability descriptions associated with each robotic machine in the group. The capability descriptions may include a list of the capabilities or affordances of the corresponding robotic machine, such as the capability to grasp and pull a lever. A processor of the task manager may perform an affordance analysis by comparing the sub-tasks associated with the designated task to the capability descriptions of the available robotic machines in the group. The processor determines a level of suitability of each of the available robotic machines to the specific sub-tasks for the designated task. The available robotic machines may be ranked according to the level of suitability. For example, robotic machines that are capable of flying would rank highly for sub-tasks involving flight, but robotic machines incapable of flight would rank low for the same sub-tasks. The processor may rank the robotic machines, and determine the robotic machines to employ for the designated task based on the highest ranking available robotic machines for the sub-tasks.

In an example, the designated task involves manipulating a brake actuator, which generally requires a robotic arm engaging the brake actuator to move the brake actuator. If none of the available robotic machines that have robotic arms are tall enough or able to extend far enough to engage the brake actuator, the processor of the task manager may select one of the highest ranking available robotic machines that has a robotic arm. The processor may analyze the rest of the available robotic machines to determine which robotic machines are able to assist the robotic machine with the robotic arm. The processor may select a robotic machine that is capable of lifting the robotic machine having the robotic arm, such that the robotic arm is able to engage and manipulate the brake actuator when lifted. Thus, the task manager may select the robotic machines to employ for performing the designated task based on the suitability of the robotic machines to perform required sub-tasks as well as the suitability of the robotic machines to coordinate with each other.

At step 412, the task manager assigns a first sequence of sub-tasks to a first robotic machine and assigns a second sequence of sub-tasks to a second robotic machine. Although not shown in the illustrated embodiment, the task manager may assign sub-tasks to more than two robotic machines in other embodiments. For example, some tasks may require three or more robotic machines working together to complete. The sequences of sub-tasks may be specific steps or actions to be performed by the corresponding robotic machines in a specific order. The sub-tasks may be similar to instructions. The performance of all of the sub-tasks by the corresponding robotic machines in the correct order may complete or accomplish the assigned task. The first and second sequences of sub-tasks may be coordinated with each other. The first sequence of sub-tasks (to be performed by the first robotic machine) in an embodiment may be at least partially different than the second sequence of sub-tasks (to be performed by the second robotic machine). For example, at least some of the sub-tasks in the first sequence may differ from at least some of the sub-tasks in the second sequence, or vice-versa. Some sub-tasks may be common to both the first and second sequences, such that the sub-tasks may be performed by both robotic machines. In an embodiment, the first and second sequences of sub-tasks delineate specific steps or actions to be performed by the respective robotic machines and provide timing information. For example, the first sequence may specify an order that the sub-tasks are to be performed relative to each other and relative to the sub-tasks in the second sequence to be performed by the second robotic machine. Thus, the first sequence may specify that after completing a given sub-task, the first robotic machine is to wait until receiving a notification from the second robotic machine that a specific sub-task in the second sequence has been completed before starting a subsequent sub-task in the first sequence.

The first and second sequences of sub-tasks may be generated by the at least one processor of the task manager after determining which robotic machines to use, or may be pre-stored in the database or another memory device. For example, the database may store a list of potential assigned tasks and sequences of sub-tasks associated with each of the assigned tasks. Thus, upon generating the task and/or determining the robotic machines, the processor may access the database to select the relevant sequences of sub-tasks associated with the assigned task.

At step 414, the task manager may transmit the first sequence of sub-tasks to the first robotic machine and the second sequence of sub-tasks to the second robotic machine. For example, the first and second sequences may be transmitted in respective command messages via the communication circuit of the task manager. The task manager communicates a command message containing the first sequence of sub-tasks to the first robotic machine and another command message containing the second sequence to the second robotic machine.

At step 416, the first robotic machine receives the command message containing the first sequence of sub-tasks. At step 418 the second robotic machine receives the command message containing the second sequence of sub-tasks. The communication circuits of the first and second robotic machines shown in FIG. 3 receive the command messages and communicate the contents to the respective controllers. At step 420, the first robotic machine generates a sub-task performance plan based on the first sequence of sub-tasks. The sub-task performance plan may be motion planning by the first robotic machine that yields various motions, actions, and forces, including torques, to be produced by different components of the first robotic machine to perform the sub-tasks in the first sequence. The processors of the first robotic machine may use dynamic movement primitives to generate the performance plan. In an embodiment in which the first robotic machine may include the robotic arm (shown in FIG. 2), the sub-task performance plan may include a motion trajectory that plans the movement of the robotic arm from a starting position to the target object on the equipment. The sub-task performance plan may also provide a prescribed approach orientation of the robotic arm, including the claw of the end effector (shown in FIG. 2), as the robotic arm approaches and engages the target object, and planned forces to be exerted by the robotic arm on the target object to manipulate the target object (e.g., a planned pulling force, direction of the force, and/or distance along which the force may be applied). In other embodiments, the sub-task performance plan may specify coordinates and/or distances that the first robotic machine, or components thereof, moves. At step 422, the second robotic machine generates a sub-task performance plan based on the second sequence of sub-tasks. The sub-task performance plan of the second robotic machine may be different than the sub-task performance plan of the first robotic machine, but may be generated in a similar manner to the sub-task performance plan of the first robotic machine.

At step 424, the first robotic machine commences execution of the first sequence of sub-tasks. At step 426, the second robotic machine commences execution of the second sequence of sub-tasks. Although steps 424 and 426 are shown side-by-side in the diagram 400 of FIG. 4, the first and second robotic machines may or may not perform the respective sub-tasks during the same time period. Depending on the sequences of sub-tasks as communicated by the task manager, the first robotic machine may be ordered to start performing the sub-tasks in the first sequence before or after the second robotic machine starts performing the second sequence of sub-tasks.

In an embodiment, the first and second robotic machines may coordinate performance of the respective sequences of sub-tasks to accomplish the assigned task. Thus, the performance of the first sequence of sub-tasks by the first robotic machine may be coordinated with the performance of the second sequence of sub-tasks by the second robotic machine. In an embodiment, the first and second robotic machines coordinate by communicating directly with each other during the performances of the sub-tasks. At step 428, the first robotic machine provides a status notification to the second robotic machine. The status notification may be a message communicated wirelessly as electromagnetic RF signals from the communication circuit of the first robotic machine to the communication circuit of the second robotic machine. The second robotic machine receives the status notification at step 434. The status notification may inform the second robotic machine that the first robotic machine has started or completed a specific sub-task in the first sequence. The second robotic machine processes the received status notification and may use the status notification to determine when to start performing certain sub-tasks in the second sequence. For example, at least some of the sub-tasks in the first and second sequences may be sequential, such that the second robotic machine may begin performance of a corresponding sub-task in the second sequence responsive to receiving the notification from the first robotic machine that the first robotic machine has completed a specific sub-task in the first sequence. Other sub-tasks in the first and second sequences may be performed concurrently by the first and second robotic machines, such that the time period that the first robotic machine performs a given sub-task in the first sequence at least partially overlaps the time period that the second robotic machine performs a given sub-task in the second sequence. For example, both robotic machines may concurrently move towards the equipment. In another example, the first robotic machine may extend a robotic arm towards the target object of the equipment concurrently with the second robotic machine lifting the first robotic machine. Coordinated and concurrent actions by the robotic machines may enhance the efficiency of the performance of the assigned task on the equipment.

The first robotic machine may transmit a status notification upon starting and/or completing each sub-task in the first sequence, or may transmit status notifications only upon starting and/or completing certain designated sub-tasks of the sub-tasks in the first sequence, which may be identified in the command message sent from the task manager. At step 430, the second robotic machine provides a status notification to the first robotic machine. The status notification from the second robotic machine may be similar in form and/or function to the status notification sent from the first robotic machine at step 428. The first robotic machine receives the status notification from the second robotic machine at step 432.

At steps 436 and 438, respectively, the first and second robotic machines complete the performances of the first and second sequences of sub-tasks. At step 440, the first robotic machine transmits a task completion notification to the task manager that the first sequence may be completed. At step 442, the second robotic machine transmits a task completion notification to the task manager that the second sequence was completed. The first and second robotic machines may also notify each other upon completing the sequences of sub-tasks, and optionally may only transmit a single task completion notification to the task manager instead of one notification from each robotic machine. The one or more notifications inform the task manager that the assigned task was completed. At step 444, the task manager receives and processes the one or more notifications. The notification may also provide feedback information to the task manager, such as force parameters used to manipulate the target object on the equipment and other parameters monitored and recorded during the performance of the sub-tasks. The information received in the task completion notification may be used by the task manager to update the information provided in future command messages to robotic machines, such as the sequences of sub-tasks contained in the command messages. Upon receiving the task completion notification, the task manager may generate a new task for the same or different robotic machines. For example, the task manager may assign the same task to the same robotic machines for the robotic machines to perform the task on another the equipment in the same or a different the equipment system. Thus, the first and second robotic machines may be controlled to move along a length of the equipment system to perform the assigned task on multiple items of equipment of the equipment system. Alternatively, the task manager may control the same or different robotic machines to perform a different assigned task on the same equipment after completion of a first assigned task on the equipment.

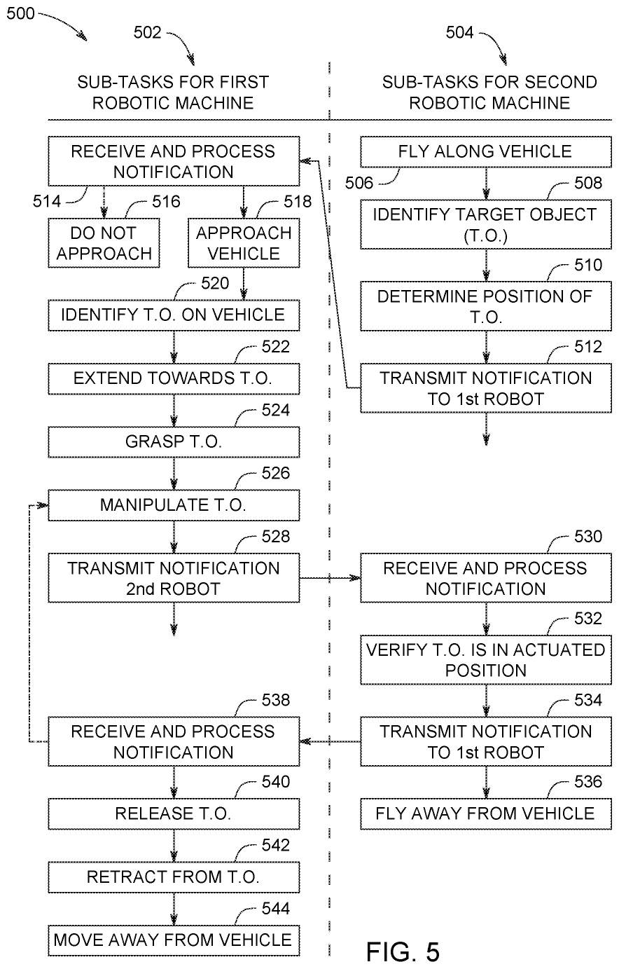

FIG. 5 is a block flow diagram 500 showing a first sequence 502 of sub-tasks assigned to a first robotic machine and a second sequence 504 of sub-tasks assigned to a second robotic machine for performance of an assigned task on the equipment according to an embodiment. The diagram may be described with reference to the grasping robotic machine and the aerial second robotic machine shown in FIG. 1. In the illustrated embodiment, the assigned task may be to manipulate a brake actuator of the first equipment of FIG. 1, such as the brake wheel of the hand brake system or the brake lever of the air brake system. The first and second sequences 502, 504 of sub-tasks may be transmitted to the grasping and aerial robotic machines by the task manager (shown in FIG. 3).

The first sub-task in the second sequence 504 at step 506 commands the aerial robotic machine to fly along the first equipment, such as above or along a side of the first equipment. At step 508, the aerial robotic machine identifies the target object, which may be the brake actuator. The aerial robotic machine may use the imaging device to generate image data of the surrounding environment including the first equipment. One or more processors of the aerial robotic machine may provide image analysis to identify the brake actuator in the image data captured by the imaging device. The aerial robotic machine at step 510 determines a position of the target object, such as a location of the brake actuator relative to the first equipment and/or whether the brake actuator is in an actuated or non-actuated position relative to the first equipment. For example, if the aerial robotic machine determines that the brake actuator is already in an actuated position, there may be no need to manipulate the brake actuator. The actuated position may represent, for example, a pulled position of the brake lever that indicates that step the air brake may be bled, or a rotated position of the brake wheel that indicates that the hand brakes may be released. The aerial robotic machine determines the position of the target object using image analysis. At step 512, the aerial robotic machine transmits a status notification to the grasping robotic machine. The status notification may be similar to the status notifications described at step 428 and 430 in FIG. 4. The status notification provides the position of the target object to the grasping robotic machine.

At step 514, the grasping robotic machine receives and processes the status notification transmitted by the aerial robotic machine. The processors (e.g., the processors shown in FIG. 3) of the robotic machine determine whether or not to approach the first equipment. For example, since the task may be to actuate a brake actuator of the first equipment, if the status notification indicates that the brake actuator may be already in the actuated position, then there may be no need to manipulate the brake actuator. Thus, if the brake actuator is in the actuated position, the grasping robotic machine at step 516 does not approach the equipment. Instead, the robotic machine may move towards another equipment on which the robotic machine may be assigned to perform a task. If, on the other hand, the brake actuator is determined by the aerial robotic machine to be in a non-actuated position, then the grasping robotic machine at step 518 approaches the equipment. For example, the robotic machine may drive or otherwise move along the ground towards the equipment and proximate to the brake actuator thereof.

At step 520, the grasping robotic machine identifies the target object on the first equipment. The robotic machine may identify the target object using image analysis based on image data captured by the imaging sensor (shown in FIG. 2). The image analysis may determine the location, tilt, size, and other parameters of the target object. At step 522, the robotic machine extends towards the target object. For example, the robotic arm (shown in FIG. 1) may extend from a retracted position to an extended position by generating torques at step various joints along the arm and/or by telescoping. At step 524, the robotic machine grasps and engages the target object. For example, the claw of the end effector (shown in FIG. 2) may grasp the brake actuator that step defines the target object. At step 526, the robotic machine manipulates the target object. In an embodiment, the robotic arm manipulates the brake actuator by moving the brake actuator from the non-actuated position to the actuated position. The robotic arm may rotate the brake wheel, translate the brake lever, or the like, to move the brake actuator to the actuated position. Upon manipulating the brake actuator, the grasping robotic machine at step 528 generates and transmits a status notification to the aerial robotic machine. The status notification informs the aerial robotic machine that the target object has been manipulated.

At step 530, the aerial robotic machine receives and processes the status notification received from the grasping robotic machine. Responsive to being notified that the target object has been manipulated, the aerial robotic machine at step 532 verifies whether or not the target object is fully actuated (e.g., has been fully and successfully manipulated to complete the task). For example, for a task to bleed air brakes, the verification may include validating that the valve of the air brake system has been sufficiently opened such that a sufficient amount of air has been released from the air brake system to allow the brake to move to a released state. Verification by the aerial robotic machine may be accomplished by various methods, including audibly recording the release of air using an audible sensor, detecting movement of the brakes to the released state using the imaging device, detecting that the brake lever is in a designated actuated position using the imaging device, and/or the like. Although not shown, the grasping robotic machine may also verify whether the brake lever is fully actuated, such as by using the encoder to detect that the robotic arm has moved the lever to a designated location, using the force sensor to detect the force exerted on the brake lever, and/or the like.

After the verification step, the aerial robotic at step 534 transmits a status notification to the grasping robotic machine, which may be received by the robotic machine at 538. The status notification contains the results of the verification step, such as whether or not the brake actuator has been fully actuated and the task has been successfully completed. If the status notification indicates that the brake actuator is not in the actuated position, then the grasping robotic machine may return to step 526 and manipulate the brake actuator a second time. If, on the other hand, the status notification indicates that the brake actuator is actuated and the task has been successfully completed, then the grasping robotic machine may, at step 540, control the robotic arm to release the brake actuator that defines the target object. At step 542, the robotic arm retracts away from the target object, returning to a retracted position on the robotic machine. At step 544, the grasping robotic machine moves on the ground away from the first equipment.

At step 536, the aerial robotic machine flies away from the first equipment. For example, the aerial robotic machine may fly towards a subsequent item of equipment (e.g., the second equipment shown in FIG. 1), and may repeat the first sequence at step 504 of sub-tasks for the second equipment. Although not shown, the aerial robotic machine may provide guidance for the grasping robotic machine as the grasping robotic machine moves along the ground. The aerial robotic machine provides guidance by monitoring for obstacles along a path of the robotic machine, and may notify the robotic machine if the aerial robotic machine detects the presence of an obstacle.

As shown in FIG. 5, the two robotic machines collaborate during the performance of the respective sub-tasks to accomplish the assigned task. The aerial robotic machine may inspect the target object, verify actuation of the target object, and/or provide guidance for the grasping robotic machine. The grasping robotic machine may engage and manipulate the target object on the equipment. It may be recognized that at least some of the sub-tasks in the first and second sequences 502, 504 may be sequential, and at least some may be concurrent. For example, the grasping robotic machine does not approach the equipment at step 518 until receiving the notification from the aerial robotic machine that is transmitted at step 512. The aerial robotic machine may perform the sub-task of flying away from the equipment at step 536 concurrently to the grasping robotic machine releasing the target object, retracting from the target object, and/or moving away from the equipment at steps 540-544.

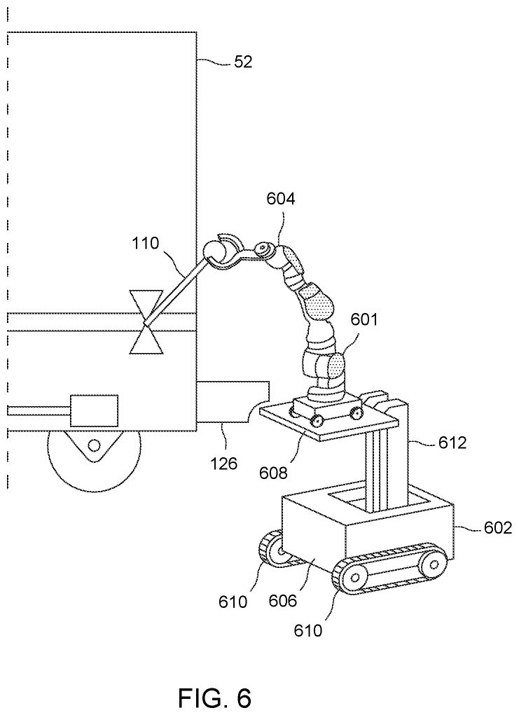

FIG. 6 is a perspective view of two robotic machines collaborating to perform an assigned task on the first equipment according to another embodiment. The task involves pulling a brake lever of the first equipment. A first robotic machine 601 may be a grasping robotic machine that may include a robotic arm 604 and may be at least similar to the grasping robotic machine shown in FIG. 2. In the illustrated embodiment, the grasping robotic machine may be too short and cannot extend far enough to properly reach and engage the brake lever. A second robotic machine 602 may be a lifting robotic machine that may be collaborate with the grasping robotic machine 601 to perform the assigned task. The lifting second robotic machine may include a body 606 and a platform 608 that may be movable vertically relative to the body. The body may include continuous tracks 610 for allowing the second robotic machine to navigate obstacles and rocky terrain. The platform may be coupled to the body via a telescoping tower 612 that may be used to lift and lower the platform relative to the body.

In the illustrated embodiment, the assigned task may be performed by the lifting second robotic machine and the grasping first robotic machine each performing a respective sequence of sub-tasks (e.g., assigned by a task manager). For example, a first sequence of sub-tasks for the grasping robotic machine may include driving onto the platform of the lifting robotic machine, when the platform may be in a lowered, starting location at or proximate to the ground. A second sequence of sub-tasks for the lifting robotic machine may include lifting the grasping robotic machine on the platform vertically upwards from the starting location to a lifted location that may be disposed more proximate to the brake lever (or another target object) than when the grasping robotic machine is in the starting location. Once the grasping robotic machine is in the lifted location, the robotic arm extends to the brake lever, grasps the brake lever, and manipulates the brake lever by pushing or pulling in a designated direction. After manipulating the brake lever and verifying that the brake lever manipulation has been successfully completed, the grasping robotic machine sends a notification to the lifting robotic machine. Responsive to receiving the notification, the lifting robotic machine lowers the platform, and the grasping robotic machine thereon, back to the starting location on or proximate to the ground. Alternatively, the lifting robotic machine may lower the platform to an intermediate location, and may carry the grasping robotic machine to another the equipment for performance of the same or a similar task on the other the equipment. An additional robotic machine, such as the aerial robotic machine shown in FIG. 1, optionally may be employed to collaborate with the robotic machines 601, 602 in the performance of the assigned task.

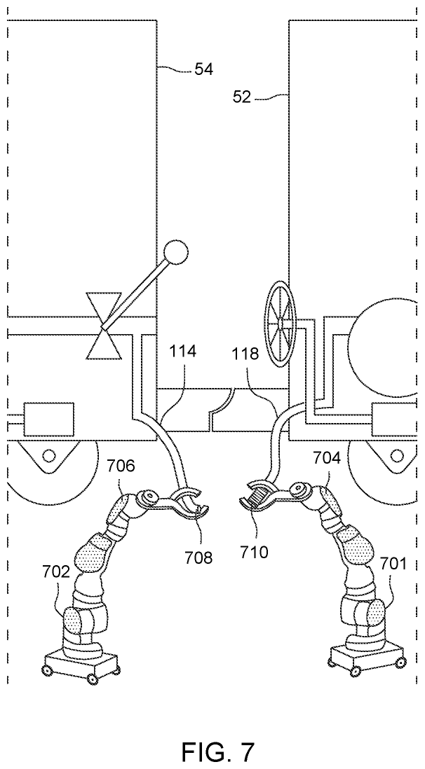

FIG. 7 is a perspective view of two robotic machines 701, 702 collaborating to perform an assigned task on a first equipment according to yet another embodiment. The assigned task involves connecting a second air hose of the first equipment to a corresponding first air hose of a second equipment adjacent to the first equipment. The task may be referred to as hose lacing. The two robotic machines may both be grasping robotic machines at least similar to the grasping robotic machine in FIG. 2. A first robotic machine 701 and a second robotic machine 702 include respective first and second robotic arms 704, 706, each similar to the robotic arm shown in FIG. 2.

In an embodiment, the first robotic machine performs the first sequence of sub-tasks by locating and identifying the second air hose of the first equipment, then extending the first robotic arm and grasping the second air hose. The second robotic machine performs the second sequence of sub-tasks by locating and identifying the first air hose of the second equipment, then extending the second robotic arm and grasping the first air hose. The second sequence of sub-tasks may instruct the second robotic machine to adjust an orientation of an end 708 of the first air hose to a designated orientation relative to the first equipment. The first sequence of sub-tasks may instruct the first robotic machine to adjust both the position and orientation of an end 710 of the second air hose. The first robotic arm of the first robotic machine may move relative to the second robotic arm of the second robotic machine towards the first air hose in order to connect the end of the second air hose to the end of the first air hose. One or both of the robotic arms may move and/or rotate to secure the hoses to one another, such as via a bayonet-style connection. The robotic machines may coordinate the movements by communicating directly with each other during the performance of the assigned task. The robotic machines may also be configured to collaborate to disconnect the air hoses in another assigned task.

In an embodiment, a system (e.g., a control system) may include a first robotic machine, a second robotic machine, and a task manager. The first robotic machine has a first set of capabilities for interacting with a surrounding environment. The second robotic machine has a second set of capabilities for interacting with the surrounding environment. The task manager has one or more processors. The task manager may select the first and second robotic machines from a group of robotic machines to perform a task that involves at least one of manipulating or inspecting a target object of the equipment that may be separate from the first and second robotic machines. The task manager may select the first and second robotic machines to perform the task based on the first and second sets of capabilities of the respective first and second robotic machines. The task manager assigns a first sequence of sub-tasks to the first robotic machine for performance by the first robotic machine and a second sequence of sub-tasks to the second robotic machine for performance by the second robotic machine. The first and second robotic machines may coordinate performance of the first sequence of sub-tasks by the first robotic machine with performance of the second sequence of sub-tasks by the second robotic machine to accomplish the task.

Optionally, the first and second sets of capabilities of the first and second robotic machines each include at least one of flying, driving, diving, lifting, imaging, grasping, rotating, tilting, extending, retracting, pushing, pulling, welding, cutting, polishing, spraying, and/or the like. The second set of capabilities of the second robotic machine may include at least one capability that differs from the first set of capabilities of the first robotic machine. The task may include actuating a lever to open a valve of the equipment.

Optionally, the first and second robotic machines coordinate performance of the first sequence of sub-tasks by the first robotic machine with the performance of the second sequence of sub-tasks by the second robotic machine by communicating directly with each other. Responsive to completing a corresponding sub-task in the first sequence, the first robotic machine may notify the second robotic machine that the corresponding sub-task is complete. At least some of the sub-tasks may be sequential such that the second robotic machine may begin performance of a corresponding sub-task in the second sequence responsive to receiving a notification from the first robotic machine that the first robotic machine has completed a specific sub-task in the first sequence. The first robotic machine may perform at least one of the sub-tasks in the first sequence concurrently with performance of at least one of the sub-tasks in the second sequence by the second robotic machine.

Optionally, the task manager may access a database that stores capability descriptions corresponding to each of the robotic machines in the group of robotic machines. The task manager may select the first and second robotic machines to perform the task instead of other robotic machines in the group based on a suitability of the capability descriptions of the first and second robotic machines to the task. The first robotic machine may perform the first sequence of sub-tasks by lifting the second robotic machine from a starting location to a lifted location such that the second robotic machine in the lifted location may be disposed more proximate to the target object of the equipment than when the second robotic machine is in the starting location. Responsive to receiving a notification from the second robotic machine that at least one of manipulation or inspection of the target object is complete, the first robotic machine may lower the second robotic machine back to the starting location.

Optionally, the first robotic machine may perform the first sequence of sub-tasks by flying above or along a side of the equipment, identifying the target object of the equipment, determining a position of the target object, and providing a notification to the second robotic machine of the position of the target object. The second robotic machine performs the second sequence of sub-tasks by moving on the ground to the equipment proximate to the target object, extending a robotic arm of the second robotic machine to the target object, engaging and manipulating the target object, releasing the target object, and retracting the robotic arm.

Optionally, multiple items of equipment may be coupled together. The first robotic machine may perform the first sequence of sub-tasks by extending a robotic arm of the first robotic machine and grasping a target object of the first equipment. The second robotic machine may perform the second sequence of sub-tasks by extending a robotic arm of the second robotic machine to a target object of the second equipment adjacent to the first equipment. The robotic arms of the first and second robotic machines move relative to one another with the corresponding target objects to at least one of connect or disconnect them.

In an embodiment, a system (e.g., a control system) includes a first robotic machine and a second robotic machine. The first robotic machine has a first set of capabilities for interacting with a surrounding environment. The first robotic machine may receive a first sequence of sub-tasks related to the first set of capabilities of the first robotic machine. The second robotic machine has a second set of capabilities for interacting with the surrounding environment. The second robotic machine may receive a second sequence of sub-tasks related to the second set of capabilities of the second robotic machine. The first and second robotic machines may perform the first and second sequences of sub-tasks, respectively, to accomplish a task that involves at least one of manipulating or inspecting a target object of the equipment that may be separate from the first and second robotic machines. The first and second robotic machines may coordinate performance of the first sequence of sub-tasks by the first robotic machine with performance of the second sequence of sub-tasks by the second robotic machine.

Optionally, the second set of capabilities of the second robotic machine may include at least one capability that differs from the first set of capabilities of the first robotic machine. At least some of the sub-tasks may be sequential such that the second robotic machine may be begin performance of a corresponding sub-task in the second sequence responsive to receiving a notification from the first robotic machine that the first robotic machine has completed a specific sub-task in the first sequence. The first robotic machine may perform the first sequence of sub-tasks by moving the second robotic machine from a starting location to a moved location such that the second robotic machine in the moved location and thereby disposed proximate to the target object of the equipment more so than when the second robotic machine was in the starting location. Responsive to receiving a notification from the second robotic machine that at least one of manipulation or inspection of the target object is complete, the first robotic machine lowers the second robotic machine back to the starting location.

In an embodiment, a system includes a first robotic machine that has a set of capabilities for interacting with a surrounding environment. The first robotic machine has a communication circuit that can receive a first sequence of sub-tasks for performing a task that involves at least one of manipulating or inspecting a target object of the equipment. The first sequence of sub-tasks may relate to the set of capabilities of the first robotic machine. The first robotic machine may perform the first sequence of sub-tasks. The first robotic machine may communicate with a second robotic machine during the performance of the first sequence of sub-tasks. The second robotic machine may perform a second sequence of sub-tasks for performing the task. Completion of both the first and second sequences of sub-tasks accomplishes the task. The first robotic machine may communicate with the second robotic machine during the performance of the first sequence of sub-tasks to coordinate with the second robotic machine such that the first robotic machine starts a corresponding sub-task in the first sequence responsive to a received notification from the second robotic machine that the second robotic machine has at least one of started or completed a specific sub-task in the second sequence. Responsive to completing a corresponding sub-task in the first sequence, the first robotic machine may transmit a notification to the second robotic machine that the corresponding sub-task is complete. The first robotic machine has a movable robotic arm. The set of capabilities include the robotic arm extending relative to the first robotic machine, grasping the target object, manipulating the target object, releasing the target object, and retracting relative to the first robotic machine.

In one embodiment, each robotic machine is equipped with one or more sensors and tools. Suitable sensors may include force-torque (F/T) sensors, tactile sensors, encoders, cameras, chemical sensors, bio-sensors, lidar, radar, time-of-flight (TOF) sensors, thermometers, pressure sensors, acoustic and vibration sensors, accelerometers (e.g., position, angle, displacement, speed and acceleration sensors), magnetic sensors, electric current or electric potential sensors (e.g., voltage sensors), radiation sensors, and triangulation sensors. Suitable triangulation sensors may include microwave sensors and camera sensors. In a collaborative robotic team, robotic machines may have different capabilities for different tasks or for different subtasks of a give task. In this way, the sensor function may be distributed across a number of robotic machines. For example, one robot can have camera sensor, one robot can have an infrared (IR) sensor, and one robot can have acoustic sensors. The robot with the visual optical camera sensor may have a light source to produce both visible and infrared light. The camera might then record an image of a working area on the work object, while the IR sensor may use the IR spectrum from the light source for triangulation of a tool, being manipulated by its supporting robotic machine, with regard to the work object. For example, an 880 nm LED light source may emit a collimated, near-infrared light beam. The beam bounces off the work object and/or another robotic machine, and is received by a photodiode positioned adjacent to the LED source. A second photodiode (or a linear array of photodiodes) may be positioned farther along the length of the sensor. When the emitted beam bounces off a determine target, the reflected energy is concentrated on the first adjacent photodiode. When an object, such as an arm with a tool of another robotic machine, moves into the optical path, the reflected beam bounces back from the object. Because the beam is no longer traveling the full optical path length, its reflected angle changes. One of the adjacent photodiodes may receive or sense the optical energy and the first robotic machine responds by sending a signal to the second robotic machine. At that point the second robotic machine may slow or stop movement of the arm to prevent or reduce the chance of a collision. In this way, the robotic machines can share information with each other to perform some tasks or subtasks. In one embodiment, various robotic machines, or portions of such machines, have one or more register marks. These register marks may be sensed by various sensors communicatively coupled to the task manager or other robotic machines. When sensed, the distance, orientation, and location of the register mark (and by extension a tool of a robotic machine) may be determined. Additionally or alternatively, bar codes (2D and/or 3D) disposed on a portion of a robotic machine may be used to both identify the robotic machine (or portion thereof) and act as a register mark when sensed by a sensor.

The robotic machines can have implements (e.g., tools and tool sets) that differ from each other. For example, various robotic machines may each have one or more of: 2-finger grippers, multi-finger grippers, magnet grippers, vacuum grippers, screw drivers, wrench, welding tool, rotary saw, grinder, impact hammer, and the like. In one embodiment, the grippers are sized and shaped to grab and lift one or more rail ties, rails, tie plates, or spike heads. Other suitable implements may include spray booms and spray nozzles. Other suitable implements may include spike drivers. Accordingly, while performing a subtask the sensors from one or more robotic machines may be used to guide the tools of one or more other robotic machines. Naturally, a suitable target object may include rail track, a rail tie, a tie plate, a rail tie fastener, or ballast material. The rail tie may be grabbed with a claw, the rail tie may be placed with a gripper or a magnet, the spike may be driven (for example through an aperture in the tie plate), and the spike head may be pulled. In one embodiment, a suitable target object is vegetation. The vegetation may be cut with a saw, grabbed with a claw, sprayed with a nozzle, and the like.

With regard to communication between robotic machines working on a task, in one embodiment a centralized task manager coordinates communication among robots and acts as a communication hub. That is, each robotic machine communicates with the hub but not necessarily with each other. In another embodiment, the robotic machines may have both centralized communication and distributed communication. That is, the robotic machines can both communicate through the task manager and communicate to each other directly. Alternatively, once a task has been assigned, the robotic machines may only communicate with each other and may not communicate back to a central task manager. Further, with regard to an embodiment in which a task manager is not available or is not used, the robotic machines may function autonomously. They may identify tasks to be done and assign robotic machines to perform that task. They further may assign out sub-tasks for that task to the plurality of assigned robotic machines.

Suitable robotic machines may be mobile and have wheels, tracks, a plurality of legs, rotors, propellers, and the like. Other robotic machines may be stationary, and the work object and/or other mobile robotic machines may be brought to the stationary robotic machine. The concept of stationary and mobile may be extended to include where an otherwise mobile robotic machine anchors itself, at least temporarily, relative to the work object and/or another robotic machine. In one embodiment, the robotic machine anchors itself directly to the work object. It may do this using implements. In another embodiment, the robotic machine may anchor itself to a portion of the nearby environment (e.g., the ground). Suitable environmental anchors may include stabilizing legs, drills or augers, clamps, and the like.

In one embodiment, the task manager may include a protected space data source and an exposed space data source. The protected space data source might store, for each of a plurality of monitoring nodes, a series of normal values that represent normal operation of a system such as those systems described herein. Such values may be generated by a model or collected from actual monitoring node data, or simply set as factory standards. A monitoring node refers to, for example, location signals, sensor data, signals sent to actuators, motors, pumps, and auxiliary equipment, intermediary parameters that are not direct sensor signals not the signals sent to auxiliary equipment, and/or control logical(s). These may represent, for example, monitoring nodes that receive data from an exposed monitoring system in a continuous fashion in the form of continuous signals or streams of data or combinations thereof. This exposed monitoring system stores data and information in the exposed space data source. Moreover, the monitoring nodes may be used to monitor occurrences of communication faults, cyber-threats or other abnormal events. This data path may be designated specifically with encryptions or other protection mechanisms so that the information may be secured and not be tampered with via cyber-attacks. The exposed space data source might store, for each of the monitoring nodes, a series of values that represent an undesirable operation of the system (e.g., when the system is experiencing a cyber-attack). Suitable encryption protocols may be used, such as hashing (e.g., MD5, RIPEMD-160, RTRO, SHA-1, SHA-2, Tiger, WHIRLPOOL, RNGss, Blum Blum Shub, Yarrowm etc.), key exchange encryption (e.g., Diffie-Hellman key exchange), symmetric encryption methods (e.g., Advanced Encryption Standard (AES), Blowfish, Data Encryption Standard (DES), Twofish, Threefish, IDEA, RC4, Tiny Encryption algorithm, etc.), asymmetric encryption methods (e.g., Rivest-Shamir-Adlemen (RSA), DAS, ElGamal, Elliptic curve cryptography, NTRUEncrypt, etc.), or a combination thereof.

During operation, information from the protected space data source and the exposed space data source may be evaluated by the task manager to identify a decision boundary (that is, a boundary that separates desired behavior from undesired behavior). If data or information flowing from the monitoring nodes, when evaluated, identifies with the protected space data source, or within a determined limit relative thereto, the task manager will continue operation normally. However, if the data or information in the exposed space data source crosses the decision boundary, the task manager may initiate a safe mode in response. The safe mode may be, in one embodiment, a soft shutdown mode that it intended to avoid damage or injury based on the shutdown itself.

In one embodiment, the first robotic machine may include one or more sensors to detect one or more characteristics of a target object and a second robotic machine may include one or more effectors to perform an operation based on a task assigned by the task manager. The operation may be to assess, repair, and/or service the target object. The robot system may include a processing system that includes one or more processors operatively coupled to memory and storage components. While this may be conceptualized and described in the context of a single processor-based system to simplify explanation, the overall processing system used in implementing a task management system as discussed herein may be distributed throughout the robotic machines and/or implemented as an off-board centralized control system. With this in mind, the processor may generate a set of sub-tasks to assess the target object for defects. For example, the task manager may determine a task including the sub-tasks (e.g., desired inspection coverage of the target object) and/or resources (e.g., robot machine capabilities) available. Based on the generated set of sub-tasks, the task manager may implement the task by sending signal(s) to the robotic machines and thereby provide sub-task instructions to perform the task. A controller of each robotic machine may process any received instructions and in turn signal(s) to one or more implements controlled by the respective robotic machine to control operation and to perform the assigned sub-tasks.

The task may include a plurality of sub-tasks to be collectively performed by at least the first and second robotic machines. Further, the task manager may adjust (e.g., revise) the sub-tasks based on the data received from sensors related to the target object. For example, the sub-task may be adjusted based on acquired data indicative of a potential defect of the target object. The task manager may send a signal(s) encoding or conveying instructions to travel a specified distance and/or direction that enables the robotic machine to acquire additional data related to the target object associated with the potential defect.

Upon performing the assigned tasks, the task manager may assess the quality of data received from the sensors. Due to a variety of factors, the quality of the data may be below a threshold level of quality. For example, pressure sensors or acoustic sensors may have background noise due to the conditions proximate to the target object. As such, the task manager may determine a signal-to-noise ratio of the signals from the sensors that indicates a relationship between a desired signal and background noise. If the task manager determines that the signal-to-noise ratio falls below a threshold level of quality, the task manager may adapt the sub-task to acquire additional data and/or improve the quality of the data feed. If the task manager determines that the signal-to-noise ratio is above a threshold level of quality, the task manager may proceed to perform maintenance actions associated with the sub-tasks based on the sensor data.

In certain embodiments, to perform maintenance actions, the task manager may generate, maintain, and update a digital representation of the target object based on one or more characteristics that may be monitored using robotic machine intermediaries and/or derived from known operating specifications. For example, the task manager may create a digital representation that includes, among other aspects, a 3D structural model of the target object (which may include separately modeling components of the target object as well as the target object as a whole). Such a structural model may include material data for one or more components, lifespan and/or workload data derived from specifications and/or sensor data, and so forth. The digital representation, in some implementations may also include operational or functional models of the target object, such as flow models, pressure models, temperature models, acoustic models, living models, and so forth. Further, the digital representation may incorporate or separately model environmental factors relevant to the target object, such as environmental temperature, humidity, pressure (such as in the context of a submersible target object, airborne target object, or space-based target object). As part of maintaining and updating the digital representation, one or more defects in the target object as a whole or components of the target object may also be modeled based on sensor data communicated to the processing components.

Depending on the characteristics of the structural model, the task manager may generate a task specifying one or more tasks or action, such as acquiring additional data related to the target object. For example, if the task manager determines that acquired data of a location on the structural model is below a threshold quality level or is otherwise insufficient, the task manager may generate or update a revised task that includes one or more tasks that position the robot to acquire additional data regarding the location.

Sensor data may be used to generate, maintain, and update the digital representation, including modeling of defects. The sensors used to collect the sensor data may vary between robotic machines. Example of sensors include, but are not limited to, cameras or visual sensors capable of imaging in one or more of visible, low-light, ultraviolet, and or infrared (i.e., thermal) contexts, thermistors or other temperature sensors, material and electrical sensors, pressure sensors, acoustic sensors, radiation sensors or imagers, probes that apply non-destructive testing technology, and so forth. With respect to probes, for example, the robotic machine may contact or interact physically with the target object to acquire data.

The environment's digital representation may incorporate or be updated based on a combination of factors derived from the data of one or more sensors on the robotic machine (or integral to the target object itself). Acquired sensor data may be subjected to a feature extraction algorithm. In some implementations, relatively faster processing can be achieved by performing feature extraction on data obtained by RGB or infrared cameras. In some implementations, scale-invariant feature transform (SIFT) and speeded up robust features (SURF) techniques may provide additional information on descriptors—for example, Oriented FAST and rotated BRIEF (ORB) feature extraction can be performed. In other implementations, simple color, edge, corner, and plane features can be extracted.

The task manager may receive visual image data from imaging sensors (e.g., cameras, lidar) on the robotic machines to create or update a 3D model of the target object to localize defects on the 3D model. Based on the sensor data, as incorporated into the 3D model, the task manager may detect a defect, such as a crack, a region of corrosion, or missing part, of the target object. For example, the task manager may detect a crack on a location of a vehicle based on visual image data that includes color and/or depth information indicative of the crack. The 3D model may additionally be used as a basis for modeling other layers of information related to the target object. Further, the task manager may determine risk associated with a potential or imminent defect based on the digital representation. Depending on the risk and a severity of the defect, the task manager, as described above, may send signal(s) to the robotic machines indicating instructions to repair or otherwise address a present or pending defect.

In one embodiment, the task manager (or another controller or control system) may have a local data collection system deployed that may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. In examples, machine learning may include a plurality of other tasks based on an output of the machine learning system. In examples, the tasks may be machine learning problems such as classification, regression, clustering, density estimation, dimensionality reduction, anomaly detection, and the like. In examples, machine learning may include a plurality of mathematical and statistical techniques. In examples, the many types of machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for vehicle performance and behavior analytics, and the like.

In one embodiment, the task manager, controller, and/or control system, may include a policy engine that may apply one or more policies. These policies may be based at least in part on characteristics of a given item of equipment or environment. With respect to control policies, a neural network can receive input of a number of environmental and task-related parameters. These parameters may include an identification of a task, data from various sensors, and location and/or position data. The neural network can be trained to generate an output based on these inputs, with the output representing an action or sequence of actions that the vehicle group should take to accomplish the trip plan. During operation of one embodiment, a determination can occur by processing the inputs through the parameters of the neural network to generate a value at the output node designating that action as the desired action. This action may translate into a signal that causes equipment to operate. This may be accomplished via back-propagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network are generated and then different adjustments to the parameters are made, and simulations are done. Once the output from the various models are obtained, they may be evaluated on their performance using a determined success metric. The best model is selected, and the vehicle controller executes that plan to achieve the desired input data to mirror the predicted best outcome scenario. Additionally, the success metric may be a combination of the optimized outcomes, which may be weighed relative to each other.

In some embodiments, to repair, remediate, or otherwise prevent a defect, the task manager may create a 3D model of a part or component pieces of the part of the target object needed for the repair. The task manager may generate descriptions of printable parts or part components (i.e., parts suitable for generation using additive manufacturing techniques) that may be used by a 3D printer (or other additive manufacturing apparatus) to generate the part or part components. Based on the generated instructions or descriptions, the 3D printer may create the 3D printed part to be attached to or integrated with the target object as part of a repair process. Further, one or more robotic machines may be used to repair the target object with the 3D printed part(s). While a 3D printed part is described in this example, other repair or remediation approaches may also be employed. For example, in other embodiments, the task manager may send signal(s) indicating instructions to a controller of a robotic machine to control the robotic machine to spray a part of the target object (e.g., with a lubricant, galvanic coating, sealant or spray paint) or to replace a part of the target object from an available inventory of parts. Similarly, in some embodiments, a robotic machine may include a welding apparatus that may be autonomously employed to perform an instructed repair. In some embodiments, the task manager may send signal(s) to a display to indicate to an operator to enable the operator to repair the defect using one or more implements of the robotic machines.

Accurate position control and navigation of an unmanned aerial vehicle (UAV) in GPS denied environments, such as indoors, may be challenging as alternatives may rely on inertial sensors or other sources such as vision. Inertial sensing may be prone to drifts and biases, while alternative techniques such as vision-based may be computationally intensive. Features of the system may include the use of one or more laser beam transmitters, one or more reflectors, and quad detectors (or cameras) mounted on gimbals on the drone. The laser transmitter through the reflector transmits a laser beam in any desired direction. For any desired height of the drone, exact position in space could be specified using the spherical angles at which the laser beam is transmitted. The drone, upon achieving the waypoint is then stabilized by a controller that locks the laser beam to the quad detector. Due to positioning or navigational errors, if the drone does not achieve detection of the laser beam in the expected amount of time, the laser beam is raster scanned till the quad detector achieves detection. Upon the initial laser lock, the laser beam angle is shifted within specified maximum angular rate such that given commanded height, the drone can navigate while maintaining laser lock. This is achieved by a controller that tries to minimize the offset of laser beam impact point on the detector and the detector center or a pre-specified radius around the detector center. If laser lock is lost during guidance, then either the laser beam could be moved to the previous position where lock was achieved, while keeping the drone in hover mode or the drone could navigate based on inertial sensing to the current waypoint specified by laser beam angle and commanded height, or a combination of the two. In order to achieve this feedback, quad detector measurements could be provided to the laser transmitter/mirror controller.

With regard to robotic machine positioning and stabilization, the pose estimate of the robotic machine camera can be used to localize an object or region within the field of view of the camera through trigonometric transforms. This setup can be used to localize artifacts on, for example, walls, trees, buildings, etc. during inspection for offline analysis or for providing the next waypoint for the robotic machine to make a closer inspection. In one embodiment, a laser transmitting unit(s) mounted on a first robotic machine interacts with a detector mounted on the second robotic machine. The laser transmitter includes a laser source, which may be incident on a mirror mounted on a motor-controlled stage. Motors may be used to actuate the mirror, and to give pan and tilt flexibility. The flexibility allows for the steering or pointing of the laser. A detector mounted on the second robotic machine may have one or more detection units. The detection unit may include a focusing lens to better direct the laser beam and increase a field of view. The second robotic machine may start its travel, e.g., flight, from a position where the detector sees the incident laser light. With an initial lock of the detector onto the laser light, the motors connected to the mirror actuate as required to steer the laser toward a region of interest. Using this knowledge and applying geometric transformations, the pan and tilt angles may be converted to positional feedback to the second robotic machine, where the robotic machine's control unit then reacts accordingly such that the laser beam is kept at the center of the detector. Height and/or distance information may be collected from an altitude measurement sensor (affixed to the second robotic machine). Such z-dimensional information may aid in 3D movement.

In one embodiment, multiple lasers and detectors may be used to increase the accuracy of the system and navigation. The second robotic machine may be controlled by the first robotic machine even if an obstacle occludes individual beams from reaching the detector. For situations where there is a requirement to see around corners, multiple robotic machines can be deployed, and an intermediate robotic machine may act as a repeater. The intermediate robotic machine may be deployed with a beam splitter+detector installed. The beam splitter may reflect half of the incident light on to the second robotic machine and its detector. The remaining half of the light may reach a detector present on the intermediate robotic machine. Using the same laser-locking strategy, the position of the intermediate robotic machine may be known.

The imaging sensor of the second robotic machine may be used for both navigation/localization as well as for inspection purposes. Further, the laser may be used for both navigation/localization as well as for line-of-sight data transmission.

Although embodiments of the subject matter are described herein with respect to mobile equipment and vehicles, embodiments of the inventive subject matter are also applicable for use with other equipment generally. Suitable vehicles may include rail cars, trains, locomotives, and other rail vehicles. Other suitable vehicles may include mining vehicles, agricultural vehicles, and other off-highway vehicles (e.g., vehicles that are not designed or permitted to travel on public roadways), automotive or passenger vehicles, aircraft (manned and unmanned), marine vessels, and/or freight transportation vehicles (e.g., semi-tractor/trailers and over-the-road trucks). The term ‘consist’ refers to two or more robotic machines or items of mobile equipment that are mechanically or logically coupled to each other. By logically coupled, the plural items of mobile equipment are controlled so that controls to move one of the items causes a responsive movement (e.g., a corresponding movement) in the other items in consist, such as by wireless command.

In an embodiment, a system includes a first robotic machine having a first set of capabilities for interacting with a target object, a second robotic machine having a second set of capabilities for interacting with the target object, and a task manager. The task manager has one or more processors and is configured to determine capability requirements to perform a task on the target object; the task has an associated series of sub-tasks, with the sub-tasks having one or more capability requirements. The task manager is also configured to assign a first sequence of sub-tasks to the first robotic machine for performance by the first robotic machine based at least in part on the first set of capabilities and a second sequence of sub-tasks to the second robotic machine for performance by the second robotic machine based at least in part on the second set of capabilities. The first and second robotic machines are configured to coordinate performance of the first sequence of sub-tasks by the first robotic machine with performance of the second sequence of sub-tasks by the second robotic machine, and thereby to accomplish the task.

In another embodiment, the first and second sets of capabilities of the first and second robotic machines each include at least one of flying, driving, diving, lifting, imaging, grasping, rotating, tilting, extending, retracting, pushing, and/or pulling. In another embodiment, the second set of capabilities of the second robotic machine include at least one capability that differs from the first set of capabilities of the first robotic machine. In another embodiment, the first and second robotic machines coordinate performance of the first sequence of sub-tasks by the first robotic machine with the performance of the second sequence of sub-tasks by the second robotic machine by communicating directly with each other. In another embodiment, the first robotic machine notifies the second robotic machine, directly or indirectly, that one of the corresponding sub-tasks is complete and the second robotic machine is responsive to the notification by performing a corresponding sub-task in the second sequence.

In another embodiment, the first robotic machine provides to the second robotic machine, directly or indirectly, a sensor signal having information about the target object, and the task manager makes a decision whether the second robotic machine proceeds with a sub-task of the second sequence based at least in part on the sensor signal. In another embodiment, at least some of the sub-tasks are sequential such that the second robotic machine begins performance of a dependent sub-task in the second sequence responsive to receiving a notification from the first robotic machine that the first robotic machine has completed a specific sub-task in the first sequence. In another embodiment, the first robotic machine performs at least one of the sub-tasks in the first sequence concurrently with performance of at least one of the sub-tasks in the second sequence by the second robotic machine.

In another embodiment, the task manager is configured to access a database that stores capability descriptions corresponding to each robotic machine in a group of robotic machines, and the task manager is further configured to select the first and second robotic machines to perform the task instead of other robotic machines in the group based on a suitability of the capability descriptions of the first and second robotic machines relative to capability needs ascribed in the database to the task or corresponding sub-tasks.

In another embodiment, the first robotic machine performs one or more of the first sequence of sub-tasks by coupling to and lifting the second robotic machine from a starting location to a lifted location such that the second robotic machine in the lifted location is positioned relative to the target object to complete one or more of the second sequence of sub-tasks than if the second robotic machine is in the starting location. In another embodiment, the first robotic machine performs the first sequence of sub-tasks by flying, and the first robotic machine identifies the target object and determines at least two of: a position of the target object, a position of the first robotic machine, and a position of the second robotic machine, and the second robotic machine performs the second sequence of sub-tasks by one or more of modifying the target object, manipulating the target object, observing the target object, interacting with the target object, and releasing the target object.

In another embodiment, the first robotic machine, having been assigned a sequence of sub-tasks by the task manager: determines to travel a determined path from a first location to a second location, or determines to act using a capability of the first set of capabilities, or both determines to travel the intended path and determines to act using the capability, and signals to the second robotic machine, to the task manager, or both the second robotic machine and the task manager information including at least one of the determined path, the act of using the capability, or both. In another embodiment, the second robotic machine, responsive to the signal from the first robotic machine, initiates a confirmatory receipt signal back to the first robotic machine.

In another embodiment, the first robotic machine and the second robotic machine each are configured to generate one or more of: time indexing signals associated one or both of the first sequence of sub-tasks and the second sequence of sub-tasks, position indexing signals for locations of one or both of the first robotic machine and the second robotic machine, and orientation indexing signals for one or more tools configured to implement one or both of the first set of capabilities of the first robotic machine and the second set of capabilities of the second robotic machine. In another embodiment, at least one of the first robotic machine and/or the second robotic machine has a first mode of operation that is a fast, gross movement mode and a second mode of operation that is a slow, fine movement mode. In another embodiment, the system further includes one or more of a stabilizer, an outrigger, and/or a clamp, and a transition in operation from the first mode to the second mode comprises deploying and setting the stabilizer, outrigger, or clamp. In another embodiment, the first mode of operation includes moving at least one of the first robotic machine and the second robotic machine to a determined location relative to the target object. The second mode of operation includes actuating one or more tools of at least one of the first robotic machine and the second robotic machine accomplish the task or a sub-task.

In an embodiment, a system includes a first robotic machine and a second robotic machine. The first robotic machine has a first set of capabilities for interacting with a surrounding environment. The first robotic machine is configured to receive a first sequence of sub-tasks related to the first set of capabilities of the first robotic machine. The second robotic machine has a second set of capabilities for interacting with the surrounding environment. The second robotic machine is configured to receive a second sequence of sub-tasks related to the second set of capabilities of the second robotic machine. The first and second robotic machines are configured to perform the first and second sequences of sub-tasks, respectively, to accomplish a task that involves at least one of manipulating or inspecting a target object that is distinct from the first and second robotic machines. The first and second robotic machines are configured to coordinate performance of the first sequence of sub-tasks by the first robotic machine with performance of the second sequence of sub-tasks by the second robotic machine.

In another embodiment, at least some of the sub-tasks are sequential such that the second robotic machine begins performance of a corresponding sub-task in the second sequence responsive to receiving a notification from the first robotic machine that the first robotic machine has completed a specific sub-task in the first sequence. Another embodiment relates to a method for controlling a first robotic machine and a second robotic machine. The first robotic machine has a first set of capabilities for interacting with a surrounding environment. The first robotic machine is configured to receive a first sequence of sub-tasks related to the first set of capabilities of the first robotic machine. The second robotic machine has a second set of capabilities for interacting with the surrounding environment. The second robotic machine is configured to receive a second sequence of sub-tasks related to the second set of capabilities of the second robotic machine. The method includes performing the first and second sequences of sub-tasks to accomplish a task comprising at least one of manipulating or inspecting a target object, and coordinating performance of the first sequence of sub-tasks by the first robotic machine with performance of the second sequence of sub-tasks by the second robotic machine.

In one or more embodiments, a system may include a task manager having one or more processors that can determine capability requirements to perform a task on a target object. The task may have an associated series of sub-tasks, with the sub-tasks having one or more capability requirements. The task manager may select a first robotic machine of plural robotic machines and assign a first sequence of sub-tasks within the associated series of sub-tasks to the first robotic machine. The first robotic machine may have a first set of capabilities for interacting with the target object and may operate according to a first mode of operation. The task manager may also select a second robotic machine of the plural robotic machines and assign a second sequence of sub-tasks within the associated series of sub-tasks to the second robotic machine. The second robotic machine may have a second set of capabilities for interacting with the target object and may operate according to a second mode of operation. The task manager may select the first robotic machine based at least in part on the first set of capabilities and the first mode of operation of the first robotic machine, and select the second robotic machine based at least in part on the second set of capabilities and the second mode of operation of the second robotic machine.

In another embodiment, the task manager may assign the first and second sequence of sub-tasks to the first and second robotic machines, respectively, to complete the task on the target object. In another embodiment, the first mode of operation may be a fast, gross movement mode, and the second mode of operation may be a slow, fine movement mode.

In another embodiment, the first mode of operation may include moving the first robotic machine to a determined location relative to the target object, and the second mode of operation may include actuating one or more tools of the second robotic machine to accomplish the task. In another embodiment, the target object may be associated with one or more of a railroad track, a road, a building, a stack, or a stationary machine. In another embodiment, the first and second sets of capabilities of the first and second robotic machines, respectively, each include at least one of flying, driving, diving, lifting, imaging, grasping, rotating, tilting, extending, retracting, pushing, or pulling. In another embodiment, the first set of capabilities of the first robotic machine may include at least one capability that differs from the second set of capabilities. In another embodiment, the second set of capabilities of the second robotic machine may include at least one capability that differs from the first set of capabilities.

In another embodiment, the task manager may direct the first and second robotic machines to coordinate performance of the first sequence of sub-tasks by the first robotic machine with the performance of the second sequence of sub-tasks by the second robotic machine by communicating one or more directly together or through the task manager. In another embodiment, the task manager may access a database that stores capability descriptions corresponding to each of the plural robotic machines. The task manager may compare the capability descriptions corresponding to each of the plural robotic machines to select the first and second robotic machines.

In one or more embodiments, a method may include determining capabilities requirements to perform a task on a target object. The task may include an associated series of sub-tasks, with the sub-tasks having one or more capability requirements. A first robotic machine may be selective from plural robotic machines, and a first sequence of sub-tasks within the associated series of sub-tasks may be assigned to the first robotic machine. The first robotic machine may have a first set of capabilities for interacting with the target object and may operate according to a first mode of operation. The first robotic machine may be selected based at least in part on the first set of capabilities and the first mode of operation of the first robotic machine. A second robotic machine may be selective from plural robotic machines, and a second sequence of sub-tasks within the associated series of sub-tasks may be assigned to the second robotic machine. The second robotic machine may have a second set of capabilities for interacting with the target object and may operate according to a second mode of operation. The second robotic machine may be selected based at least in part on the second set of capabilities and the second mode of operation of the second robotic machine.

In another embodiment, the first and second sequence of sub-tasks may be assigned to the first and second robotic machines, respectively, to complete the task on the target object. In another embodiment, the first and second robotic machines may be directed to coordinate performance of the first sequence of sub-tasks by the first robotic machine with the performance of the second sequence of sub-tasks by the second robotic machine by communicating directly together. In another embodiment, a database that stores capability descriptions corresponding to each of the plural robotic machines may be accessed. The capability descriptions corresponding to each of the plural robotic machines may be compared with each other to select the first and second robotic machine.

In one or more embodiments, a task manager may include one or more processors that may determine capability requirements to perform a task on a target object. The task may have an associated series of sub-tasks, with the sub-tasks having one or more capability requirements. The system may also include plural robotic machines with corresponding capability descriptions. The task manager may assign a first sequence of sub-tasks within the associated series of sub-tasks to a first robotic machine of the plural robotic machines. The first robotic machine may have a first set of capabilities for interacting with the target object, and may operate according to a first mode of operation. The task manager may assign a second sequence of sub-tasks within the associated series of sub-tasks to a second robotic machine of the plural robotic machines. The second robotic machine may have a second set of capabilities for interacting with the target object, and may operate according to a second mode of operation. The task manager may select the first robotic machine based at least in part on the first set of capabilities and the first mode of operation of the first robotic machine, and select the second robotic machine based at least in part on the second set of capabilities and the second mode of operation of the second robotic machine.

In another embodiment, the task manager may access a database that stores the capability descriptions corresponding to each of the plural robotic machines. The task manager may compare the capability descriptions corresponding to each of the plural robotic machines to select the first and second robotic machines. In another embodiment, the first mode of operation may be a fast, gross movement mode, and the second mode of operation may be a slow, fine movement mode. In another embodiment, the first mode of operation may include moving the first robotic machine to a determined location relative to the target object, and the second mode of operation may include actuating one or more tools of the second robotic machine to accomplish the task. In another embodiment, the first set of capabilities of the first robotic machine may include at least one capability that differs from the second set of capabilities. In another embodiment, the second set of capabilities of the second robotic machine may include at least one capability that differs from the first set of capabilities.

Embodiments described herein may also relate to a system for vegetation control, maintenance of way along a route, vehicular transport therefore, and associated methods. In one embodiment, a vegetation control system is provided that includes a directed energy system onboard one or more vehicles of a vehicle system and one or more controllers that may operate the vehicle system and/or the directed energy system based at least in part on environmental information.

The one or more controllers may communicate with a position device that may provide location information. Location information may include position data on the vehicle system, as well as the vehicle system speed, data on the route over which the vehicle system will travel, and various areas relating to the route. Non-vehicle information may include whether the vehicle system is in a populated area, such as a city, or in the country. Non-vehicle information may indicate whether the vehicle system is on a bridge, in a draw, in a tunnel, or on a ridge. Non-vehicle information may indicate whether the route is following along the bank of a river or an agricultural area. Additional information may include which side of the vehicle system which of these features is on. The one or more controllers may actuate the directed energy system based at least in part on position data obtained by the controller from the position device. During use, the one or more controllers may prevent the directed energy system from emitting one or more directed energy beams while in a tunnel or near a structure or near people. As detailed herein, the one or more controllers may control such directed energy beam factors as the duration, power, angle, and emission pattern in response to vegetation being higher, lower, nearer, or farther away from the vehicle system.

Regarding environmental information, this is information that the one or more controllers may use that could affect the application of the one or more directed energy beams. Suitable sensors may collect and communicate the environmental information to the one or more controllers. Environmental information may include one or more of a traveling speed of the vehicle system, an operating condition of the directed energy system, a power level of the directed energy system, a type of vegetation, a quantity of vegetation, a terrain feature of a route section adjacent to the laser system, an ambient humidity level, an ambient temperature level, a direction of travel of the vehicle, curve or grade information of the vehicle route, a direction of travel of wind adjacent to the vehicle, a windspeed of air adjacent to the vehicle, a distance of the vehicle from a determined protected location, a distance of the vehicle from the vegetation.

During use, the controller responds to the environmental information or to operator input by switching operating modes of the vehicle and/or of the directed energy system. The controller may switch operating modes to selectively control one or more of activating only a portion of the directed energy system. For example, if sensors or maps indicate that there is equipment and/or people on one side of the vehicle at a location on the route and tall weeds in a ditch on the other side then the controller may control the directed energy system to activate the directed energy beam sources on the side with the weeds but not activate on the side with the equipment and/or people. Further, the controller may ensure that directed energy beam sources face downward to cover the weeds that are lower than the route because they are in a ditch. That is, the directed energy system may have one or more directed energy beam sources and these are organized into subsets, wherein the subsets may be on one or more of one side of the vehicle relative to the other, high emitting, low emitting, horizontal emitting, forward emitting, and rearward emitting. The directed energy beam sources may have adjustable focusing and projecting assemblies that may selectively emit wide directed energy beams and/or narrow directed energy beams. The directed energy system may have one or more adjustable directed energy beam sources that may be selectively pointed in determined directions. The controller may determine, based at least in part on environmental information, that a particular type of foliage is present, a preferred directed energy beam is effective (and selected by the controller), as well as whether the selected directed energy beam should be applied to the meristems, leaves/stalk, bark, and/or to the roots/soil; and the appropriate directed energy beam sources and focusing assemblies are activated by the controller to deliver the directed energy beams as determined.

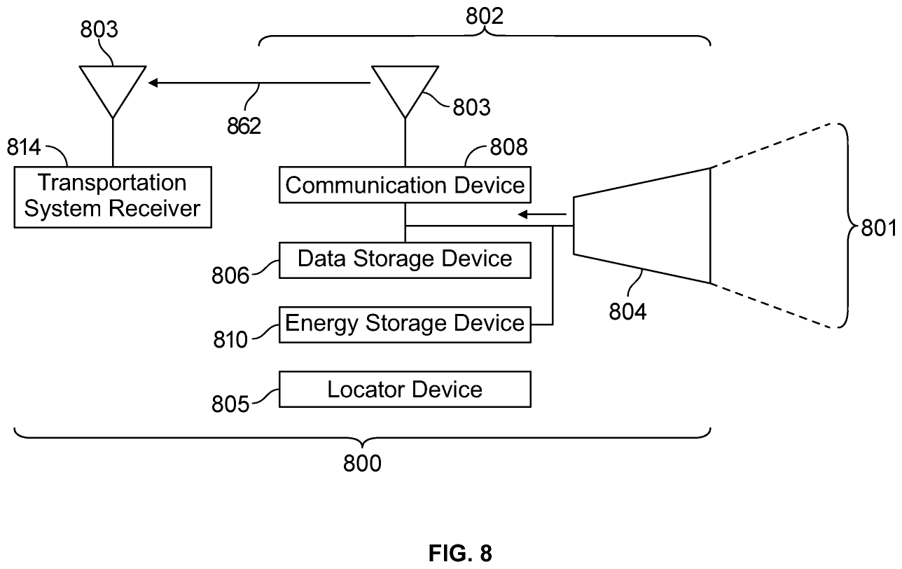

FIG. 8 illustrates a control system 800 for a vehicle (not shown in FIG. 8) that may capture and communicate data related to an environmental condition of a route over which the vehicle may travel and to determine actions to take relative to vegetation adjacent to that route, and the like according to one embodiment. In one or more embodiments, the control system may represent the controller 208 illustrated in FIG. 2 and associated with one or both of the first or second robotic machines. As one example, the control system may capture and communicate data related to one or more vehicles, vehicle component(s), wayside devices, routes along which the vehicle(s) and/or the robotic machines move, features of the routes along which the vehicles and/or robotic machines move, or the like.

The environmental information acquisition system includes a portable unit 802 having a camera 804, a data storage device 806 and/or a communication device 808, and a battery or other energy storage device 810. The portable unit may be portable in that the portable unit is small and/or light enough to be carried by a single adult human, however there are some embodiments in which a larger unit or one that is permanently affixed to the vehicle would be suitable. The portable unit may capture and/or generate image data 812 of a field of view 801. For example, the field of view may represent a solid angle or area over which the portable unit may be exposed to the environment and thereby to generate environmental information. The image data may include still images, videos (e.g., moving images or a series of images representative of a moving object), or the like, of one or more objects within the field of view of the portable unit. In any of the embodiments of any of the systems described herein, data other than image data may be captured and communicated. For example, the portable unit may have sensors for capturing image data outside of the visible light spectrum or a microphone for capturing audio data, a vibration sensor for capturing vibration data, elevation and location data, information relating to the grade/slope, information relating to the route (e.g., rail track, a rail tie, a tie plate, a rail tie fastener, ballast material, or the like), and the surrounding terrain, and so on. Terrain information may include whether there is a hill side, a ditch, or flat land adjacent to the route, whether there is a fence or a building, information about the state of the route itself (e.g., ballast and ties, painted lines, and the like), and information about the vegetation. The vegetation information may include the density of the foliage, the type of foliage, the thickness of the stalks, the distance from the route, the overhang of the route by the foliage, and the like.

A suitable portable unit may include an Internet protocol camera, such as a camera that may send video data via the Internet or another network. In one aspect, the camera may be a digital camera capable of obtaining relatively high-quality image data (e.g., static or still images and/or videos). For example, the camera may be an Internet protocol (IP) camera that generates packetized image data. A suitable camera may be a high definition (HD) camera capable of obtaining image data at relatively high resolutions.

The data storage device may be electrically connected to the portable unit and may store the image data. The data storage device may include one or more computer hard disk drives, removable drives, magnetic drives, read only memories, random access memories, flash drives or other solid state storage devices, or the like. The data storage device may be disposed remote from the portable unit, such as by being separated from the portable unit by at least several centimeters, meters, kilometers, as determined at least in part by the application at hand.

The communication device may be electrically connected to the portable unit and may communicate (e.g., transmit, broadcast, or the like) the image data to a transportation system receiver 814 located off-board the portable unit. The image data may be communicated to the receiver via one or more wired connections, over power lines, through other data storage devices, or the like. The communication device and/or receiver may represent hardware circuits or circuitry, such as transceiving circuitry and associated hardware (e.g., antennas) 803, that include and/or are connected with one or more processors (e.g., microprocessors, controllers, or the like).

In one embodiment, the portable unit includes the camera, the data storage device, and the energy storage device, but not the communication device. In such an embodiment, the portable unit may be used for storing captured image data for later retrieval and use. In another embodiment, the portable unit comprises the camera, the communication device, and the energy storage device, but not the data storage device. In such an embodiment, the portable unit may be used to communicate the image data to a vehicle or other location for immediate use (e.g., being displayed on a display screen), and/or for storage remote from the portable unit (this is, for storage not within the portable unit). In another embodiment, the portable unit comprises the camera, the communication device, the data storage device, and the energy storage device. In such an embodiment, the portable unit may have multiple modes of operation, such as a first mode of operation where image data is stored within the portable unit on the data storage device 806, and a second mode of operation where the image data is transmitted off the portable unit for remote storage and/or immediate use elsewhere.

A suitable camera may be a digital video camera, such as a camera having a lens, an electronic sensor for converting light that passes through the lens into electronic signals, and a controller for converting the electronic signals output by the electronic sensor into the image data, which may be formatted according to a standard such as MP4. The data storage device, if present, may be a hard disc drive, flash memory (electronic non-volatile non-transitory computer storage medium), or the like. The communication device, if present, may be a wireless local area network (LAN) transmitter (e.g., Wi-Fi transmitter), a radio frequency (RF) transmitter that transmits in and according to one or more commercial cell frequencies/protocols (e.g., 3G or 4G), and/or an RF transmitter that may wirelessly communicate at frequencies used for vehicle communications (e.g., at a frequency compatible with a wireless receiver of a distributed power system of a rail vehicle. Distributed power refers to coordinated traction control, such as throttle and braking, of a train or other rail vehicle consist having plural locomotives or other powered rail vehicle units). A suitable energy storage device may be a rechargeable lithium-ion battery, a rechargeable Ni-MH battery, an alkaline cell, or other device suitable for portable energy storage for use in an electronic device. Another suitable energy storage device, albeit more of an energy provider than storage, include a vibration harvester and a solar panel, where energy is generated and then provided to the camera system.

The portable unit may include a locator device 805 that generates data used to determine the location of the portable unit. The locator device may represent one or more hardware circuits or circuitry that include and/or are connected with one or more processors (e.g., controllers, microprocessors, or other electronic logic-based devices). In one example, the locator device is selected from a global positioning system (GPS) receiver that determines a location of the portable unit, a beacon or other communication device that broadcasts or transmits a signal that is received by another component (e.g., the transportation system receiver) to determine how far the portable unit is from the component that receives the signal (e.g., the receiver), a radio frequency identification (RFID) tag or reader that emits and/or receives electromagnetic radiation to determine how far the portable unit is from another RFID reader or tag (e.g., the receiver), or the like. The receiver may receive signals from the locator device to determine the location of the locator device 805 relative to the receiver and/or another location (e.g., relative to a vehicle or vehicle system). Additionally, or alternatively, the locator device may receive signals from the receiver (e.g., which may include a transceiver capable of transmitting and/or broadcasting signals) to determine the location of the locator device relative to the receiver and/or another location (e.g., relative to a vehicle or vehicle system).

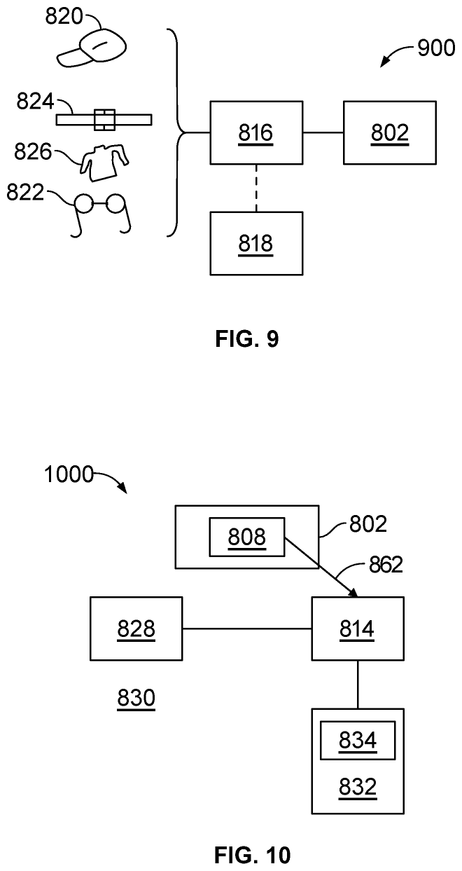

FIG. 9 illustrates an environmental information capture system 900 according to another embodiment. This system includes a garment 816 that may be worn or carried by an operator 818, such as a vehicle operator, transportation worker, or other person. A portable unit or locator device may be attached to the garment. For example, the garment may be a hat 820 (including a garment worn about the head), an ocular device 822 (e.g., a Google Glass™ device or other eyepiece), a belt or watch 824, part of a jacket 826 or other outer clothing, a clipboard, or the like. The portable unit may detachably connect to the garment, or, in other embodiments, the portable unit may be integrated into, or otherwise permanently connected to the garment. Attaching the portable unit to the garment may allow the portable unit to be worn by a human operator of a vehicle (or the human operator may be otherwise associated with a transportation system), for capturing image data associated with the human operator performing one or more functions with respect to the vehicle or transportation system more generally. The controller may determine if the operator is within a spray zone of one or more dispenser. If the operator is detected within the spray zone, the controller may block or prevent the dispenser from spraying the spray chemical through one or more of the nozzles.

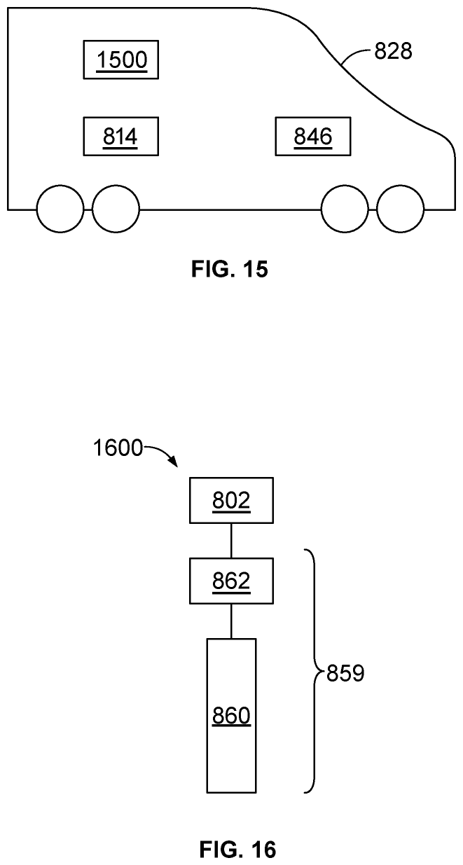

With reference to FIG. 10, in one embodiment, the portable unit may include the communication device, which may wirelessly communicate the image data to the transportation system receiver. The transportation system receiver may be located onboard a vehicle 828, at a wayside location 830 of a route of the vehicle, or otherwise remote from the vehicle. The illustrated vehicle (see also FIG. 15) is a high rail vehicle that may selectively travel on a rail track and on a roadway. Remote may refer to not being onboard the vehicle, and in embodiments, more specifically, to not within the immediate vicinity of the vehicle, such as not within a Wi-Fi and/or cellular range of the vehicle. In one aspect, the portable unit may be fixed to the garment being worn by an operator of the vehicle and provide image data representative of areas around the operator. For example, the image data may represent the areas being viewed by the operator. The image data may no longer be generated by the portable unit during time periods that the operator is within the vehicle or within a designated distance from the vehicle. Upon exiting the vehicle or moving farther than the designated distance (e.g., five meters) from the vehicle, the portable unit may begin automatically generating and/or storing the image data. As described herein, the image data may be communicated to a display onboard the vehicle or in another location so that another operator onboard the vehicle may determine the location of the operator with the portable unit based on the image data. With respect to rail vehicles, one such instance could be an operator exiting the cab of a locomotive. If the operator is going to switch out cars from a rail vehicle that includes the locomotive, the image data obtained by the portable unit on the garment worn by the operator may be recorded and displayed to an engineer onboard the locomotive. The engineer may view the image data as a double check to ensure that the locomotive is not moved if the conductor is between cars of the rail vehicle. Once it is clear from the image data that the conductor is not in the way, then the engineer may control the locomotive to move the rail vehicle.

The image data may be autonomously examined by one or more image data analysis systems or image analysis systems described herein. For example, one or more of the transportation system receiver 814, the vehicle, and/or the portable unit may include an image data analysis system (also referred to as an image analysis system) that examines the image data for one or more purposes described herein.

Continuing, FIG. 10 illustrates one embodiment of a camera system 1000 according to an embodiment of the invention. The system may include a display screen system 832 located remote from the portable unit and from the vehicle. The display screen system receives the image data from the transportation system receiver as a live feed and display the image data (e.g., converted back into moving images) on a display screen 834 of the display screen system. The live feed may include image data representative of objects contemporaneous with capturing the video data but for communication lags associated with communicating the image data from the portable unit to the display screen system. Such an embodiment may be used, for example, for communicating image data, captured by a human operator wearing or otherwise using the portable unit and associated with the human operator carrying out one or more tasks associated with a vehicle (e.g., vehicle inspection) or otherwise associated with a transportation network (e.g., rail track inspection), to a remote human operator viewing the display screen. A remote human operator, for example, may be an expert in the particular task or tasks, and may provide advice or instructions to the on-scene human operator based on the image data or may actuate and manipulate a dispenser system, maintenance equipment, and the vehicle itself.

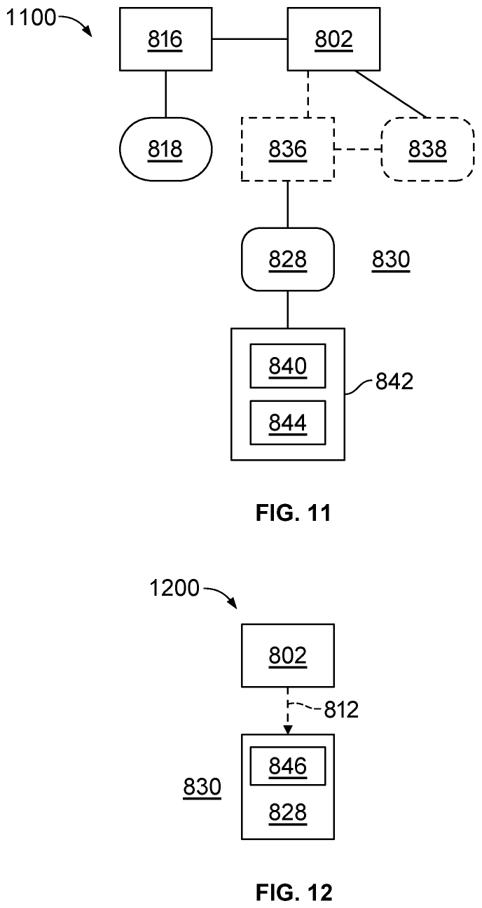

FIG. 11 illustrates one embodiment of a camera system 1100 having a garment and a portable unit attached and/or attachable to the garment. The system may be similar to the other camera systems described herein, with the system further including a position detection unit 836 and a control unit 838. The position detection unit detects a position of the transportation worker wearing the garment. The configurable position detection unit may be connected to and part of the garment, connected to and part of the portable unit, or connected to and part of the vehicle or a wayside device. The position detection unit may be, for example, a global positioning system (GPS) unit, or a switch or other sensor that detects when the human operator (wearing the garment) is at a particular location in a vehicle, outside but near the vehicle, or otherwise. In one embodiment, the position detection unit may detect the presence of a wireless signal when the portable unit is within a designated range of the vehicle or vehicle cab. The position detection unit may determine that the portable unit is no longer in the vehicle or vehicle cab responsive to the wireless signal no longer being detected or a strength of the signal dropping below a designated threshold. In one embodiment, the

The control unit (which may be part of the portable unit) controls the portable unit based at least in part on the position of the transportation worker that is detected by the position detection unit. The control unit may represent hardware circuits or circuitry that include and/or are connected with one or more processors (e.g., microprocessors, controllers, or the like).

In one embodiment, the control unit controls the portable unit to a first mode of operation when the position of the transportation worker that is detected by the position detection unit indicates the transportation worker is at an operator terminal 840 of the vehicle (e.g., in an operator cab 842 of the vehicle), and to control the portable unit to a different, second mode of operation when the position of the transportation worker that is detected by the position detection unit indicates the transportation worker is not at the operator terminal of the vehicle. In the first mode of operation, for example, the portable unit is disabled from at least one of capturing, storing, and/or communicating the image data, and in the second mode of operation, the portable unit is enabled to capture, store, and/or communicate the image data. In such an embodiment, therefore, it may be the case that the portable unit is disabled from capturing image data when the operator is located at the operator terminal, and enabled when the operator leaves the operator terminal. The control unit may cause the camera to record the image data when the operator leaves the operator cab or operator terminal so that actions of the operator may be tracked. For example, in the context of a rail vehicle, the movements of the operator may be examined using the image data to determine if the operator is in a safe area during operation of a set of dispensers or maintenance equipment.

In one embodiment, the control unit may control the portable unit to a first mode of operation when the position of the transportation worker that is detected by the position detection unit 836 indicates the transportation worker is in the operator cab 842 of the vehicle and to control the portable unit to a different, second mode of operation when the position of the transportation worker that is detected by the position detection unit indicates the transportation worker is not in the operator cab of the vehicle. For example, the portable unit may be enabled for capturing image data when the operator is outside the operator cab and disabled for capturing image data when the operator is inside the operator cab with no view of the environment. This may be a powered down mode to save on battery life.

In another embodiment, the system has a display screen 844 in the operator cab of the rail vehicle. The communication device of the portable unit may transmit the image data to the transportation system receiver which may be located onboard the vehicle and operably connected to the display screen, for the image data to be displayed on the display screen. Such an embodiment may be used for one operator of a vehicle to view the image data captured by another operator of the vehicle using the portable unit. For example, if the portable camera system is attached to a garment worn by the one operator when performing a task external to the vehicle, video data associated with the task may be transmitted back to the other operator remaining in the operator cab, for supervision or safety purposes.

FIG. 12 illustrates one embodiment of a camera system 1200. A control system 846 onboard the vehicle may perform one or more of controlling movement of the vehicle, movement of maintenance equipment, and operation of one or more dispensers (not shown). The control system may control operations of the vehicle, such as by communicating command signals to a propulsion system of the vehicle (e.g., motors, engines, brakes, or the like) for controlling output of the propulsion system. That is, the control system may control the movement (or not) of the vehicle, as well as its speed and/or direction.

The control system may prevent movement of the vehicle responsive to a first data content of the image data and allow movement of the vehicle responsive to a different, second data content of the image data. For example, the control system onboard the vehicle may engage brakes and/or prevent motors from moving the vehicle to prevent movement of the vehicle, movement of the maintenance equipment, or operation of the dispenser responsive to the first data content of the image data indicating that the portable unit (e.g., worn by an operator, or otherwise carried by an operator) is located outside the operator cab of the vehicle and to allow movement and operation responsive to the second data content of the image data indicating that the portable unit is located inside the operator cab.

The data content of the image data may indicate that the portable unit is outside of the operator cab based on a change in one or more parameters of the image data. One of these parameters may include brightness or intensity of light in the image data. For example, during daylight hours, an increase in brightness or light intensity in the image data may indicate that the operator and the portable unit has moved from inside the cab to outside the cab. A decrease in brightness or light intensity in the image data may indicate that the operator and the portable unit has moved from outside the cab to inside the cab. Another parameter of the image data may include the presence or absence of one or more objects in the image data. For example, the control system may use one or more image and/or video processing algorithms, such as edge detection, pixel metrics, comparisons to benchmark images, object detection, gradient determination, or the like, to identify the presence or absence of one or more objects in the image data. If the object is inside the cab or vehicle, then the inability of the control system to detect the object in the image data may indicate that the operator is no longer in the cab or vehicle. But, if the object is detected in the image data, then the control system may determine that the operator is in the cab or vehicle.

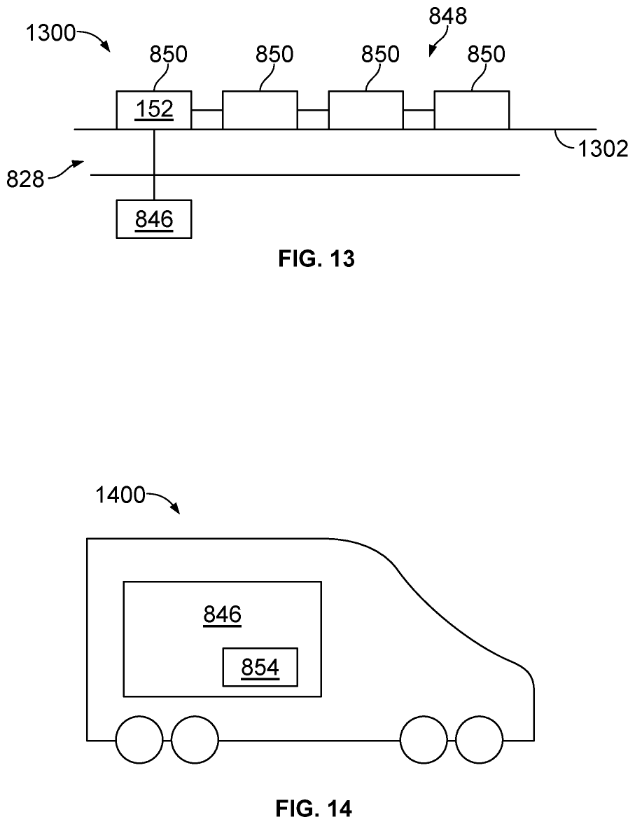

FIG. 13 illustrates one embodiment of a vehicle system 1300 that has a vehicle consist (i.e., a group or swarm) 848 that includes plural communicatively interconnected vehicle units 850, with at least one of the plural vehicle units being a lead vehicle unit 852. The vehicle system may be a host of autonomous or semi-autonomous drones. Other suitable vehicles may be an automobile, agricultural equipment, high-rail vehicle, locomotive, marine vessel, mining vehicle, other off-highway vehicle (e.g., a vehicle that is not designed for and/or legally permitted to travel on public roadways), and the like. The consist may represent plural vehicle units communicatively connected and controlled so as to travel together along a route 1302, such as a track, road, waterway, or the like. The controller may send command signals to the vehicle units to instruct the vehicle units how to move along the route to maintain speed, direction, separation distances between the vehicle units, and the like.

The control system may prevent movement of the vehicles in the consist responsive to the first data content of the environmental information indicating that the portable unit is positioned in an unsafe area (or not in a safe area) and to allow movement of the vehicles in the consist responsive to the second data content of the environmental information indicating that the portable unit is not positioned in and unsafe area (or in a known safe area). Such an embodiment may be used, for example, for preventing vehicles in a consist from moving when an operator, wearing or otherwise carrying the portable unit, is positioned in a potentially unsafe area relative to any of the vehicle units.

FIG. 14 illustrates the control system according to one embodiment. The control system 846 may be disposed onboard a high rail vehicle 1400 and may include an image data analysis system 854. The illustrated vehicle is a high rail vehicle that may selectively travel on a rail track and on a roadway. The analysis system may automatically process the image data for identifying the first data content and the second data content in the image data and thereby generate environmental information. The control system may automatically prevent and allow movement of the vehicle responsive to the first data and the second data, respectively, that is identified by the image data analysis system. The image data analysis system may include one or more image analysis processors that autonomously examine the image data obtained by the portable unit for one or more purposes, as described herein.

FIG. 15 illustrates the transportation system receiver located onboard the vehicle 1500 according to one embodiment. The transportation system receiver may wirelessly communicate network data onboard and/or off-board the vehicle, and/or to automatically switch to a mode for receiving the environmental information from the portable unit responsive to the portable unit being active to communicate the environmental information. For example, responsive to the portable unit being active to transmit the environmental information, the transportation system receiver may switch from a network wireless client mode of operation (transmitting data originating from a device onboard the vehicle, such as the control unit) to the mode for receiving the environmental information from the portable unit. The mode for receiving the environmental information from the portable unit may include a wireless access point mode of operation (receiving data from the portable unit).

In another embodiment, the portable unit may include the transportation system receiver located onboard the vehicle. The transportation system receiver may wirelessly communicate network data onboard and/or off-board the vehicle, and/or to automatically switch from a network wireless client mode of operation to a wireless access point mode of operation, for receiving the environmental information from the portable unit. This network data may include data other than environmental information. For example, the network data may include information about an upcoming trip of the vehicle (e.g., a schedule, grades of a route, curvature of a route, speed limits, areas under maintenance or repair, etc.), cargo being carried by the vehicle, or other information. Alternatively, the network data may include the image data. The receiver may switch modes of operation and receive the environmental information responsive to at least one designated condition of the portable unit. For example, the designated condition may be the potable portable unit being operative to transmit the environmental information, or the portable unit being in a designated location. As another example, the designated condition may be movement or the lack of movement of the portable unit. Responsive to the receiver and/or portable unit determining that the portable unit has not moved and/or has not moved into or out of the vehicle, the portable unit may stop generating the environmental information, the portable unit may stop communicating the environmental information to the receiver, and/or the receiver may stop receiving the environmental information from the portable unit. Responsive to the receiver and/or portable unit determining that the portable unit is moving and/or has moved into or out of the vehicle, the portable unit may begin generating the environmental information, the portable unit may begin communicating the environmental information to the receiver, and/or the receiver may begin receiving the environmental information from the portable unit.

In another embodiment of one or more of the systems described herein, the system is configured so that the image data/environmental information may be stored and/or used locally (e.g., in the vehicle), or to be transmitted to a remote location (e.g., off-vehicle location) based on where the vehicle is located. For example, if the vehicle is in a yard (e.g., a switching yard, maintenance facility, or the like), the environmental information may be transmitted to a location in the yard. But, prior to the vehicle entering the yard or a designated location in the yard, the environmental information may be stored onboard the vehicle and not communicated to any location off the vehicle.

Thus, in an embodiment, the system further comprises a control unit that, responsive to at least one of a location of the portable unit or a control input, controls at least one of the portable unit or the transportation system receiver to a first mode of operation for at least one of storing or displaying the video data on board the rail vehicle and to a second mode of operation for communicating the video data off board the rail vehicle for at least one of storage or display of the video data off board the rail vehicle. For example, the control unit may control at least one of the portable unit or the transportation system receiver from the first mode of operation to the second mode of operation responsive to the location of the portable unit being indicative of the rail vehicle being in a city or populated area.

During operation of the vehicle and/or portable unit outside of a designated area (e.g., a geofence extending around a vehicle yard or other location), the image data generated by the camera may be locally stored in the data storage device of the portable unit, shown on a display of the vehicle, or the like. Responsive to the vehicle and/or portable unit entering into the designated area, the portable unit may switch modes to begin wirelessly communicating the image data to the receiver, which may be located in the designated area. Changing where the image data is communicated based on the location of the vehicle and/or portable unit may allow for the image data to be accessible to those operators viewing the image data for safety, analysis, or the like. For example, during movement of the vehicle outside of the vehicle yard, the image data may be presented to an onboard operator, and/or the image data may be analyzed by an onboard analysis system of the vehicle to generate environmental information and ensure safe operation of the vehicle. Responsive to the vehicle and/or portable unit entering into the vehicle yard, the image data and/or environmental information may be communicated to a central office or management facility for remote monitoring of the vehicle and/or operations being performed near the vehicle.

As one example, event data transmission (e.g., the transmitting, broadcasting, or other communication of image data) may occur based on various vehicle conditions, geographic locations, and/or situations. The image data and/or environmental information may be either pulled (e.g., requested) or pushed (e.g., transmitted and/or broadcast) from the vehicle. For example, image data may be sent from a vehicle to an off-board location based on selected operating conditions (e.g., emergency brake application), a geographic location (e.g., in the vicinity of a crossing between two or more routes), selected and/or derived operating areas of concern (e.g., high wheel slip or vehicle speed exceeding area limits), and/or time driven messages (e.g., sent once a day). The off-board location may request and retrieve the image data from specific vehicles on demand.

FIG. 16 illustrates another embodiment of a camera system 1600. The system includes a portable support 859 having at least one leg 860 and a head 862 attached to the at least one leg. The head detachably couples to the portable unit, and the at least one leg autonomously supports (e.g., without human interaction) the portable unit at a wayside location off-board the vehicle. The support may be used to place the portable unit in a position to view at least one of the vehicle and/or the wayside location. The communication device may wirelessly communicate the image data to the transportation system receiver that is located onboard the vehicle. The image data may be communicated from off-board the vehicle to onboard the vehicle for at least one of storage and/or display of the image data onboard the vehicle. In one example, the portable support may be a camera tripod. The portable support may be used by an operator to set up the portable unit external to the vehicle, for transmitting the image data back to the vehicle for viewing in an operator cab of the vehicle or in another location. The image data may be communicated to onboard the vehicle to allow the operator and/or another passenger of the vehicle to examine the exterior of the vehicle, to examine the wayside device and/or location, to examine the route on which the vehicle is traveling, or the like. In one example, the image data may be communicated onboard the vehicle from an off-board location to permit the operator and/or passengers to view the image data for entertainment purposes, such as to view films, videos, or the like.

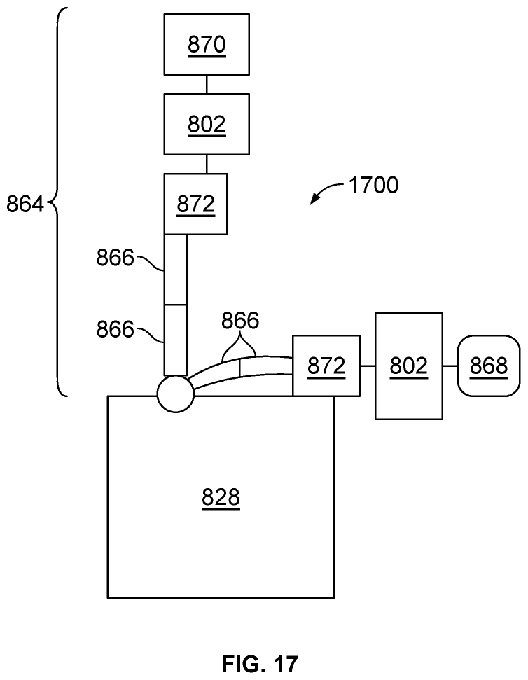

FIG. 17 illustrates an embodiment of a spray system 1700. The system includes a controllable mast 864 that may be attached to a platform of the vehicle. The controllable mast has one or more mast segments 866 that support a maintenance equipment implement 868 and a dispenser 870 relative to the vehicle. The controllable mast includes a coupler 872 attached to at least one of the mast segments. The coupler allows for controlled movement and deployment of the maintenance equipment and/or the dispenser. The portable unit 802 may be coupled to the controllable mast. The controllable mast may be retractable, for example by providing the mast segments as telescoping segments and/or by providing the coupler as extendable from and retractable into the controllable mast. For example, the coupler may have a telescoping structure or be otherwise extensible or retractable by using a piston and rod arrangement, such as a hydraulic piston. The controllable mast may use such a piston and rod arrangement.

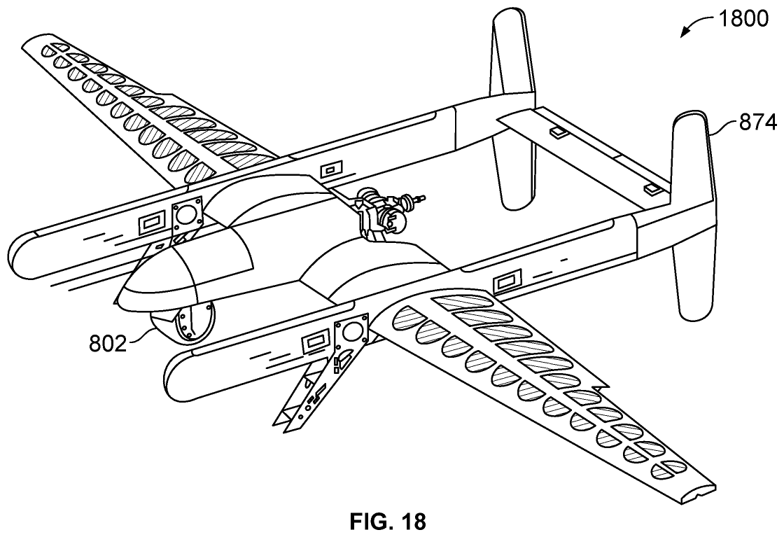

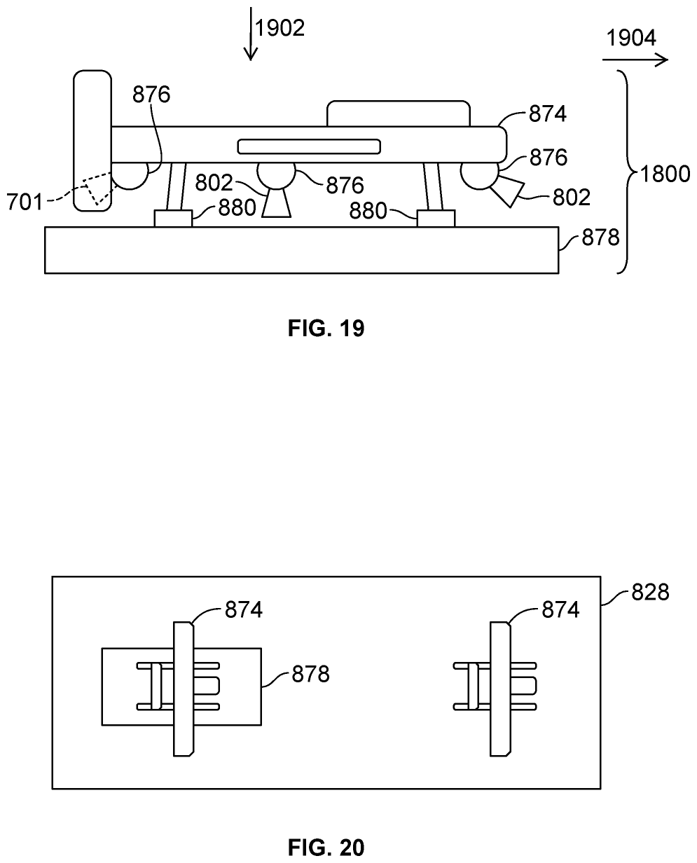

FIGS. 18-20 illustrate an embodiment of an environmental information acquisition system 1800. FIG. 18 illustrates a perspective view of the system, FIG. 19 illustrates a side view of the system, and FIG. 20 illustrates a top view of the system 1800. The system includes an aerial device 874 that may navigate via one of remote control or autonomous operation while flying over a route of the ground vehicle. The aerial device may have one or more docks 876 for receiving one or more portable units and may have a vehicle dock for coupling the aerial device to the vehicle. In the illustrated example, the aerial device includes three cameras, with one portable unit facing along a forward direction of travel 1900 of the aerial device, another portable unit facing along a downward direction 1902 toward the ground or route over which the aerial device flies, and another portable unit facing along a rearward direction 1904 of the aerial device. Alternatively, a different number of portable units may be used and/or the portable units may be oriented in other directions.

When the aerial device is in the air, the portable units may be positioned for the cameras to view the route, the vehicle, or other areas near the vehicle. The aerial device may be, for example, a scale dirigible, a scale helicopter, an aircraft, or the like. By “scale” it means that the aerial device may be smaller than needed for transporting humans, such as 1/10 scale or smaller of a human transporting vehicle. A suitable scale helicopter may include multi-copters and the like.

The system may include an aerial device vehicle dock 878 to attach the aerial device to the vehicle. The aerial device vehicle dock may receive the aerial device for at least one of detachable coupling of the aerial device to the vehicle, charging of a battery of the aerial device from a power source of the vehicle, or the like. For example, the dock may include one or more connectors 880 that mechanically or magnetically coupled with the aerial device to prevent the aerial device from moving relative to the dock, that conductively couple an onboard power source (e.g., battery) of the aerial device with a power source of the vehicle (e.g., generator, alternator, battery, pantograph, or the like) so that the power source of the aerial device may be charged by the power source of the vehicle during movement of the vehicle.

The aerial device may fly off of the vehicle to obtain image data that is communicated from one or more of the cameras onboard the aerial device to one or more transportation system receivers 814 onboard the vehicle and converted to environmental information. The aerial device may fly relative to the vehicle while the vehicle is stationary and/or while the vehicle is moving along a route. The environmental information may be displayed to an operator on a display device onboard the vehicle and/or may be autonomously examined as described herein by the controller that may operate the vehicle, the maintenance equipment, and/or the dispenser. When the aerial device is coupled into the vehicle dock, one or more cameras may be positioned to view the route during movement of the vehicle.

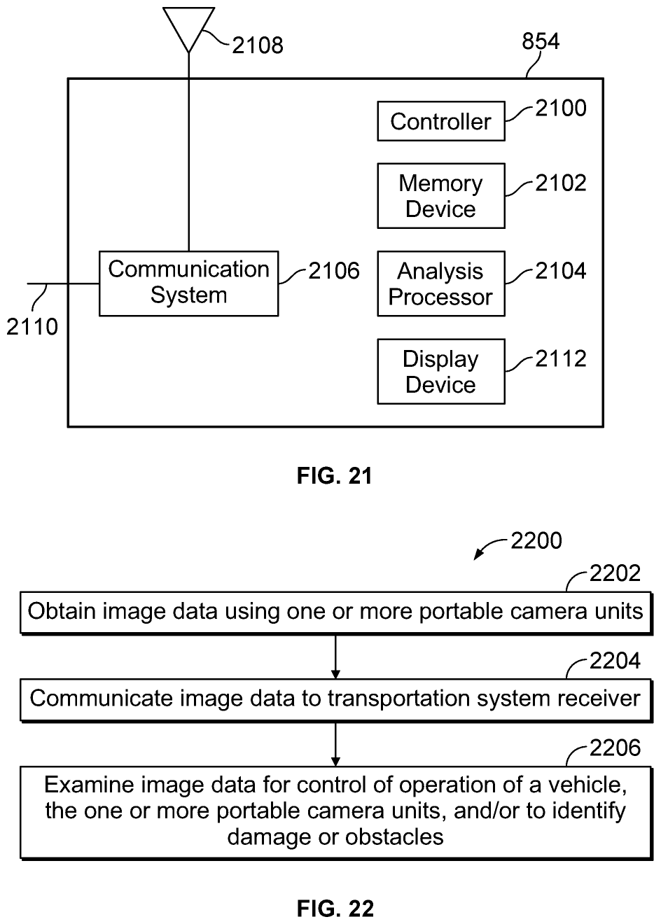

FIG. 21 is a schematic illustration of the image analysis system 854 according to one embodiment. As described herein, the image analysis system may be used to examine the data content of the image data to automatically identify objects in the image data, aspects of the environment (such as foliage), and the like. A controller 2100 of the system includes or represents hardware circuits or circuitry that includes and/or is connected with one or more computer processors, such as one or more computer microprocessors. The controller may save image data obtained by the portable unit to one or more memory devices 2102 of the imaging system, generate alarm signals responsive to identifying one or more problems with the route and/or the wayside devices based on the image data that is obtained, or the like. The memory device 2102 includes one or more computer readable media used to at least temporarily store the image data. A suitable memory device may include a computer hard drive, flash or solid state drive, optical disk, or the like.

Additionally, or alternatively, the image data and/or environmental information may be used to inspect the health of the route, status of wayside devices along the route being traveled on by the vehicle, or the like. The field of view of the portable unit may encompass at least some of the route and/or wayside devices disposed ahead of the vehicle along a direction of travel of the vehicle. During movement of the vehicle along the route, the portable unit may obtain image data representative of the route and/or the wayside devices for examination to determine if the route and/or wayside devices are functioning properly, or have been damaged, need repair or maintenance, need application of the spray composition, and/or need further examination or action.

The image data created by the portable unit may be referred to as machine vision, as the image data represents what is seen by the system in the field of view of the portable unit. One or more analysis processors 2104 of the system may examine the image data to identify conditions of the vehicle, the route, and/or wayside devices and generate the environmental information. The analysis processor may examine the terrain at, near, or surrounding the route and/or wayside devices to determine if the terrain has changed such that maintenance of the route, wayside devices, and/or terrain is needed. For example, the analysis processor may examine the image data to determine if vegetation (e.g., trees, vines, bushes, and the like) is growing over the route or a wayside device (such as a signal) such that travel over the route may be impeded and/or view of the wayside device may be obscured from an operator of the vehicle. As another example, the analysis processor may examine the image data to determine if the terrain has eroded away from, onto, or toward the route and/or wayside device such that the eroded terrain is interfering with travel over the route, is interfering with operations of the wayside device, or poses a risk of interfering with operation of the route and/or wayside device. Thus, the terrain “near” the route and/or wayside device may include the terrain that is within the field of view of the portable unit when the route and/or wayside device is within the field of view of the portable unit, the terrain that encroaches onto or is disposed beneath the route and/or wayside device, and/or the terrain that is within a designated distance from the route and/or wayside device (e.g., two meters, five meters, ten meters, or another distance). The analysis processor may represent hardware circuits and/or circuitry that include and/or are connected with one or more processors, such as one or more computer microprocessors, controllers, or the like.

Acquisition of image data from the portable unit may allow for the analysis processor 2104 to have access to sufficient information to examine individual video frames, individual still images, several video frames, or the like, and determine the condition of the wayside devices and/or terrain at or near the wayside device. The image data may allow for the analysis processor to have access to sufficient information to examine individual video frames, individual still images, several video frames, or the like, and determine the condition of the route. The condition of the route may represent the health of the route, such as a state of damage to one or more rails of a track, the presence of foreign objects on the route, overgrowth of vegetation onto the route, and the like. As used herein, the term “damage” may include physical damage to the route (e.g., a break in the route, pitting of the route, or the like), movement of the route from a prior or designated location, growth of vegetation toward and/or onto the route, deterioration in the supporting material (e.g., ballast material) beneath the route, or the like. For example, the analysis processor may examine the image data to determine if one or more rails are bent, twisted, broken, or otherwise damaged. The analysis processor may measure distances between the rails to determine if the spacing between the rails differs from a designated distance (e.g., a gauge or other measurement of the route). The analysis of the image data by the analysis processor may be performed using one or more image and/or video processing algorithms, such as edge detection, pixel metrics, comparisons to benchmark images, object detection, gradient determination, or the like.

A communication system 2106 of the system represents hardware circuits or circuitry that include and/or are connected with one or more processors (e.g., microprocessors, controllers, or the like) and communication devices (e.g., wireless antenna 2108 and/or wired connections 2110) that operate as transmitters and/or transceivers for communicating signals with one or more locations. For example, the communication system may wirelessly communicate signals via the antenna and/or communicate the signals over the wired connection (e.g., a cable, bus, or wire such as a multiple unit cable, train line, or the like) to a facility and/or another vehicle system, or the like.

The image analysis system may examine the image data obtained by the portable unit to identify features of interest and/or designated objects in the image data. By way of example, the features of interest may include gauge distances between two or more portions of the route. With respect to rail vehicles, the features of interest that are identified from the image data may include gauge distances between rails of the route. The designated objects may include wayside assets, such as safety equipment, signs, signals, switches, inspection equipment, or the like. The image data may be inspected automatically by the route examination systems to determine changes in the features of interest, designated objects that are missing, designated objects that are damaged or malfunctioning, and/or to determine locations of the designated objects. This automatic inspection may be performed without operator intervention. Alternatively, the automatic inspection may be performed with the aid and/or at the request of an operator.

The image analysis system may use analysis of the image data to detect damage to the route. For example, misalignment of track traveled by rail vehicles may be identified. Based on the detected misalignment, an operator of the vehicle may be alerted so that the operator may implement one or more responsive actions, such as by slowing down and/or stopping the vehicle. When the damaged section of the route is identified, one or more other responsive actions may be initiated. For example, a warning signal may be communicated (e.g., transmitted or broadcast) to one or more other vehicles to warn the other vehicles of the damage, a warning signal may be communicated to one or more wayside devices disposed at or near the route so that the wayside devices may communicate the warning signals to one or more other vehicles, a warning signal may be communicated to an off-board facility that may arrange for the repair and/or further examination of the damaged segment of the route, or the like.

In another embodiment, the image analysis system may examine the image data to identify text, signs, or the like, along the route. For example, information printed or displayed on signs, display devices, vehicles, or the like, indicating speed limits, locations, warnings, upcoming obstacles, identities of vehicles, or the like, may be autonomously read by the image analysis system. The image analysis system may identify information by the detection and reading of information on signs. In one aspect, the image analysis processor may detect information (e.g., text, images, or the like) based on intensities of pixels in the image data, based on wireframe model data generated based on the image data, or the like. The image analysis processor may identify the information and store the information in the memory device. The image analysis processor may examine the information, such as by using optical character recognition to identify the letters, numbers, symbols, or the like, that are included in the image data. This information may be used to autonomously and/or remotely control the vehicle, such as by communicating a warning signal to the control unit of a vehicle, which may slow the vehicle in response to reading a sign that indicates a speed limit that is slower than a current actual speed of the vehicle. As another example, this information may be used to identify the vehicle and/or cargo carried by the vehicle by reading the information printed or displayed on the vehicle.

In another example, the image analysis system may examine the image data to ensure that safety equipment on the route is functioning as intended or designed. For example, the image analysis processor, may analyze image data that shows crossing equipment. The image analysis processor may examine this data to determine if the crossing equipment is functioning to notify other vehicles at a crossing (e.g., an intersection between the route and another route, such as a road for automobiles) of the passage of the vehicle through the crossing.

In another example, the image analysis system may examine the image data to predict when repair or maintenance of one or more objects shown in the image data is needed. For example, a history of the image data may be inspected to determine if the object exhibits a pattern of degradation over time. Based on this pattern, a services team (e.g., a group of one or more personnel and/or equipment) may identify which portions of the object are trending toward a bad condition or already are in bad condition, and then may proactively perform repair and/or maintenance on those portions of the object. The image data from multiple different portable units acquired at different times of the same objects may be examined to determine changes in the condition of the object. The image data obtained at different times of the same object may be examined in order to filter out external factors or conditions, such as the impact of precipitation (e.g., rain, snow, ice, or the like) on the appearance of the object, from examination of the object. This may be performed by converting the image data into wireframe model data, for example.

FIG. 22 illustrates a flowchart of one embodiment of a method 2200 for obtaining and/or analyzing image data for transportation data communication. The method may be practiced by one or more embodiments of the systems described herein. The method includes a step 2202 of obtaining image data using one or more portable units. As described above, the portable units may be coupled to a garment worn by an operator onboard and/or off-board a vehicle, may be coupled to a wayside device that is separate and disposed off-board the vehicle but that may obtain image data of the vehicle and/or areas around the vehicle, may be coupled to the vehicle, may be coupled with an aerial device for flying around and/or ahead of the vehicle, or the like. In one aspect, the portable unit may be in an operational state or mode in which image data is not being generated by the portable unit during time periods that the portable unit is inside of (or outside of) a designated area, such as a vehicle. Responsive to the portable unit moving outside of (or into) the designated area, the portable unit may change to another operational state or mode to begin generating the image data.

The method may include a step 2204 of communicating the image data to the transportation system receiver. For example, the image data may be wirelessly communicated from the portable unit to the transportation system receiver. The image data may be communicated using one or more wired connections. The image data may be communicated as the image data is obtained, or may be communicated responsive to the vehicle and/or the portable unit entering into or leaving a designated area, such as a geofence.

The method may include a step 2206 examining the image data for one or more purposes, such as to control or limit control of the vehicle, to control operation of the portable unit, to identify damage to the vehicle, the route ahead of the vehicle, or the like, and/or to identify obstacles in the route such as encroaching foliage. For example, if the portable unit is worn on a garment of an operator that is off-board the vehicle, then the image data may be analyzed to determine whether the operator is between two or more vehicle units of the vehicle and/or is otherwise in a location where movement of the vehicle would be unsafe (e.g., the operator is behind and/or in front of the vehicle). With respect to vehicle consists, the image data may be examined to determine if the operator is between two or more vehicle units or is otherwise in a location that cannot easily be seen (and is at risk of being hurt or killed if the vehicle consist moves). The image data may be examined to determine if the off-board operator is in a blind spot of the on-board operator of the vehicle, such as behind the vehicle.

An image analysis system described above may examine the image data and, if it is determined that the off-board operator is between vehicle units, is behind the vehicle, and/or is otherwise in a location that is unsafe if the vehicle moves, then the image analysis system may generate a warning signal that is communicated to the control unit of the vehicle. This warning signal may be received by the control unit and, responsive to receipt of this control signal, the control unit may prevent movement of the vehicle. For example, the control unit may disregard movement of controls by an onboard operator to move the vehicle, the control unit may engage brakes and/or disengage a propulsion system of the vehicle (e.g., turn off or otherwise deactivate an engine, motor, or other propulsion-generating component of the vehicle). In one aspect, the image analysis system may examine the image data to determine if the route is damaged (e.g., the rails on which a vehicle is traveling are broken, bent, or otherwise damaged), if obstacles are on the route ahead of the vehicle (e.g., another vehicle or object on the route), or the like.

In one embodiment, the environmental information acquisition system data may be communicated via the controller to an offboard back-office system, where various operational and environmental information may be collected, stored and analyzed. In one back-office system, archival or historic information is collected from at least one vehicle having an environmental information acquisition system. The system may store information regarding one or more of the location of spraying, the type and/or concentration of spray composition, the quantity of spray compensation dispensed, the vehicle speed during the spray event, the environmental data (ditch, hill, curve, straightaway, etc.), the weather at the time of application (rain, cloud cover, humidity, temperature), the time of day and time of season during the spray event, and the like. Further, the system may store information regarding the type of vegetation and other related data as disclosed herein.

With the data collected by the controller, the back-office system may determine an effectiveness over time of a particular treatment regime. For example, the back-office system may note whether subsequent applications of spray composition are excessive (e.g., the weeds in a location are still brown and dead from the last treatment) or insufficient (e.g., the weeds in a location are overgrown relative to the last evaluation by an environmental information acquisition system on a vehicle according to an embodiment of the invention). Further, the back-office system may adjust or change the spray composition suggestions to try different concentrations, different chemical components, different spray application techniques to achieve a desired outcome of foliage control.

In one embodiment, a system (e.g., an environmental information acquisition system) includes a portable unit and a garment. The portable unit includes a camera that may capture at least image data, at least one of a data storage device electrically connected to the camera and may store the image data or a communication device electrically connected to the camera and may wirelessly communicate the image data to a transportation system receiver located off-board the portable unit. The garment may be worn by a transportation worker. The portable unit may be attached to the garment. In one aspect, the garment includes one or more of a hat/helmet, a badge, a smart phone, an electronic watch, or an ocular device. In one aspect, the system may include a locator device that may detect a location of the transportation worker wearing the garment, and a control unit that may control the portable unit based at least in part on the location of the transportation worker that is detected by the locator device. In one aspect, the control unit may control the portable unit to a first mode of operation responsive to the location of the transportation worker that is detected by the locator device indicating that the transportation worker is at an operator terminal of the vehicle and to control the portable unit to a different, second mode of operation responsive to the location of the transportation worker that is detected by the locator device indicating that the transportation worker is not at the operator terminal of the vehicle.

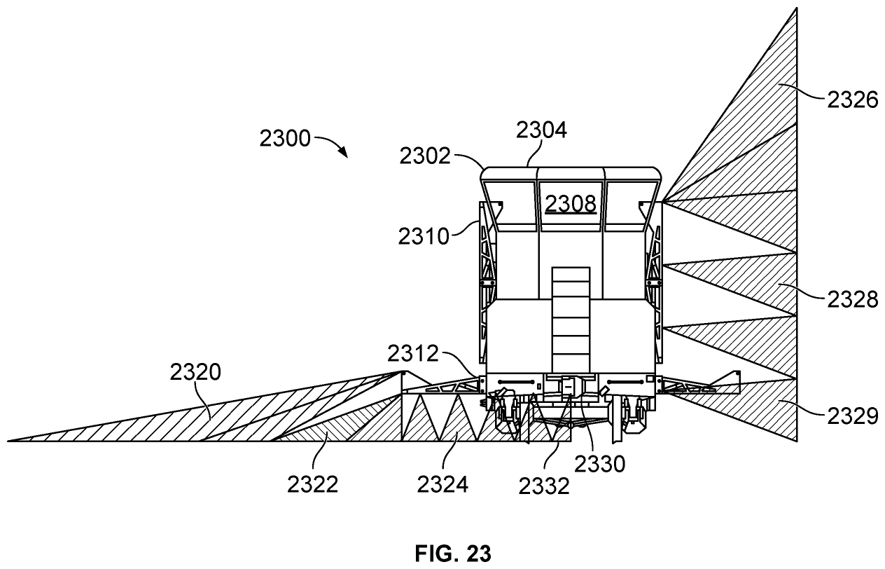

With reference to FIG. 23, a vehicle system 2300 having an embodiment of the invention is show. The vehicle system includes a control cab 2302. The control cab includes a roof 2304 over an operator observation deck (not shown) and a plurality of windows 2308. The windows may be oriented at an angle to allow an improved field of view of an operator on the observation deck in viewing areas of the terrain proximate to the control cab. An extendable boom 2310 is one of a plurality of booms (shown in an upright or tight configuration). An extendable boom 2312 is one of the plurality of booms (shown in an extended or open configuration). The booms may be provided in sets, with each set having plural booms and being located on a side of the vehicle system. The booms, and the sets, may be operated independently of each other, or in a manner that coordinates their action depending on the selected operating mode. Supported by the boom, a plurality of nozzles may provide spray patterns extending from the booms. The location and type of nozzle may produce, for example, and in an extended position, a distal spray pattern 2320, a medial spray pattern 2322, and a proximate spray pattern 2324. While in an upright configuration, the nozzles may produce a relatively high spray pattern 2326, an average height spray pattern 2328, and a low spray pattern 2329. A front rigging 2330 may produce spray patterns 2332 that cover the area in the front (or alternatively in the rear) of the control cab.

During use, as noted herein, the nozzles may be selectively activated. The activation may be accomplished automatically in some embodiments, and manually by an operator in other embodiments. The operator may be located in the observation deck in one embodiment, or may be remote from the vehicle in other embodiments. In addition to the nozzle activation being selective, the application of the spray composition may be controlled by extending or retracting the booms. The booms may be partially extended in some embodiments. The volume and pressure of the spray composition may be controlled through the nozzles. The concentration and type of active component in the spray composition may be controlled.

In one aspect, the vehicle control unit may include an image data analysis system that may automatically process the image data for identifying the first data content and the second data content. The vehicle control unit may automatically prevent and allow action by the vehicle responsive to the first data and the second data, respectively, that is identified by the image data analysis system. In one aspect, the system includes the transportation system receiver that may be located onboard the vehicle, where the transportation system receiver may communicate network data other than the image data at least one of onboard or off-board the vehicle and to automatically switch to a mode for receiving the image data from the portable unit responsive to the portable unit being active to communicate the image data. In one aspect, the system includes a retractable mast configured for attachment to a vehicle. The retractable mast may include one or more mast segments deployable from a first position relative to the vehicle to a second position relative to the vehicle. The second position is higher than the first position. The mast may include a coupler attached to one of the one or more mast segments for detachable coupling of the portable unit to said one of the one or more mast segments. The portable unit is coupled to the retractable mast by way of the coupler and the retractable mast is deployed to the second position, with the portable unit positioned above the vehicle.

In one embodiment, the vehicle is a marine vessel (not shown) and the portable system identifies marine equivalents to foliage. That is, a vessel may detect algal blooms, seaweed beds, oil slicks, and plastic debris, for example.

In one embodiment, a vehicle system with spray control is provided. The vehicle system includes a vehicle platform for a vehicle, a dispenser configured to dispense a composition onto at least a portion of an environmental feature adjacent to the vehicle, and a controller configured to operate one or more of the vehicle, the vehicle platform, or the dispenser based at least in part on environmental information.

The controller is configured to communicate with a position device and to actuate the dispenser based at least in part on position data obtained by the controller from the position device. The controller may include a spray condition data acquisition unit for acquiring spray condition data for spraying the composition comprising an herbicide from a storage tank to a spray range defined at least in part by the environmental feature adjacent to the vehicle. The dispenser may include a plurality of spray nozzles for spraying herbicides at different heights in a vertical direction.

The dispenser may include a variable angle spray nozzle capable of automatically adjusting a spraying angle of the composition. The environmental information may include one or more of a traveling speed of the vehicle or the vehicle platform, an operating condition of the dispenser, a contents level of dispenser tanks, a type of vegetation, a quantity of the vegetation, a terrain feature of a route section adjacent to the dispenser, an ambient humidity level, an ambient temperature level, a direction of travel of the vehicle, curve or grade information of a vehicle route, a direction of travel of wind adjacent to the vehicle, a windspeed of air adjacent to the vehicle, a distance of the vehicle from a determined protected location, and/or a distance of the vehicle from the vegetation.

The dispenser may include plural dispenser nozzles through which the composition is sprayed, and the controller may be configured to respond to the environmental information by switching operating modes with different ones of the operating modes selectively activating different nozzles of the dispenser nozzles. The dispenser may include plural dispenser nozzles organized into subsets. The subsets may be configured as one or more of: spraying one side of the vehicle, high spraying, low spraying, horizontal spraying, forward spraying, or rearward spraying. The dispenser may have adjustable nozzles that are configured to have selectively wide spray patterns and narrow streaming spray patterns.

The dispenser may have adjustable nozzles that are configured to be selectively pointed in determined directions. The controller may control a concentration of active chemicals within the composition being sprayed through the dispenser. The composition may be a mixture of multiple active chemicals, and the controller may be configured to control a mixture ratio of the multiple active chemicals. The controller may be configured to determine one or more of the mixture ratio or a concentration of the active chemicals in the composition in response to detection of one or more of a type of vegetation, a type of weed, a size of the weed, or a terrain feature.

The controller may selectively determine a concentration, a mixture, or both the concentration and the mixture of the composition based at least in part on a vehicle location relative to a sensitive zone. The dispenser may be configured to selectively add a foaming agent to the composition. The controller may be configured to control a pressure at which the dispenser dispenses the composition. The controller may be configured to select one or more nozzles of the dispenser or adjust an aim of the one or more nozzles.

The vehicle may be a high rail vehicle that can selectively travel on a rail track and on a roadway. The vehicle may have maintenance equipment be mounted to the vehicle platform and configured to maintain a section of a route adjacent to the vehicle. The maintenance equipment implement may include one or more of an auger, a mower, a chainsaw or circular saw, an excavator scoop, a winch, and/or a hoist. The controller may communicate with sensors that determine a nature of vegetation adjacent to the route. The controller may communicate with sensors that determine whether a person is within a spray zone of the spray composition and to block the dispenser from spraying responsive to detecting a person within the spray zone. The controller may communicate with sensors that determine whether a person is within an area where operation of maintenance equipment mounted to the platform would injury the person.

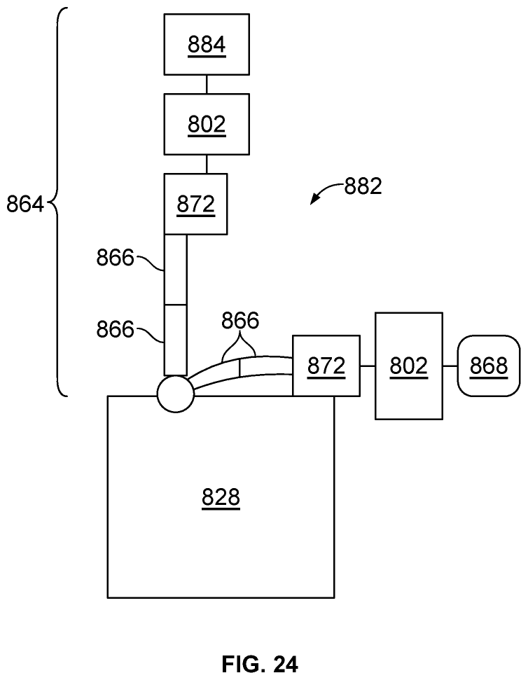

Referring to FIG. 24, a maintenance of way system 882 may include one or more controllable masts that may be attached to a vehicle. The retractable mast(s) may have one or more mast segments that support a maintenance equipment implement and a directed energy system 884 relative to the vehicle. The controllable mast(s) may include a coupler attached to at least one of the mast segments. The coupler allows for controlled movement and deployment of the maintenance equipment and/or the directed energy system. A portable unit may be coupled to the controllable mast.

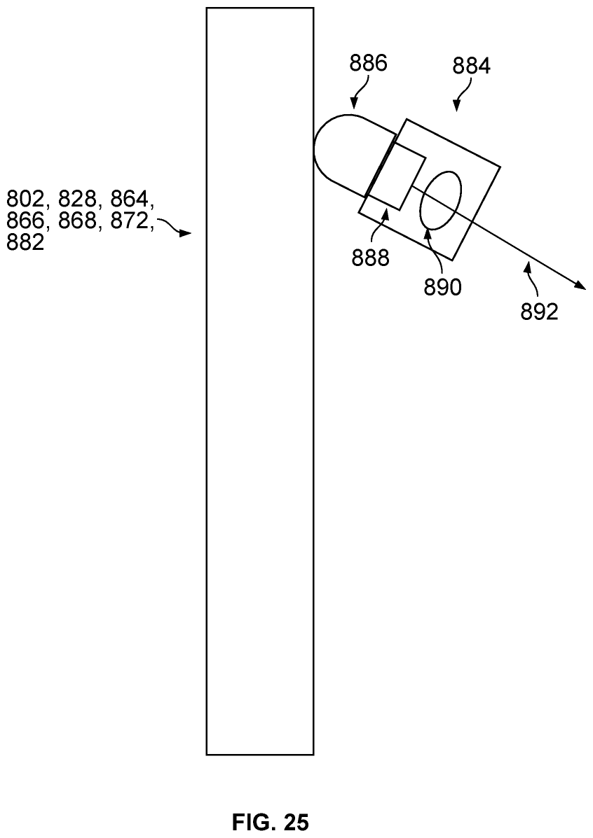

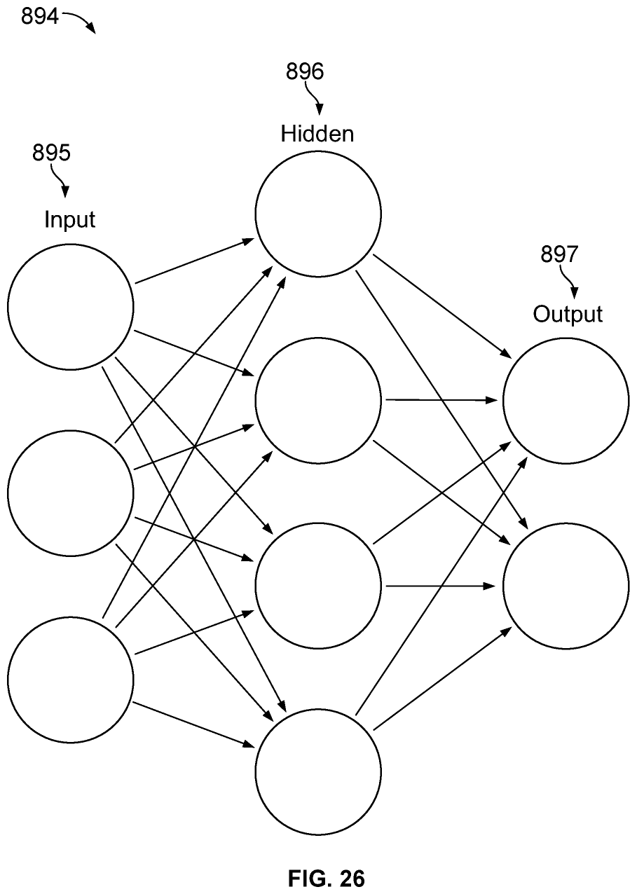

Referring to FIG. 25, the maintenance of way system may include the directed energy system 884 that is coupled to the vehicle system, for example the controllable mast, by a coupling 886. According to one embodiment, the coupling may be a pivot joint that can allow the directed energy system to pivot and/or rotate so as to allow the directed energy system to direct a directed energy beam 892 to any location within the field of view of the portable unit that is adjacent to the vehicle. The directed energy system may be coupled to a mast segment or to a coupler of the controllable mast. The directed energy system may be coupled to a portable unit on the controllable mast. The directed energy system may include a directed energy source 888 that can generate directed energy. The directed energy system may include a focusing assembly 890 that can focus the directed energy generated by the directed energy source and project the directed energy beam.

According to one embodiment, the directed energy source may be a laser system. The laser system may be, for example, a CO2 laser. The laser beam of the laser system may be continuous beam or a pulsed beam. The laser system may have a power of from 50 to 2000 W. For example, the laser system may have a power of 50 to 100 W, or from 200 to 500 W, or from 1,000 to 2,000 W.

According to one embodiment, the directed energy source may be a microwave energy source and the directed energy system may be a microwave amplification by stimulated emission of radiation (maser) system. According to one embodiment, the directed energy source may be a sonic energy source. According to one embodiment, the directed energy source may be a particle energy source, for example an electron or positron or ion source. According to one embodiment, the directed energy source may be a plasma source. The focusing and projecting assembly may focus the directed energy and project the directed energy beam at a determined power level for a determined time.

Referring to FIG. 26, a machine learning model 894 according to one embodiment may be provided in the form of a neural network. A neural network may be a series of algorithms that endeavors to recognize underlying relationships in a set of data. A “neuron” in a neural network is a mathematical function that collects and classifies information according to a specific architecture. The machine learning model may include an input layer 895, a hidden layer 896, and an output layer 897. The hidden layer is located between the input layer and the output layer of the algorithm of the machine learning model. The algorithm applies weights to the inputs (e.g., pressures and flows) and directs them through an activation function as the output. The hidden layer performs nonlinear transformations of the inputs entered into the network. According to one embodiment, the machine learning model may have two more hidden layers and be a deep learning model. The hidden layers may vary depending on the function of the machine learning model, and the hidden layers may vary depending on their associated weights. The hidden layers allow for the function of the machine learning model to be broken down into specific transformations of the input data. Each hidden layer function may be provided to produce a defined output. For example, one hidden layer may be used to identify objects within the field of view that are not vegetation. Another hidden layer may determine if image data within the field of view corresponds to vegetation. Other hidden layers may determine if image data corresponds to wayside equipment or people within the field of view.

The input layer may accept image data from one or more of the portable units. The image data may be obtained during operation of the vehicle system. According to one embodiment, the machine learning model may be an unsupervised machine learning model. According to one embodiment, the machine learning model may be a semi-supervised machine learning model. According to one embodiment, the machine learning model is a supervised machine learning model. The machine learning model may be provided with training data that is labelled. Data that represents vegetation that may be reduced or removed to maintain the way for the vehicle system may be labelled and provided to the machine learning model. The training data may also include vegetation that may be along the way of the vehicle system that is not to removed or reduced. The training data may also include image data of equipment that may be wayside of the vehicle system. The machine learning model may be trained not to direct any directed energy beams on the wayside equipment. The training data may also include image data of humans that may be in wayside locations of the vehicle system and the machine learning model may be trained not to direct energy beams toward humans. According to one embodiment, the vehicle system is a rail vehicle system and the training data may include image data of rust on rails. The directed energy system may use directed energy to remove rust on the rails identified by the machine learning model.

According to one embodiment, the machine learning model may be stored in a memory or data storage device and executed by the vehicle control system. According to one embodiment, the machine learning model may be executed by the image data analysis system of the vehicle control system.

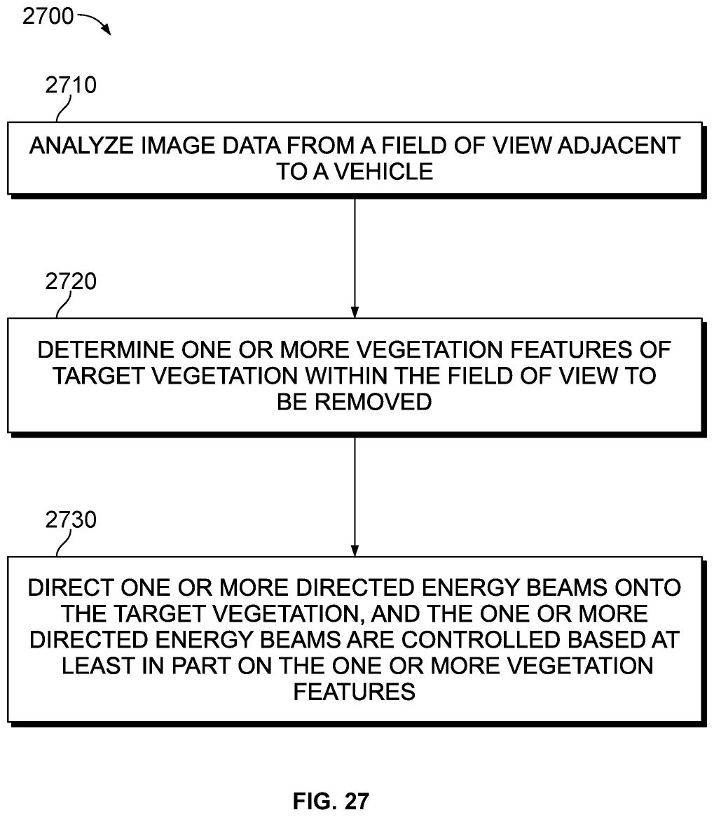

Referring to FIG. 27, a method 2700 may include a step 2710 of analyzing image data from a field of view adjacent to a vehicle and determining one or more vegetation features of target vegetation within the field of view to be removed. The method may include a step 2720 of determining one or more vegetation features of target vegetation within the field of view to be removed and a step 2730 of directing one or more directed energy beams onto the target vegetation. The one or more directed energy beams may be controlled based at least in part on the one or more vegetation features.

A system may include an imaging device to obtain image data from a field of view outside of a vehicle and a controller that can analyze the image data and identify one or more vegetation features of a target vegetation within the field of view. The vegetation features may be one or more of a type of vegetation, a quantity of vegetation, a distance of or a size of vegetation. The system may include a directed energy system that can direct one or more directed energy beams toward the target vegetation responsive to the controller identifying the one or more vegetation features.

The directed energy system may be a laser system that emits laser energy. The controller may control one or more of a power or a duration of the one or more directed energy beams to burn or irradiate a portion of the target vegetation. The portion of the target vegetation may be a patch of skin or bark or leaves of the target vegetation. The target vegetation may be one or more weeds. The controller may control the directed energy system to direct the one or more directed energy beams onto one or more meristems of the one or more weeds. The target vegetation may be one or more trees. The controller may control the directed energy system to direct the one or more directed energy beams onto bark of the one or more trees.

The controller may determine an amount of the target vegetation that are removed based at least in part on a distance of the directed energy system from the target vegetation. The vehicle may be a rail vehicle. The target may include rust on one or more of a rail that the rail vehicle travels on or wayside equipment. The controller may determine an amount of the target vegetation that is removed based at least in part on an amount of power of the directed energy beams directed onto the target vegetation. The controller may operate a machine learning model to analyze the image data and identify the one or more vegetation features within the field of view using the machine learning model. The controller may determine, based at least in part on the vegetation features, if the target vegetation should be irradiated by the directed energy system or not, and if so for how long and at what power level.

A method may include analyzing image data from a field of view adjacent to a vehicle and determining one or more vegetation features of target vegetation within the field of view to be removed. The method may include directing one or more directed energy beams onto the target vegetation. The one or more directed energy beams may be controlled based at least in part on the one or more vegetation features.

The method may include controlling the one or more directed energy beams to be in a power range that is defined at least in part by the one or more vegetation features, a calculated or measured distance between a source of the directed energy beams and the target vegetation, or both. The one or more vegetation features may include one or more of a type of vegetation, a quantity of vegetation, or a size of vegetation about the target vegetation. The method may include controlling one or more of a power or a duration of the one or more directed energy beams based at least in part on the vegetation features. The type of vegetation may include one or more weeds. The method may include controlling the directed energy system to direct the one or more directed energy beams onto one or more meristems of the one or more weeds. The type of vegetation may include one or more trees. The method may include controlling the directed energy system to direct the one or more directed energy beams onto bark of the one or more trees. The amount of bark to be removed, burned or irradiated by the directed energy beams may be determined based at least in part on the vegetation features. Some trees may be too thick or large to be cut down by the directed energy beams. Removing bark around the perimeter of the trees (e.g., girdling the trees) can kill and destroy the trees, thereby eventually removing the trees.

The method may include controlling an amount of the target vegetation to be affected based at least in part on an amount of power of the directed energy beams directed onto the target vegetation. The method may include operating a machine learning model to analyze the image data and determine the one or more vegetation features within the field of view.

A system may include one or more imaging devices onboard one or more vehicles that obtain image data from one or more fields of view adjacent to the one or more vehicles and one or more controllers in communication with the one or more imaging devices. The one or more controllers may analyze the image data and determine one or more vegetation features of target vegetation within the one or more fields of view. The system may include one or more directed energy systems onboard the one or more vehicles that generate and direct one or more energy beams onto the target generation in response to the controller analysis of the vegetation features.

The one or more controllers may include one or more directed energy data acquisition units that can acquire directed energy data for directing the one or more directed energy beams. The one or more vegetation features may include one or more of a type of vegetation, a quantity of vegetation, or a size of vegetation to be removed. The one or more controllers may operate one or more machine learning models to analyze the image data and determine the one or more vegetation features.

Embodiments of the subject matter described herein may relate to a fastener system and method. In one embodiment, the fastener system may be a rail tie application device. The rail tie application device may be used to fasten couplers, such as rail spikes, into rail ties. The rail spikes may secure objects, such as rails or other equipment, to the rail ties. To facilitate the aligning of the rail spike during its fastening, a sensor may be used. In one embodiment, an imaging sensor or image system allows for an operator (human or machine) to determine the spike alignment with the desired coupling site, to monitor the fastening event, and/or to ensure that the rail spike was properly removed and/or seated.

Suitable imaging sensors may include an infrared camera, a stereoscopic 2D or 3D camera, a digital video camera, and the like. For example, the imaging sensor may be or may include an infrared (IR) emitter that generates and/or emits a pattern of IR light into the environment, and a depth camera that analyzes the pattern of IR light to interpret perceived distortions in the pattern. The imaging sensor may include one or more color cameras that operate in the visual wavelengths. In one embodiment, the imaging sensor may acquire perception information at an acquisition rate of at least 15 Hz, such as approximately 30 Hz. A suitable imaging sensor may be a K1NECT sensor available from Microsoft.

Other suitable imaging sensors may include video camera units for capturing and/or communicating video data. Suitable images may be in the form of still shots, analog video signals, or digital video signals. The signals, particularly the digital video signals, may be subject to compression/decompression algorithms, such as MPEG or HEVC. A suitable camera may capture and record in a determined band of wavelengths of light or energy. For example, in one embodiment, the camera may sense wavelengths in the visible spectrum and, in another, the camera may sense wavelengths in the infrared spectrum. Multiple sensors may be combined in a single camera and may be used selectively based on the application. Further, stereoscopic and 3D cameras are contemplated for at least some embodiments described herein. These cameras may assist in determining distance, velocity, and/or surface profiles. These may be supplemented with range finders. Suitable range finders may use lasers or lidar to determine shapes, distances, and/or relations of objects in its field of view. Sequences of images or data may indicate movement, speed, and/or direct of components; or may indicate initial and subsequent states (such as a crush washer being crushed after use).

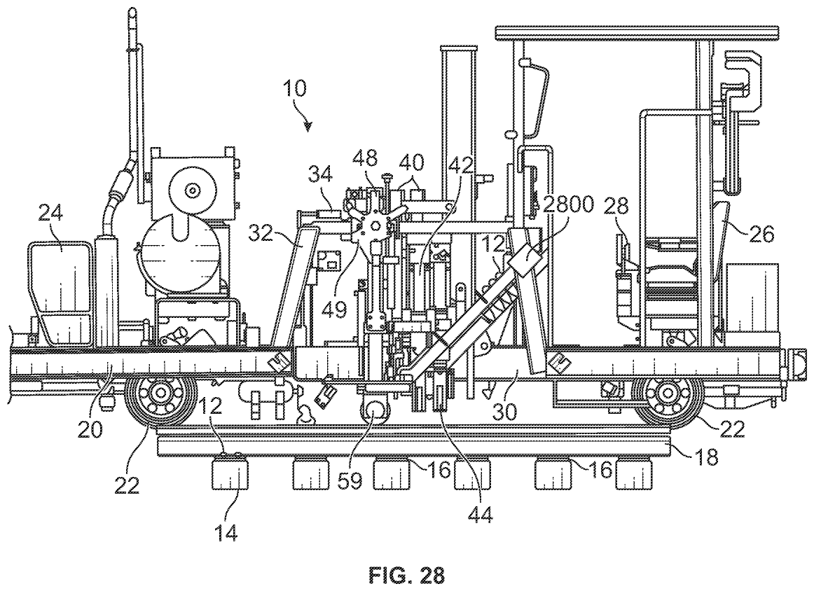

FIG. 28 illustrates a fastener driving machine 10, according to one embodiment. During use, the fastener driving machine may drive fasteners into a route. As one example, the fasteners may be rail fasteners that may be driven into railroad ties 14 to secure rail tie plates and a pair of rails 18 to the ties. The fasteners, the ties, the tie plates and the rails may be collectively referred to as the railroad track. In an embodiment, the fasteners may secure wayside structures at locations alongside a route (e.g., a paved road, a track, a gravel route, or the like) along which the fastener driving machine can move.

The fastener driving machine may be mounted on a frame 20 that may be supported on plural wheels 22 such that the frame is movable along the track. Alternatively, the frame may be supported by tracks or other suitable conveyance. In one embodiment, the frame may be self-propelled and powered by a power source.

A suitable power source may be an engine 24. Other suitable power sources may include batteries, overhead catenaries, third rails, fuel cells, and the like. In another embodiment, the frame may be towable by another powered vehicle. Where the controller is a person, an operator's seat 26 may be disposed on the frame in operational relationship to an operator control system having a joystick 28 or equivalent operator input system. The operator control system may have at least one trigger, switch, button, or other input mechanism. In another embodiment, the control system may be operator-free and may include a controller having one or more microprocessors. For example, the controller may automatically and/or semi-automatically control one or more operations of the fastener driving machine, the power source, a propulsion system, or the like.

A work area or operational zone 30 may be defined by a surface of the frame as a recess. One such recess may be formed on each side of the frame corresponding to one of the two rails of the track. Additional structural support may be provided by an elevated superstructure 32, which may be a mounting point for a spotting carriage 34. The spotting carriage may include a series of shafts and/or fluid power cylinders used to selectively position operational units vertically, parallel, and transverse to the rails over portions of the track needing maintenance.

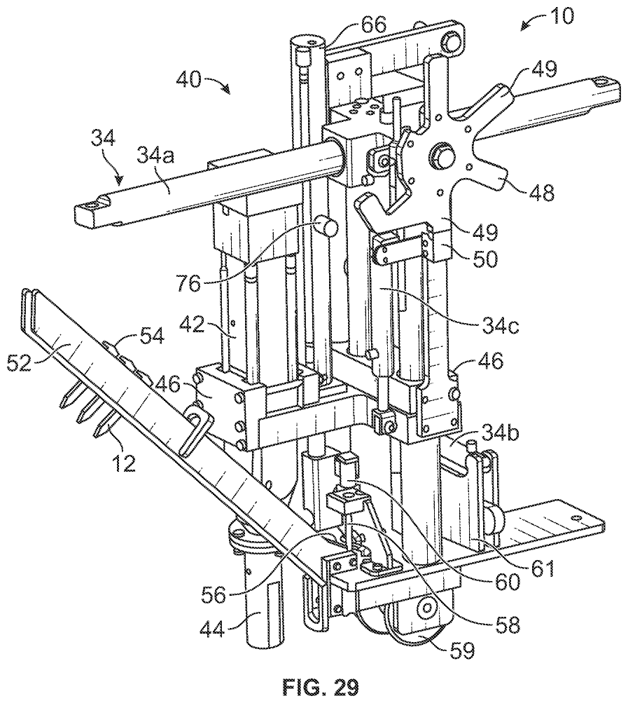

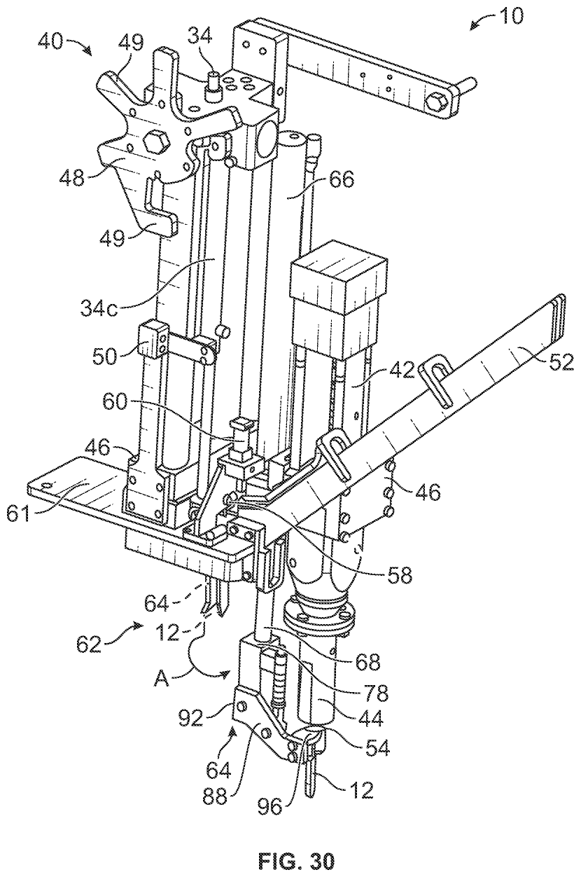

FIG. 29 illustrates a partial front perspective view of the fastener driving machine 10 and FIG. 30 illustrates a partial rear perspective view of the fastener driving machine, according to one embodiment. In one arrangement, a shaft 34a having an associated cylinder (not shown) controls movement of the fastener driving machine in a first direction that is substantially parallel to the route (forward and back), cylinder 34b controls movement of the fastener driving machine in a second direction that is substantially transverse to the route (left to right), and cylinder 34c controls vertical movement of the fastener driving machine in a third direction that is relative to the route. For example, extension and retraction of the cylinder 34b causes pivoting action about the shaft 34a. The frame may have a tie nipper (not shown) for pulling the tie tight to the rail for application of the fastener.

Each work area may have an assigned fastener driving unit 40. A suitable fastener driving unit may be a spiker gun. Components of a fastener driving unit may include a fluidic power or hydraulic cylinder 42 with a reciprocating element. A suitable reciprocating element may be a piston shaft or ram 44. Other suitable reciprocating elements may be powered via compressed air, by an electric motor, a solenoid, or the like. Responsive to the fastener driving unit being activated by the controller and/or the operator, the reciprocating element may engage the head of a fastener (not shown) and drive the fastener into and/or out of a selected tie. In one or more embodiments, the hydraulic cylinder may be a “push” type of cylinder, where the fluid pressure may be gradually and progressively applied to the fastener. In another embodiment, the hydraulic cylinder may be a “percussive” type of cylinder, where fluid pressure may be applied in a pulsing fashion.

A suitable cylinder may be the percussive type and may be similar to conventional hydraulic impact hammers, such as impact hammers used for breaking up concrete or asphalt pavement. In one or more embodiments, the impact hammer may be designed to deliver about 200 ft. lbs. of impact energy at a rate of about 450-1200 blows per minute. The hydraulic cylinder may be mounted in a hammer bracket 46. The hammer bracket may, in turn, be connected to the spotting carriage 34. This may allow the hydraulic cylinder to move to a determined location under operator control and/or control by the controller. The hydraulic cylinder may be reciprocally moved vertically relative to the spotting carriage, which may be movable in at least two generally horizontal directions, parallel and transverse, relative to the rails.

The fastener driving unit may have one or more fastener magazines 52. The fastener magazine may accommodate a plurality of rail fasteners 12 and feed them sequentially for driving by the ram. An example fastener magazine may accommodate the fasteners in an arrangement such that offset and elongated fastener heads 54 may be oriented in the direction of the rails (illustrated in FIG. 29). For example, the fasteners may be fed in from the fastener magazine to the fastener driving unit in a single file alignment with the fastener heads being oriented in line with each other and in a position to be driven into the holes of the tie plate.

In one or more embodiments, the fastener magazine may be an inclined, elongated chute made of a pair of parallel bars that guide the fasteners toward a delivery point 56. The fasteners may be fed into the fastener magazine from a bin (not shown) that holes plural fasteners. The bin may include a channel or passage disposed along a bottom side of the bin for the elongated portion of the fasteners to fall into. For example, the channel or passage may be sized to allow passage of the elongated portion of the fastener to extend through the passage, but to interfere with a flange of the fastener head. Plural fasteners may be similarly aligned with each other within the channel, with the flange of each corresponding fastener head controlling the alignment of each fastener in the same or common direction. A blade or other structure may move along the length of the channel to convey the similarly oriented fasteners out of the channel of the bin and into the fastener magazine such that each of the fasteners in the magazine are similarly aligned in a single file alignment. Optionally, the fastener magazine may have an alternative arrangement and/or different configuration.

In an example embodiment, the fastener magazine may be inclined so that the fasteners move toward a delivery point by gravity. At a delivery point, an escapement pin 58, powered by a fluid power cylinder 60, may selectively permit the delivery of one fastener at a time under operator and/or automatic control. The magazine, the escapement pin, and the fluid power cylinder may all be supported on the fastener driving unit by a lower bracket 61. A guide wheel 59 may be pivotably secured to the unit and engage the corresponding rail or route to properly align the unit during operation.

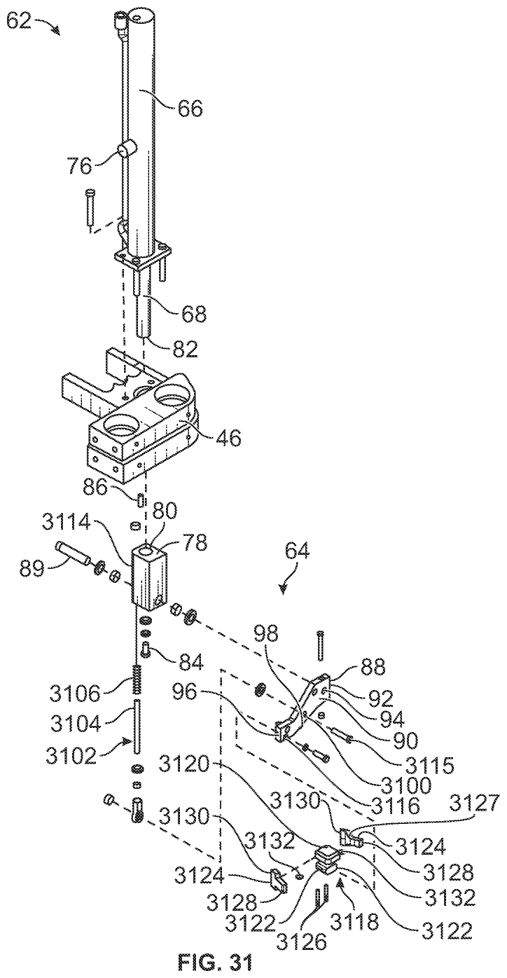

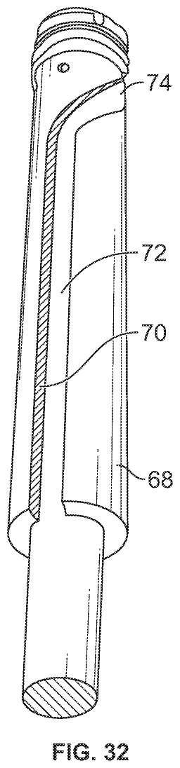

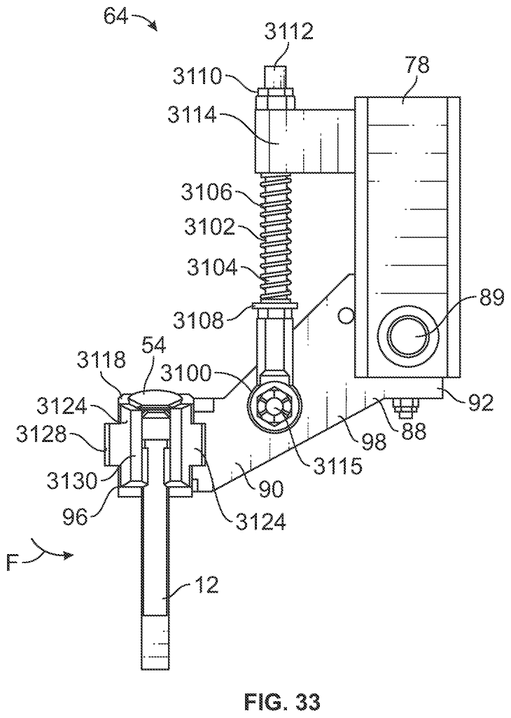

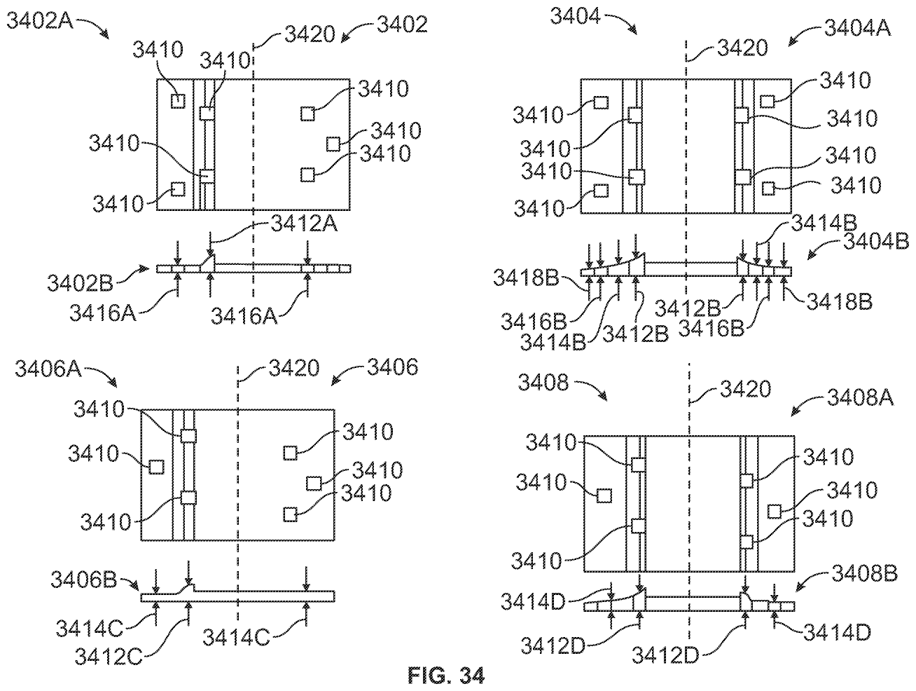

The fastener driving machine 10 illustrated in FIG. 30 also includes a fastener feeder mechanism 62. FIG. 31 illustrates an exploded view of the fastener feeder mechanism. FIG. 32 illustrates a shaft 68 of the fastener feeder mechanism, according to one embodiment. FIG. 33 illustrates a front view of the fastener feeder mechanism, according to one embodiment.

In the illustrated embodiment, the fastener feeder mechanism includes a fastener holder 64 that moves between a first position (fragmentarily shown in phantom in FIG. 30) and a second position (shown in solid lines in FIG. 30). In the first position, the fastener feeder mechanism receives a fastener from the magazine, and in the second position, the fastener is placed in a driving position for engagement by the ram 44 for driving the fastener. In the illustrated embodiment, the fastener feeder mechanism may lower and axially rotate from the first position to the second position to move each fastener away from the magazine and towards the driving position. In one embodiment, the vertical (lowering) movement component and the axially rotating movement component of the fastener feeder mechanism may be performed in close temporal succession. For example, these plural movements may occur substantially simultaneously, as indicated by the arrow A in FIG. 30 and as described below.

Referring now to FIG. 30-32, the fastener feeder mechanism includes a fluid power feeder cylinder 66 having the shaft 68 with a groove 70 that may rotate while reciprocating. More specifically, the groove includes an elongated, generally axial portion 72 for effecting vertical movement, and a semi-helical component 74 for effecting axial rotation. In the illustrated embodiment of FIG. 32, the shaft may be radially thickened along its length to accommodate and support the groove while maintaining structural strength. The groove may be slidably and matingly engaged by a cam follower 76 (shown in FIGS. 29 and 31) that extends into the cylinder to provide the desired movement. In an example embodiment, the semi-helical component of the shaft may rotate approximately 90-degrees between a retracted position and an extended position. This example 90-degree rotation moves the fastener from the delivery point to the location of the ram, and axially rotates the fastener by about 90-degrees. Upon driving of the fastener, the head of the fastener may be oriented approximately transverse to the direction of the rail. Thus, once the feeder cylinder has been energized, the fastener holder may be simultaneously lowered and axially rotated to move the fastener as described.

The fastener holder 64 includes a support block 78 having a generally vertical counterbore 80 for receiving a free end 82 of the shaft. The block may be fastened to the free end of the shaft, such as by a threaded fastener 84 and a key 86 (shown in FIG. 31) engaging a keyway (not shown) machined in the end of the shaft. Thus, the block may not rotate relative to the shaft.

A jaw mount support 88 may be pivotably secured to the support block to pivot on an axis 89 transverse to the direction of travel of the machine 10 on the route. The jaw mount support may have a generally planar body 90 with a first end 92 having a pivot bore 94, and a second end 96, that has an area that is smaller than the first end, that is offset from the first end in a dogleg style or other offset configuration. A central section 98 may be provided with a mounting bore 3100 for a spring rod 3102, including a shaft 3104 circumscribed by a compression spring 3106 retained in position by suitable washers 3108 and locknuts 3110. An upper end 3112 of the spring rod may be slidably received in a weldment 3114 secured, as by welding or suitable equivalent, to the support block. A lower end of the spring rod may be engaged on the jaw mount support by a fastener 3115 engaging the mounting bore. The spring rod may bias the jaw mount support in an operational position (shown in FIG. 33) with the force acting in a direction represented by the arrow F toward the track and in the direction of travel of the machine 10 along the track.

Returning to the jaw mount support, the second end may be narrower than the first end, with the central section tapering therebetween. The second end may include a jaw mount aperture 3116 (shown in FIG. 31) for receiving a jaw mount or jaw mount block 3118. The jaw mount has a body 3120 having a generally “L”-shape when viewed from the front and provided with first and second sides 3122. Each side may receive a corresponding jaw 3124. Each jaw may be pivotally secured to the corresponding side via a pivot pin 3126 passing through a throughbore 3127 approximately centrally located in the jaw and extending into the jaw mount body. The location of the throughbore on the jaw may be selected based at least in part on end-use requirements and application. Some suitable jaws may be “T”-shaped when viewed from the side. Each jaw may have a relatively narrow pivot end 3128 and a relatively wider free end 3130 opposite the pivot end and as such reciprocate laterally on the jaw body. At least one jaw spring 3132 may connect to the corresponding jaw and to the jaw mount body to bias the jaws toward a closed position about a fastener 12 (shown in FIG. 33). In one embodiment, the jaw spring may be a compression type that pushes the pivot ends away from the jaw body. In one or more embodiments, one spring could bias both jaws. During operation, the jaws may support the fastener by the head and may not surround a portion of a body of the fastener, facilitating the withdrawal of the fastener holder once the ram has at least partially driven the fastener into the tie by the fastener head.

In one or more example operations, operation of one or more of the fastener driving units may be controlled at least partially automatically using an image sensor (imaging sensor), a processor-based vision processing system (vision system), and/or a processor-based control system that may control the fastener driving units to drive spikes in the tie plates, while accounting for variances in tie plates. Vision-based methods incorporating 3D image capturing and processing using machine learning may be used in example embodiments to image tie plates over which the rail fastener driving machine 10 may be positioned, and determine tie plate configurations based on the imaged tie plates. The tie plate configurations may be used to determine and/or assist in determining a spiking pattern for spiking the tie holes. A control system may automatically control the fastener driving units based on the determined spiking pattern.

Referring again to FIG. 28, an image sensor 2800 is disposed adjacent to the rail fastener driving machine. In the illustrated embodiment, the image sensor is a camera and is disposed in a location suitable for obtaining an image of a tie plate disposed underneath the rail fastener driving machine. The camera may include and/or be combined with (e.g., coupled to) one or more location, position, range finders and/or orientation sensors for obtaining location, relative or absolute position, and/or orientation information of the camera. Example detectors may include, but may be not limited to, gyroscopes, global positioning satellite (GPS) receivers, and the like.

The camera may obtain images of the tie plate. If the camera used is a three-dimensional (3D) camera, the camera may capture three dimensional images. Alternatively, a two dimensional camera may obtain 2D images. Multiple 2D cameras may be used to create a 3D map of the rail, the tie, the ballast, an orientation of the spike, or the like. One or more 3D cameras and one or more 2D cameras may be combined for image capture.

In some example embodiments, the camera(s) may be employed along with pattern matching methods in a vision system to determine, for example, features of the imaged tie plate, such as hole locations, rail foot locations, plate center, or the like. Providing a model of the tie plate may allow identification of a tie plate in three dimensions, which may facilitate determining a location of a center of one or more spike holes. Further, the shape and/or profile of the tie plate can be used in 3D pattern matching to determine if the tie plate has been previously identified. In other embodiments, the object maps may be compared to standard tie plate designs, baseline images, golden samples, look up tables, and the like. Correction algorithms can account for differences in time-of day, lighting, weather, grade, and related factors, between the imaged tie plate and standard or baseline tie plate designs. The control system may process or identify features to compare the imaged tie plate image to previously stored tie plate configurations with known hole locations, such as to determine a location of one or more holes in the imaged tie plate, even when the holes may be obscured, for instance, by debris or other conditions, when there may be conditions present that degrade the quality of the image (e.g., dirt, ballast, or liquids on portions of the tie plate). If a pattern is not found, features, such as holes of the imaged tie plate, may be identified individually or independently.

In one or more example methods, one or more processors may receive the 3D image data and may use a model (e.g., a learning model, a machine-learning model, a deep learning model, or the like) to identify one or more 3D tie plate configurations (e.g., stored within a database and/or memory storage device) from the one or more imaged tie plates. In one or more embodiments, the 3D tie plate configuration may be identified if one or more holes are at least partially obscured, are not visible in the image data, or the like. In one or more embodiments, the model may find and/or determine a position of one or more holes on a new plate, such as a new plate that may be not part of an existing plate database, For example, the machine may be adding spikes to a new plate or a new plate configuration for the first time. In one or more embodiments, the model may be trained to identify (e.g., classify) spike holes so it can find spike holes even with some degradation to the image of the tie plate.

In one or more embodiments, example control algorithms may employ an associated spiking pattern to select which holes may be spiked. Once the resulting positioning of a spike hole and/or spike hole pattern is determined, the controller may operate the fastener driving units and control the spiking operation.

The camera and/or additional sensors, if any, may be in signal communication (e.g., wired and/or wireless communication). Suitable wireless communication protocols may include Bluetooth or other short-range protocol, Wi-Fi or other long-range protocol, and the like. Optionally, there may be an intermediary processor-based device for receiving, storing, and/or processing image data generated by the camera in response to capturing an image of the tie plate. The processor-based device may be incorporated with, or in signal communication with, a control panel disposed onboard the vehicle (e.g., in the cab where the operator may be located, or otherwise accessible to the operator). Optionally, the processor-based device may be disposed off-board the vehicle, and may be accessible to an operator located off of the vehicle. For example, the operator may be one or more remotely located operators that may not be physically present within the cab and/or onboard the vehicle. In one or more embodiments, the control panel receives operator-input data and provides visual and/or audio feedback to the operator. It may be contemplated that some or all of the control panel functions may be provided by a processor-based device that may be secured (removably or fixed) to the cab, such as by a portable communication device (e.g., a smartphone, tablet, personal computer, virtual or augmented reality device, etc.), or a combination of any of these.

In one or more embodiments, example operator-input data received from an operator can relate to, for instance, zones of a tie plate, a spike pattern, rail weight, and the like. Such operator input data can help to set operational parameters for the fastener driving units.

In one or more embodiments, example control systems may include an interface such as a graphical user interface (GUI) for allowing an operator to enter and/or modify tie plate configurations and/or associated spiking patterns. The entered and/or modified tie plates may be stored in suitable storage, e.g., a non-transitory memory, a database, etc. Providing such an interface allows for configurability of accessible tie plate data, accounting for various tie plate configurations. Optionally, interfaces embodied in operator-level monitors (e.g., screens) of processor-based devices provide for particular configurations (e.g., railroad-specified configurations) based on one or more of track speed, track type, route curvature, or the like. Configurations may be performed before the machine leaves, in the field, or a combination.

Tie plate configurations can vary from one type to a different type, from one manufacturer to a different manufacturer, from one model to a different model, etc.. For instance, tie plate configurations may differ in physical features affecting the tie plate hole (spike hole) location(s). Such features can include, but are not limited to, tie plate length/width/thickness dimensions, shoulder locations, number of tie plate holes, tie plate hole location on the plate, etc. For instance, FIG. 34 illustrates a top view of a set of examples of different tie plates, illustrating example differences in hole location, number, etc. For example, a first configuration 3402 includes a top view 3402A and a side view 3402B. The first configuration includes seven holes 3410, with four holes disposed in a pattern on one side of a center axis 3420 of the plate (e.g., a left side) and three holes disposed on the other side of the center axis. The plate varies in thickness between a first thickness 3412A and a second thickness 3416B, with the holes extending through the different thicknesses of the plate based on the location of the corresponding hole.

A second configuration 3404 includes a top view 3404A and a side view 3404B. The second configuration includes eight holes 3410 disposed in a configuration that is different than the first configuration. For example, the second configuration includes four holes on one side of the center axis, and four holes on the other side of the center axis. Additionally the plate of the second configuration varies in thicknesses between a first thickness 3412B, a second thickness 3414B, a third thickness 3416B, and a fourth thickness 3418B.

A third configuration 3406 includes a top view 3406A and a side view 3406B. The third configuration includes six holes 3410 disposed in a configuration, with three holes on one side of the center axis, and three holes disposed on the other side of the center axis. The plate of the third configuration may have varying thicknesses, between a first thickness 3412C and a second thickness 3414C. A fourth configuration 3408 includes a top view 3408A and a side view 3408B. The fourth configuration includes six holes, with three holes disposed on one side of the center axis (e.g., the left side) and three holes disposed on the other side of the center axis (e.g., the right side). Additionally, the holes of the fourth configuration extend through varying thicknesses 3412D, 3414D of the plate of the fourth configuration.

In the illustrated embodiment, the holes of the third configuration (as illustrated in the top view of the third configuration) may have an arrangement that is substantially the same or similar to the arrangement of the holes of the fourth configuration (as illustrated in the top view of the fourth configuration). However, the varying thicknesses of the plate of the third configuration differ from the varying thicknesses of the plate of the fourth configuration. For example, the holes extending through the plate of the third configuration extend through different thicknesses relative to the holes extending through the plate of the fourth configuration. Optionally, the plate may have any alternative uniform and/or varying thickness across a width of the plate, and the plate may include any number of holes arranged in any configuration.

In one or more embodiments, a proper spiking pattern may depend on all tie holes for tie plates being properly identified. However, given the large number of possible tie plate configurations based on these features and others, it would be difficult and time-consuming, or even impossible, to manually train an automated spike control system to pre-configure and/or adjust a spiking pattern for each potential tie plate that may fit a rail, even if some of the configurations may be filtered out (such as by restricting to a rail foot width). Further, if a spiking pattern needs to be changed, it would similarly be burdensome to update all existing configurations, or to create and separately maintain new ones. Additionally, the large variety of tie plate sizes and hole layouts can be challenging to accommodate in a simple interface.

In one or more embodiments, the controller may store and/or retrieve spiking patterns for various tie plate configurations in a more generalized manner, while allowing for adjustment and configurability where needed. In example embodiments, instead of creating and storing predetermined spiking patterns based on pre-configured tie plate data by individual tie plate, example methods may generate, configure, and/or store spiking patterns by subdividing tie plate configurations into assigned areas, referred to herein as spiking zones. The spiking zones can be selected automatically by a spiking control system and/or manually by an operator to allow for spiking (or not spiking) any hole that may be contained within the respective spiking zone. These spiking zones can provide a spiking pattern that may be stored for later retrieval and use in the field to control a spiking operation.

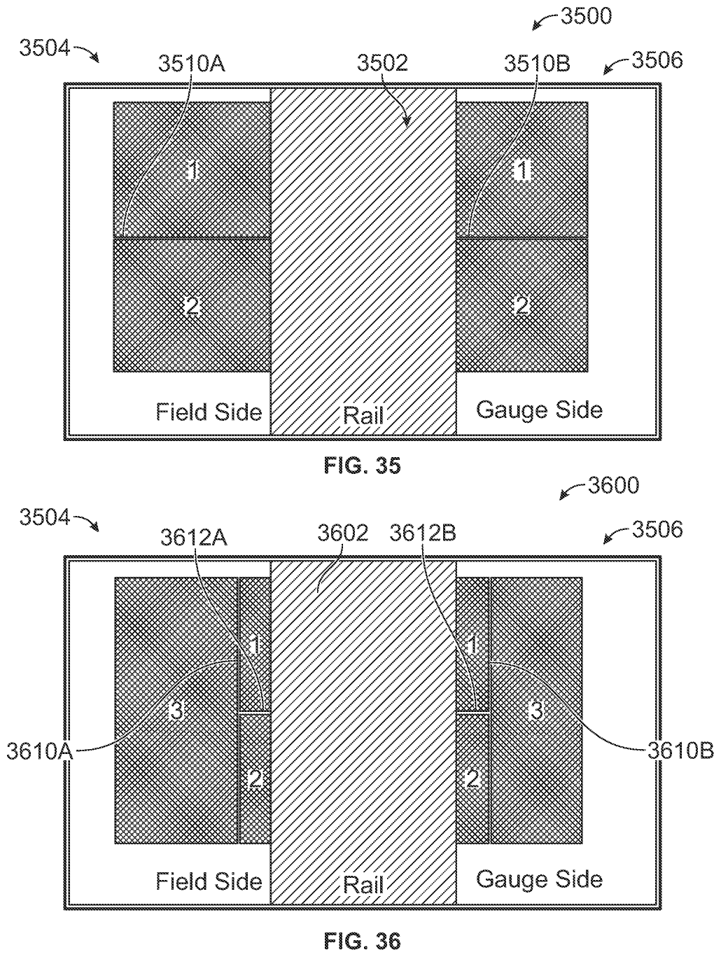

In example embodiments, the number of spiking zones in which the tie plate configurations may be assigned can be based on, for instance, the number of holes on each side of the rail. For example, FIGS. 35-37 illustrate examples for subdividing a tie plate image into spiking zones using zone dividers or borders. In example methods, spiking zones extend where possible to the edges of the tie plate image.

In one or more embodiments, locations of one or more borders may be determined to divide the tie plate configuration into different spiking zones on each side of the rail. In the illustrated embodiment of FIG. 35, a tie plate image 3500 includes a rail 3502, a field side 3504 on one side of the rail, and a gauge side 3506 on the other side of the rail that is opposite the field side. The image also includes a substantially horizontally-extending border 3510A on the field side, and a substantially horizontally-extending border 3510B on the gauge side. For example, the borders differentiate four spiking zones that have substantially uniform sizes relative to each other. In one or more embodiments, if a tie plate has two holes on a field side and two holes on a gauge side of a rail, there can be assigned two spiking zones on each side of the rail to allow for one spiking zone for each hole. For example, the border 3510A on the field side creates two spiking zones, and the border 3510B on the gauge side creates two spiking zones.

Alternatively, in a tie plate image 3600 shown in FIG. 36, the field and gauge sides each have three holes, in which case there can be three spiking zones to allow for one spiking zone for each hole. For example, the field side includes a horizontally-extending border 3612A and a vertically-extending border 3610A, and the gauge side includes a horizontally-extending border 3612B and a horizontally-extending border 3610B. The plural borders create three spiking zones on the field side of the rail and three spiking zones on the gauge side of the rail. Similarly, three borders can be used to create four spiking zones on one or more sides of the rail, four borders can be used to create five spiking zones on one or more sides of the rail, and so on.

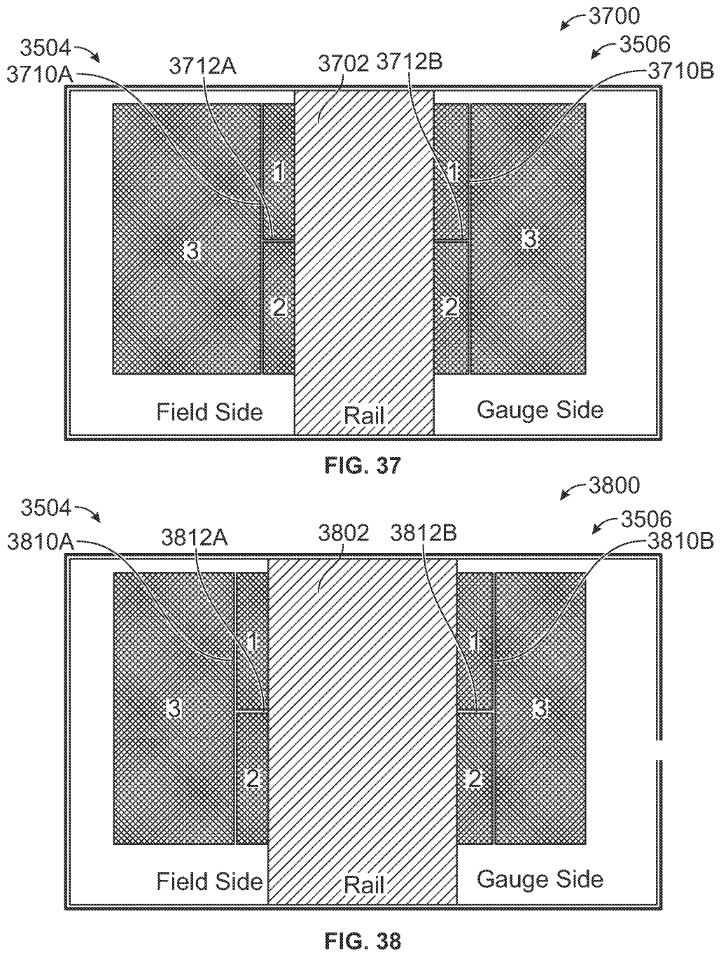

In one or more embodiments, spiking zones can be used to provide spiking patterns for tie plates irrespective of rail weight (e.g., rail size, rail width, etc.). For example, FIG. 37 illustrates a tie plate image 3700 that includes borders 3710A, 3710B, 3712A, 3712B defining three zones on each side of a rail 3702, and FIG. 38 illustrates a tie plate image 3800 that includes borders 3810A, 3810B, 3812A, 3812B defining three zones on each side of a rail 3802. The rail 3702 shown in FIG. 37 is light (e.g., is smaller, narrower, etc.) relative to rail 3802 shown in FIG. 38. In one or more embodiments, the tie plate configuration can dictate the physical properties of the tie plate such as rectangular dimensions, locations of shoulders, locations of the tie holes, or the like. For example, the rail weight (e.g., the rail width) dictates which tie plate configurations may be possible (valid) for the rail.

Because the example spiking zones may be located relative to the plate shoulders in the tie plate images, the hole location may be not affected by varying rail weight. Further, since example spiking zones can extend to the edges of the tie plate image, the spiking zone locations may be not affected by varying rectangular dimensions of the tie plate. In one or more embodiments, the locations of the spiking zones can be determined based on one or more of the plate shoulder positions (as the spiking zones can expand out from the shoulder) and the number of holes (which determines the number of zones). This may be done without the need to consider other physical properties of the tie plates. In one or more embodiments, the controller may correct for physical properties beyond shoulder position and/or number of holes.

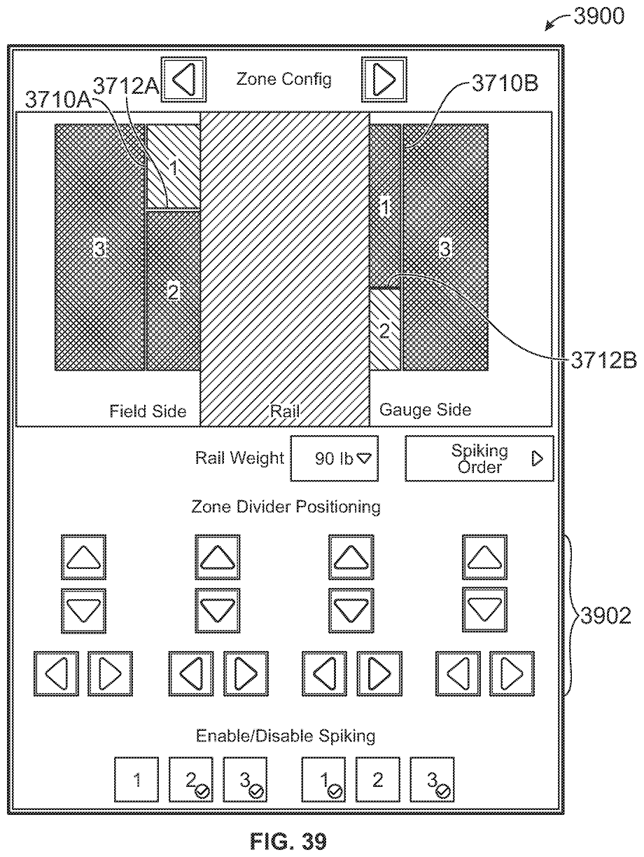

FIG. 39 illustrates an example of a spiker zone interface 3900 for configuring and/or adjusting spiking zones, such as the spiking zones shown in the example tie plate configuration of FIG. 37. The spiking zones may be configured and/or adjusted based on operator input from a control system having a GUI. In the tie plate configuration of FIG. 39, the vertically-extending border 3710A on the field side has been moved toward the tie plate edge (e.g., away from the rail edge), making zones 1 and 2 wider and zone 3 narrower. Additionally, the horizontally-extending border 3712A on the field side may be moved up, and the horizontally-extending border 3712B on the gauge side may be moved down.

Vertical and horizontal arrows 3902 (e.g., soft keys, interactive widgets or icons on a touch-sensitive display, hard keys or buttons, or the like) may be provided for shifting horizontal and vertical borders on either the field or gauge side in up, down, left, or right directions, respectively. The GUI may include an interface (illustrated as a drop-down menu) for selecting a rail weight. Optionally, the GUI may include controls (e.g., soft keys or buttons) for selecting individual zones for spiking or not spiking in a particular spiking pattern. For instance, in FIG. 39, zone 1 on the field side and zone 2 on the gauge side have spiking turned off (are deselected) and may be shown in red on the display. Zones 2 and 3 on the field side and zones 1 and 3 on the gauge side may be turned on (selected) and shown in green. In operation, a hole that may be located anywhere within zones 2 or 3 on the field side will be spiked, but not a hole that may be located in zone 1 on the field side.

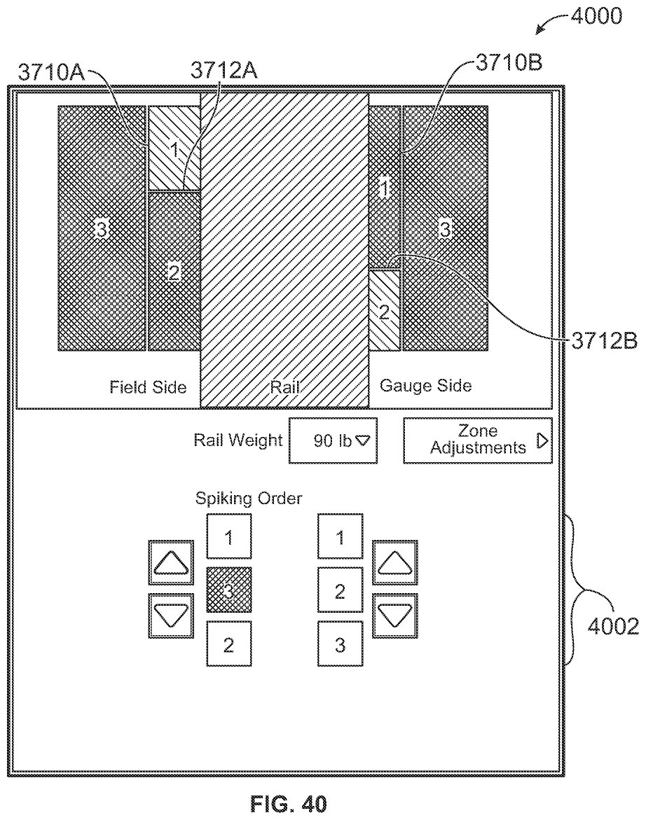

In one or more embodiments, it may be possible to navigate between interfaces for different configurations, such as the spiker zone adjustment interface shown in FIG. 39, and a spiking order selection interface 4000 shown in FIG. 40 (FIG. 40). The spiking order interface may indicate and/or determine which spiking zones will be spiked first, which spiking zone will be spiked second, and which spiking zone will be spiked third (or last). A default order may be determined, for instance, based on a determined zone number (e.g., zone 1 by default may be spiked first, then zone 2, etc.). In FIG. 40, controls 4002 (e.g., soft keys) may be provided for rearranging the spiking order of the spiking zones. The example controls include controls for zone selection and for moving the selected zone up or down (earlier or later) in the spiking order. In FIG. 40, for example, the field side zone spiking order may be changed to 1, 3, 2, while the gauge side zone spiking order has not been modified so that the default order 1, 2, 3 may be currently set. However, since in zone 1 on the field side and zone 2 on the gauge side have been deselected (indicated in FIG. 39), these zones will be ignored in the spiking pattern, so that the field size spiking zone order may be effectively 3, 2, while the gauge side spiking order may be effectively 1, 3.

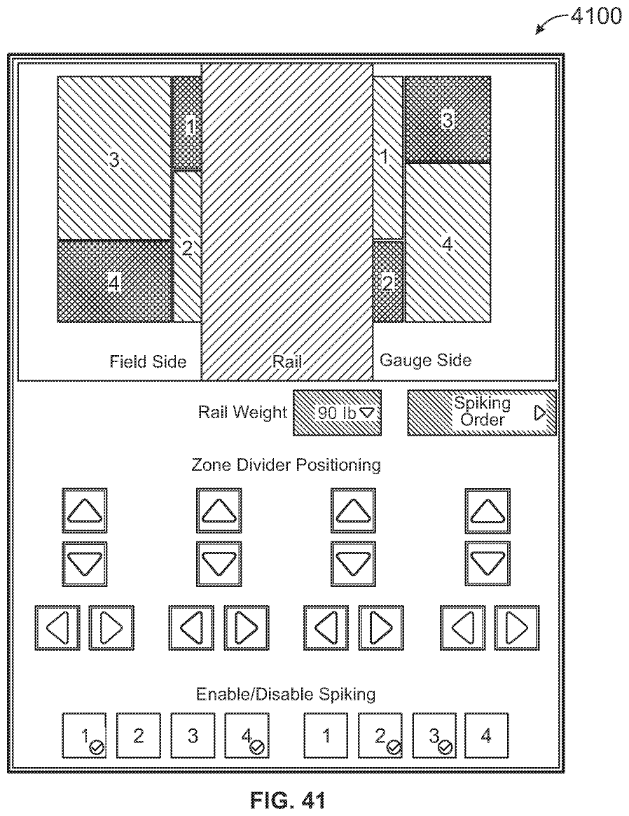

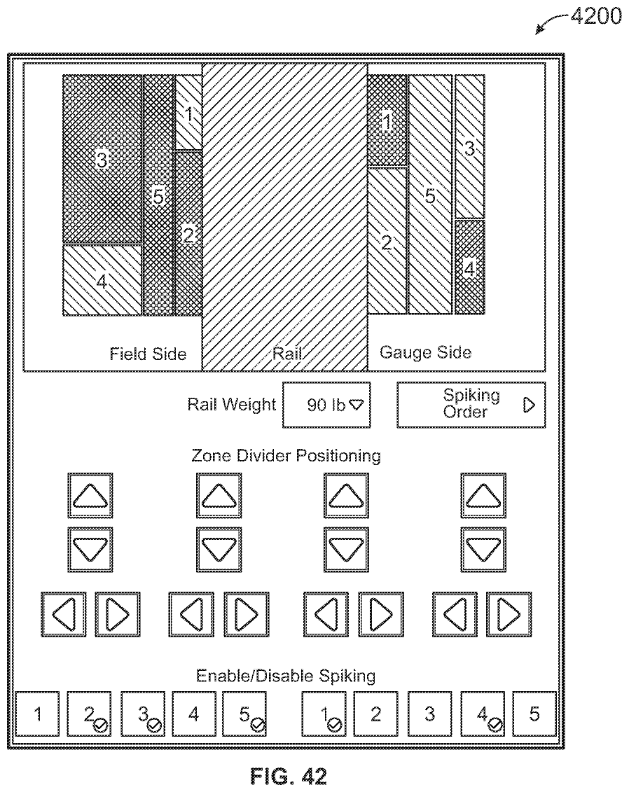

FIGS. 41 and 42 illustrate additional and/or alternative examples of spiker zone interfaces 4100, 4200, respectively. The spiker zone interface 4100 may be used for a four-zone tie plate configuration, and the spiker zone interface 4200 may be used for a five-zone tie plate configuration. In FIGS. 41 and 42, the border positioning interface may be displayed, and zones on the field and gauge side have been de-selected and reordered for a spiking pattern.

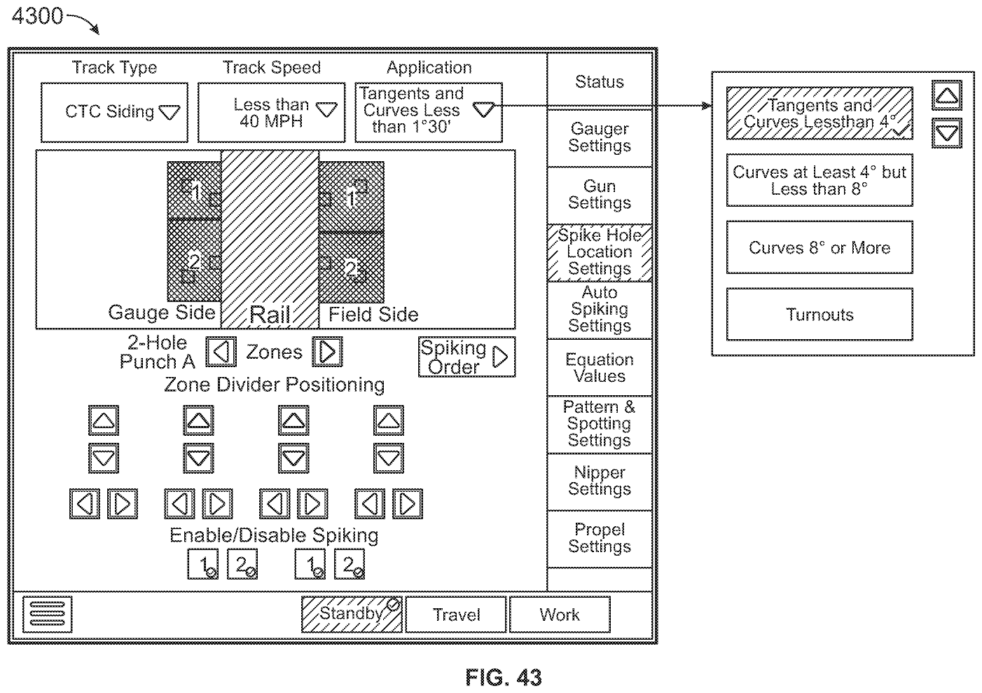

Some spiking patterns may be based at least in part on features in addition to the various possible tie plate sizes, hole layouts, hole quantities, and hole positions. Further example features may include features based on varying track conditions, such as track type, speed limits, or application (curvature), which can be input by an operator. FIG. 43 shows an example interface 4300 for customizing a spiking pattern based on features such as track type (e.g., main track, centralized traffic control (CTC) siding, vehicle yard, industry and/or industrial track, paved road, gravel route, etc.), speed limit (e.g., less than 40 mph; about 40 mph, or greater than 40 mph), route curvature (e.g., tangent; less than about 30′, less than about 1°, less than about 4°, less than about 8°, greater than about 8° or more, turnouts, etc.), or the like. Controls for other example settings or displays (e.g., for status, gauger settings, spiker gun settings, spike hole location settings, auto spiking settings, pattern and spotting settings, nipper settings, and propel settings, etc.) may be provided in the interface.

The tie plate configurations and spiker patterns may be processed in example control operations in the field (e.g., on a route, in real time such as while the fastener driving unit is moving and/or operating) for automatic and/or semi-automatic control of a spiking operation. In one or more embodiments, autonomous and/or semi-autonomous fastener driving unit control may provide consistency in performance relative to manual or non-autonomous control of the fastener driving unit. Such autonomous and/or semi-autonomous control may free time for an operator.

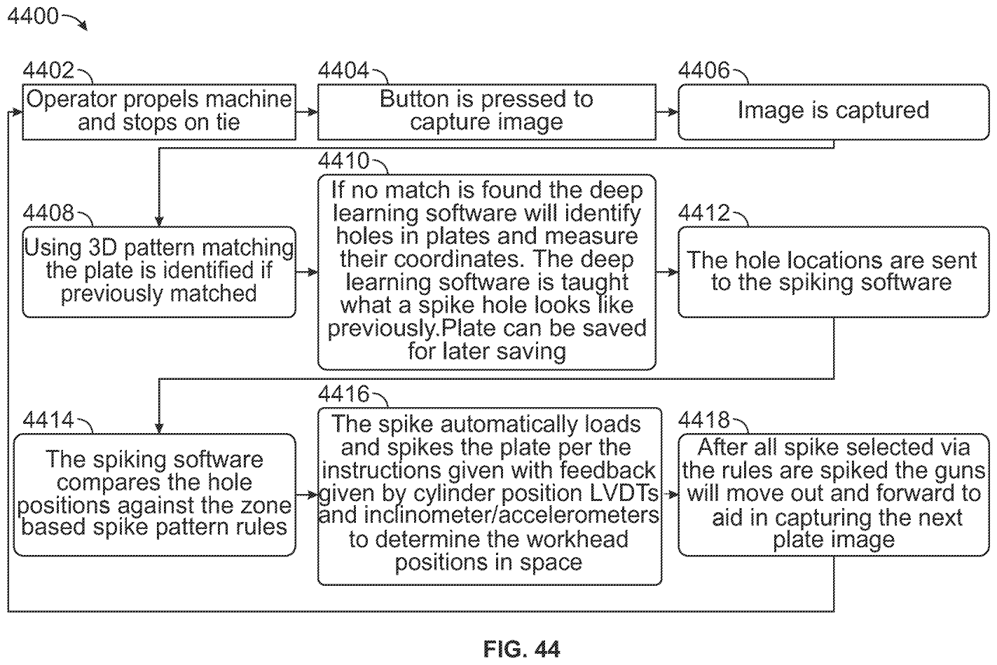

FIG. 44 illustrates one example of a flowchart 4400 of a method for controlling operation of the fastener driving unit. The example method may be performed, for instance, by the vision system (including the 3D camera) in communication with the control system. The example operation may be executed as a loop, but may terminate at any step, for instance, if a final tie plate has been spiked. Optionally, one or more steps of the method may be duplicated or repeated, skipped, or the like, during the execution of the loop. In an example operation, at step 4402, an operator may propel the rail fastener driving machine and stop the driving machine at a location that is over, or over a portion of, a tie plate. An instruction may be received by the vision system to capture an image of the tie plate. For example, at step 4404, a button may be pressed to capture the image. Alternatively, the instruction for image capture may be automatically triggered by the control system based on, for instance, detection of a tie plate or candidate, one or more sensors, or on other criteria.

In response to the instruction to capture the image, at step 4406 the camera captures one or more images of the tie plate. In an example embodiment, the tie plate image may be captured via a 3D high dynamic range (HOR) scan with two-dimensional imagery. In another example, the tie plate image may be captured by a camera having alternative 2D imagery capabilities. A 3D pattern with the 2D image(s) may provide the controller with multiple data points to compare/contrast hole information as available to detect holes. For example, using both 2D and 3D types of data may provide more consistent results with relatively less error compared to using only 2D type of data or only 3D type of data. In one or more embodiments, a 3D camera may reduce or eliminate the possibility of false holes being detected caused by dark spots on the plate where it will only see height differentials.

In one or more embodiments, the vision system may analyze the imaged features of the particular tie plate. These features may be broken down by the vision system into hole locations, rail foot locations, plate center, or other features of the rail, route, tie plate, or the like, which may be transmitted to a control system.

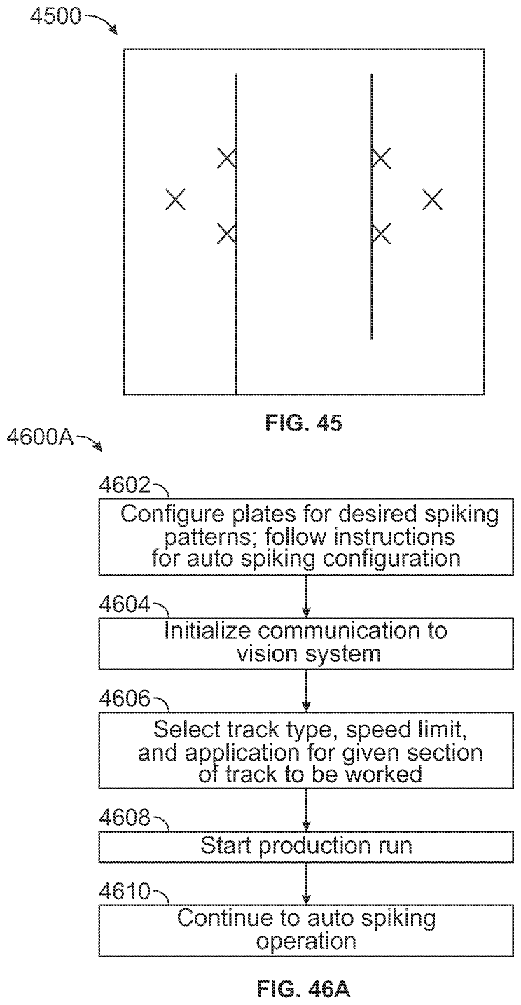

At step 4408, the control system performs 3D pattern matching, for instance by a processor-implemented comparison algorithm, such as a machine-learning model (e.g., a deep learning model, such as a trained neural network), to identify a previously-stored tie plate configuration based on the identified features of the captured 3D image. For instance, FIG. 45 shows an example processed tie plate image 4500 of a tie plate hole pattern. Nonlimiting example machine-learning models include deep learning models used for image classification in computer vision, such as but not limited to convolutional neural networks (CNNs).

At step 4410, if no match may be found, the comparison algorithm can optionally identify tie holes in the captured 3D tie plate image. For instance, the deep learning model (or a different deep learning layer or model) can be trained to identify tie plate holes. The coordinates of the identified tie plate holes can be determined (e.g., measured). Hole locations may be initially determined through pattern matching, or determined individually or independently of pattern matching. The newly captured 3D tie plate image can be saved for later use, e.g., for determining a new tie plate spiking pattern, for further training of the deep learning model, etc. Alternatively, if a match for the tie plate image is located, step 4410 may be skipped, and flow of the method may proceed toward step 4412.

At step 4412, the hole locations (e.g., from the matched 3D pattern of the stored tie plate configuration or from the measured tie plate image if a match may be not found) may be sent to spiking control software. At step 4414, the spiking control software, executed by a processor of a control system, compares the obtained hole positions against the zone-based spike pattern rules stored for the identified matching tie plate configuration. At step 4416, the spiking control software (in one embodiment, automatically) loads and spikes the tie plate based on stored instructions (e.g., from the stored spiker pattern associated with the tie plate configuration).

Feedback (e.g., from sensors such as the cylinder position Linear Variable Distance Transducers (LVDTs), inclinometers/accelerometers, etc.) may determine the workhead position. The stored spike pattern may be actuated, and at step 4418, the spiker guns may be move out and forward to assist in capturing the next tie plate image. For example, the method may return to step 4402 and another tie plate may be examined.

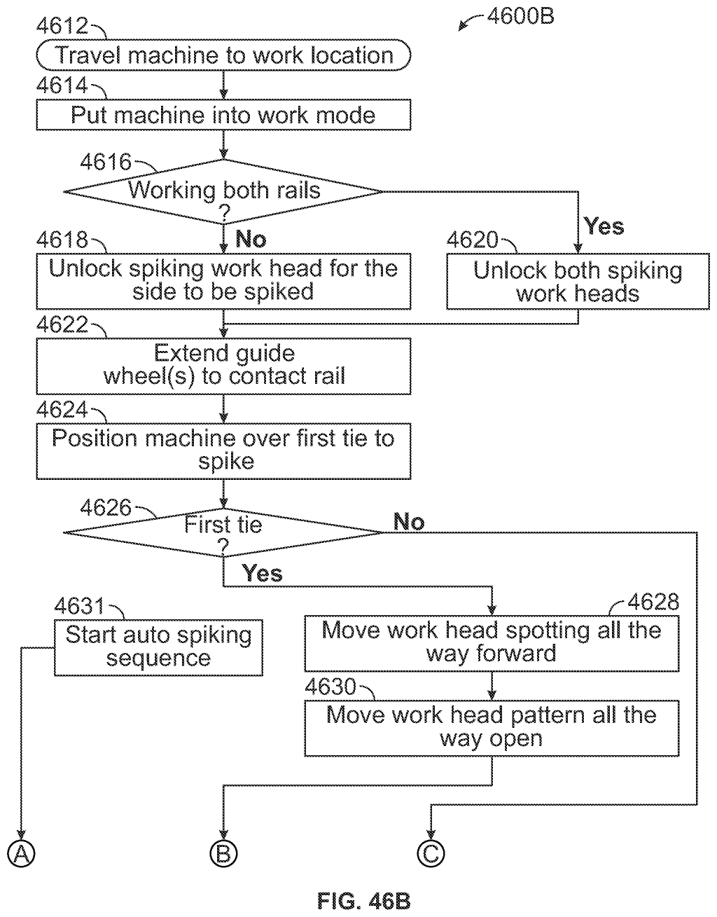

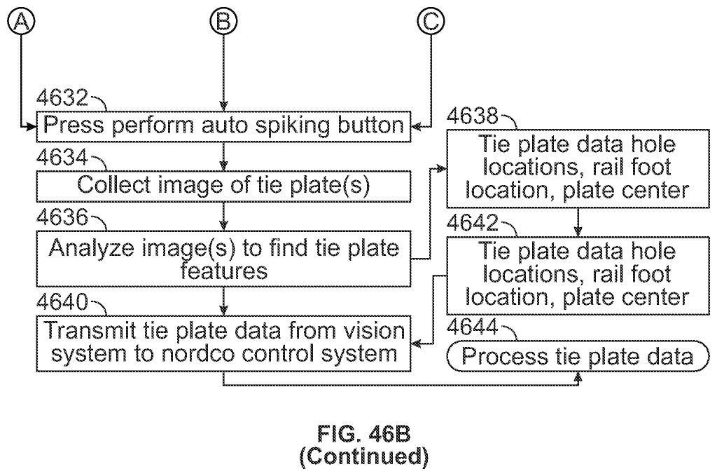

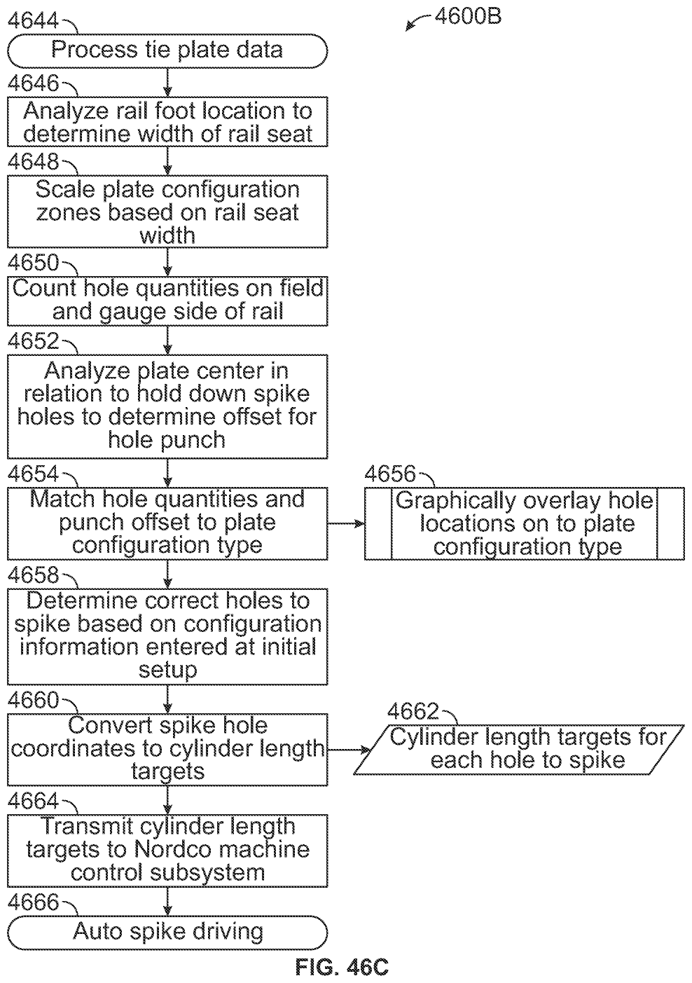

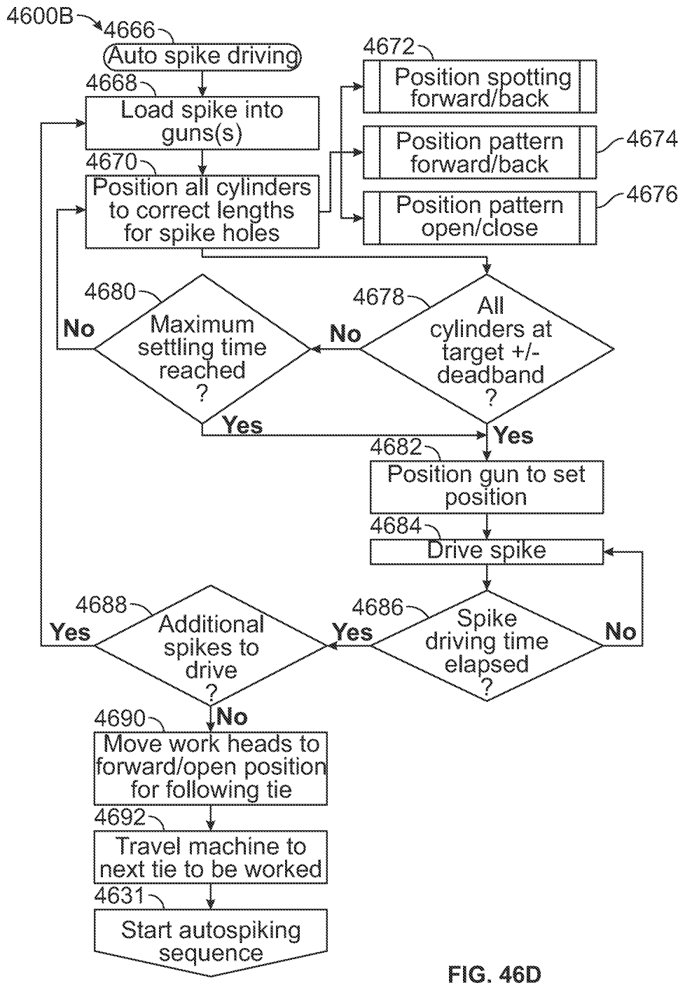

FIGS. 46A-46D show an operation of an example system for automatic or semi-automatic spiker control. A first flowchart 4600A (shown in FIG. 46A) illustrates one or more steps that may be performed to initiate a spiking operation. A second flowchart 4600B (shown in FIGS. 46B-46D) illustrates one or more steps that may be performed to complete the spiking operation. At step 4602, tie plates may be configured for desired spiking patterns based on operator inputs using a processor-based device executing software instructions and providing a user interface. The spiking patterns can be determined according to example configuration methods. The tie plate configurations with associated spiking patterns may be stored in suitable storage, e.g., in non-transitory storage such as non-transitory media, a nonlimiting example being a database that may be accessible to the control system.

At step 4604, the control system and/or an operator initializes communication to a vision system. The vision system can be embodied in an image capturing device such as the 3D camera, and a processor executing stored instructions for processing a captured 3D image according to example methods provided herein. Example processing of the captured 3D image includes comparing the 3D image to stored tie plate hole location patterns using a machine learning model, analyzing the 3D image to identify one of the stored hole location patterns as a match, e.g., based on 3D pattern recognition, retrieving tie plate data based on the identified hole location pattern, and transmitting the tie plate data to the control system for controlling a spiking operation.

At step 4606, the control system may receive and/or select one or more selected track inputs based on varying track conditions such as track type, speed limit, or application (curvature). At step 4608, a spiking run may then start, and at step 4610, the auto-spiking operation may continue.

Referring to FIG. 46B, during a production run, at step 4612 the rail fastener driving machine 10 may be transported to a work location, such as a railroad in which a spiking operation may be to take place. At step 4614, the control system may be put into a work mode. At step 4616, a determination is made whether both rails may be being operated on. If both rails will be operated on, then steps 4618 and 4620 are completed and both spiking workheads (spiking heads) of the fastener driving unit may be unlocked. Otherwise, if only one of the rails will be operated on, only the corresponding spiking head on the side to be spiked may be unlocked.

At step 4622, guide wheels of the rail fastener driving machine may extend to contact the rail(s), and at step 4624, the rail fastener driving machine 10, e.g., the fastener driving unit, may be positioned over a tie plate to be spiked. At step 4626, if this tie is the first tie to be spiked in the current operation, flow of the method may proceed toward step 4628. At step 4628 the spiking head may be moved spotting completely forward, and at step 4630, a workhead pattern may be moved completely open. Alternatively, if at step 4626 the tie is not the first tie to be spiked, flow of the method may proceed toward step 4632.

At step 4631, an auto-spiking sequence may begin. To begin an auto-spiking sequence, at step 4632, the vision system may receive an instruction, e.g., from the operator and/or from the control system, to begin an automatic and/or semi-automatic spiking operation. In response, at step 4634, the 3D camera in the vision system (and any 2D cameras if used) collects (e.g., captures) an image (or images) of the tie plates.

At step 4636, the vision system analyzes features of the imaged tie plate. These features may be then broken down into tie plate data such as hole locations, rail foot locations and plate center, e.g., by accessing stored data (e.g., in a database) associated with the identified hole location pattern (e.g., steps 4638 and 4642). At step 4640, the tie plate data may be output, e.g., transmitted, to the control system. The control system may receive hole locations and spikes based on a rules setup on a screen by an operator using zone spiking rules, and at step 4642, the tie plate data may be processed.

The flowchart 4600B continues to FIG. 46C, which shows an example method for processing tie plate data for spiker control. At step 4646, the rail foot location may be analyzed by the control system to determine a width of a rail seat, and at step 4648 the tie plate configuration zones (spiker zones) may be scaled based on the rail seat width. At step 4650, the control system may count hole quantities on the field side and the gauge side of the rail. At step 4652, the control system further analyzes the plate center in relation to hold down spike holes to determine an offset for hole punching.

At step 4654, hole quantities and punch offset may be then matched to a stored tie plate configuration type. For instance, at optional step 4656, the control system can graphically overlay the hole locations onto the plate configuration type using suitable image processing methods. At step 4658, the control system then determines the correct holes to spike based on the configuration information entered in the initial setup, e.g., according to the example tie plate configuration methods provided herein.

At steps 4660, 4662, and 4664, the spike hole coordinates may be converted to cylinder length targets for each hole to spike, and the cylinder length targets may be output, e.g., transmitted, to a machine control subsystem of the control system for automatic spike driving at step 4666. The flowchart 4600B may continue to FIG. 46D and includes an example operation of the steps associated with the automatic spike driving. In an example automatic spike driving operation, at step 4668, the spike(s) may be loaded into the spiker gun(s), and at step 4670 all cylinders may be positioned to the correct lengths for the spike holes (e.g., based on predefined processes for position spotting forward/back, position patterns forward/back, and position patterns open/close shown at steps 4672, 4674, 4676, respectively). At step 4678, if all cylinders may be at the target+/−deadband, or if a maximum setting time has been reached, flow of the method proceeds toward step 4682 and the spiker gun may be positioned to a set position. If not, then flow of the method proceeds toward step 4680 and the cylinders may be repositioned. At steps 4682 and 4684, the positioned spiker gun drives the spike, e.g., until a spike driving time has elapsed. If the spike driving time has not elapsed, then flow of the method returns to step 4684. Alternatively, if the spike driving time has elapsed, flow of the method proceeds toward step 4688 and a determination is made whether additional spikes need to be driven. At step 4690, the workheads may be then moved to a forward/open position for following the tie. At step 4692, the rail fastener driving machine 10 travels to the next tie to be worked, and step 4631 may repeat for a new auto spiking sequence to begin (e.g., FIG. 46B).

In one embodiment, the controller determines a distance between the spike in the magazine and the identified hole in the plate. The controller then signals an adjustment (if needed) to the cylinder actuator to ensure that the cylinder does not over travel or under travel when actuated.

In one embodiment, the controller senses aspects regarding the hole, the rail tie, the spike, and other factors to determine whether an adjustment signal should be sent to the spiker gun to set an actuation energy level that differs from a determined actuation energy level. For example, if the sensor data provided to the controller indicates that a tie of a softer material than the previous tie is present under the hole in the plate, the controller may signal that less actuation force should be used to set the spike in the tie. Conversely, if the controller determines that more force should be used based at least in part on the sensor data provided by the sensors (e.g., cameras) then the controller signals the actuator accordingly.

In one embodiment, the sensors record and map the tie plate after the spike has been driven through the hold and into the rail tie. The controller may determine that the placement was within determined tolerance levels, and if so may record the location and proper setting, and other related data. If the placement was determined to be out of tolerance the controller may respond in one or more ways. One suitable response may be to simply identify which spike and/or tie plate is affected and record and/or signal the defect to a determined recipient. Another suitable response may be to strike again, such as, for example, if the spike was not sufficiently seated in the hole. This would necessitate avoiding the load of a subsequent spike from the magazine. The controller may switch to another, otherwise unused, hole and place a second spike into the tie plate. If the spike head or the tie plate are deformed in a manner that indicates an overly energetic strike, the controller may reduce power on a subsequent spiking run and achieve a calibrated and appropriate strike force in subsequent attempts.

The controller may use the sensor data to check for additional aspects related to the health of the rail track. The surface of the rail, if in view of the sensors, may be checked for wear, cracks, pits, angle and the like. The condition of the ballast, the tie, and the other objects in view of the camera may be checked for aspects relevant to them. Information so collected may be stored along with the data on the spike, tie, and plate.

Embodiments of the subject matter described herein relate to a positioning system and method of operation. A positioning system according to an embodiment of the invention may allow for independent movement of two or more different hydraulic hammers relative to each other, and that may move to different target locations to drive fasteners into receiving apertures or holes. In one embodiment, the positioning system may include one or more discharge devices that may dispense and/or retrieve fasteners into and/or out from a vehicle route. The positioning system may include one or more shafts and/or links that operably coupled the discharge device(s) with a frame of a vehicle system.

The vehicle system may move the positioning system to different locations along a vehicle route, and the positioning system may control movement of the discharge device(s) to direct the fasteners into and/or out of holes disposed alongside the vehicle route. For example, the positioning system may align the discharge device(s) with holes disposed at different locations alongside the route. The positioning system may be arranged to allow movement of one discharge device in two or more different directions (e.g., linear and/or rotational directions of movement) relative to the vehicle route that is independent or separate from movement of another discharge device. Optionally, the positioning system may be arranged to allow movement of one discharge device in one direction that is independent or separate from movement of the discharge device in another, different direction. For example, each of two or more discharge devices of the positioning system may move separately and/or independent from each other. Movement may refer to position, speed, orientation, or a combination of the foregoing. A controller may operate the positioning system to determine movement of the discharge device(s) based at least in part on input from various sensors or controls. For automatic systems, the controller may use sensors and for a manual system (having an operator) the operator may operate controls. In some instances, the manual system with an operator may have some automatic aid (such as fine point alignments, pressure feed signals, and video stream feeds from one or more angles).

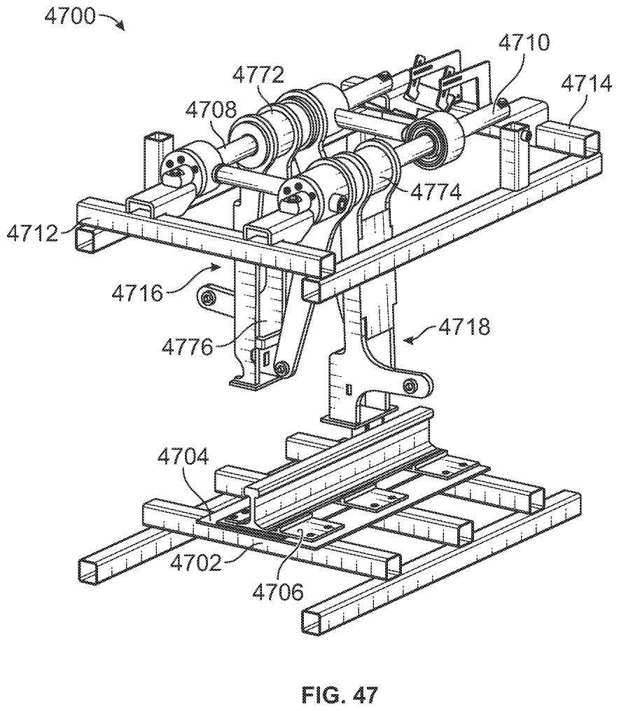

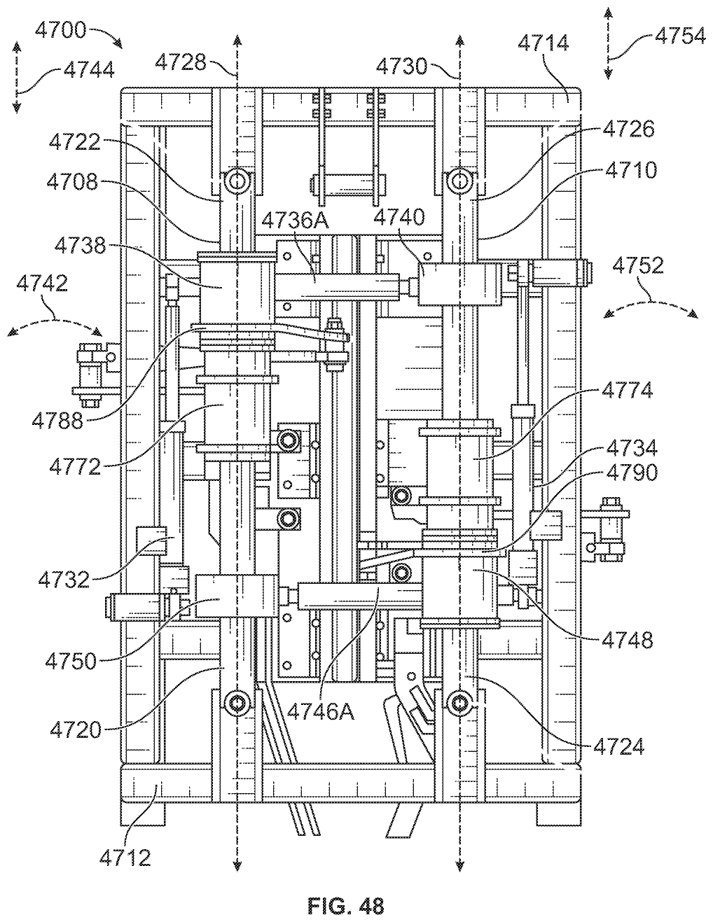

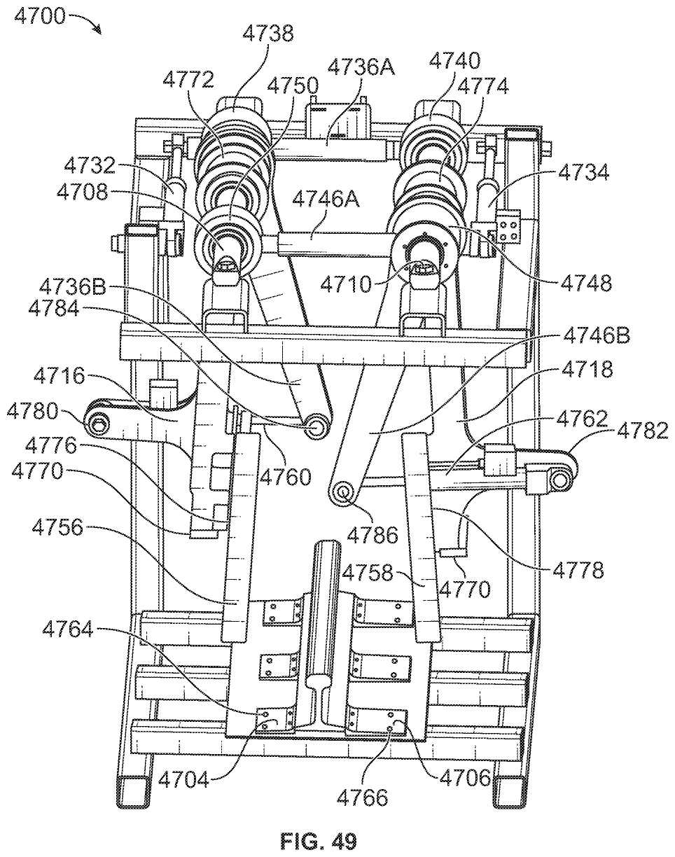

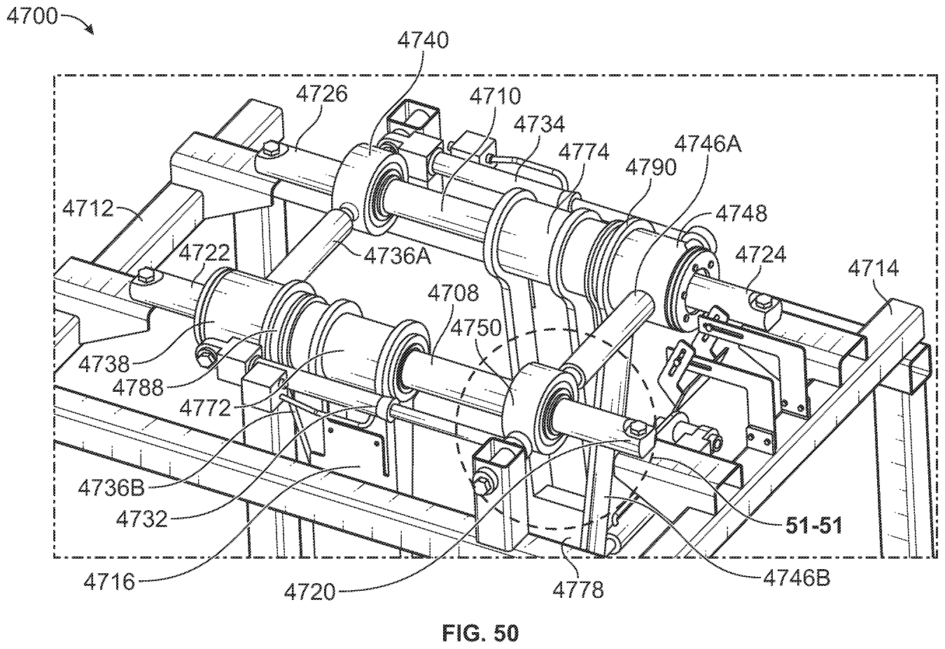

FIG. 47 illustrates a perspective view of one example of a positioning system 100 in accordance with one embodiment. FIG. 48 illustrates a top view of the positioning system. FIG. 49 illustrates a front view of the positioning system. FIG. 50 illustrates a perspective partial top view of the positioning system. FIGS. 47 through 50 will be discussed together herein. The positioning system may be coupled with a frame of a vehicle system (not shown). The vehicle system may move the positioning system along a vehicle route, such as a track, and the positioning system may control movement of one or more discharge devices, such as hydraulic hammers, that may dispense fasteners, such as rail spikes, into rail plate holes. For example, the vehicle system may provide macro type movement of the positioning system to advance the positioning system along the vehicle route, and the positioning system may provide precise or micro-type movement of the one or more discharge devices to position the discharge devices in alignment with rail plate holes. Various sensors, in one embodiment, may be used for the alignment. And, in one embodiment, a feedback system includes one or more sensors that monitor for obstructions and/or misalignment of the fastener relative to the plate hole.

In the illustrated embodiment of FIGS. 47-50, a single positioning system is illustrated. For example, the positioning system is coupled with the vehicle frame such that the positioning system moves along a single track 4702 of the vehicle route. Optionally, the vehicle system may include a second positioning system that may be coupled with the vehicle system such that the second positioning system moves along a second track of the vehicle route. For example, the vehicle route may be rail track that includes two rails. The first positioning system may be coupled with the vehicle system such that the first positioning system is suspended over a first rail of the track, and the second positioning system may be coupled with the vehicle system such that the second positioning system is suspended over a second rail of the track. In one embodiment, the vehicle system may include a single positioning system, and movement of the vehicle system in a first direction along the route may suspend the positioning system over the first rail of the track. The vehicle system may turn or rotate (e.g., 180 degrees) such that return movement of the vehicle system in a second direction (e.g., opposite the first direction) along the route places the positioning system over the second rail of the track.

In the illustrated embodiment, the positioning system is coupled with a first portion 4712 of the vehicle frame and a second portion 4714 of the vehicle frame. The first and second portions of the vehicle frame shown in FIGS. 47-50 is for illustrative purposes only. In alternative embodiments, the positioning system may be coupled with the vehicle frame via alternative arrangements.

The positioning system includes a first shaft 4708 that extends along a first axis 4728 between a first end 4720 and a second end 4722. The first end of the first shaft is coupled with the first portion of the vehicle frame, and the second end of the first shaft is coupled with the second portion of the vehicle frame. The positioning system also includes a second shaft 4710 that extends along a second axis 4730 between a third end 4724 and a fourth end 4726. The third end of the second shaft is coupled with the first portion of the vehicle system, and the fourth end of the second shaft is coupled with the second portion of the vehicle system.

In the illustrated embodiment, the first and second shafts are substantially parallel with each other. Alternatively, the first and second shafts may not be parallel with each other. For example, the first shaft may be out of parallel with the second shaft by about 10 millimeters (mm), by about 25 mm, by about 50 mm, by about 100 mm, or the like. For example, machining tolerances of the first and second shafts, and/or other components of the positioning system, may result in the first and second shafts not being parallel with each other. The first shaft may be radially offset from the second shaft in one or more of the X-direction, Y-direction, and/or Z-direction.

A first discharge device 4756, shown in FIG. 49, is coupled with the first shaft via a first discharge device bracket 4716. The first discharge device bracket includes a first bracket bushing 4772 that receives the first shaft therein. The first discharge device bracket also includes a first bracket device mounting portion 4776. In the illustrated embodiment, the first bracket device mounting portion is a substantially planar component that is coupled with the first discharge device, such as via one or more coupling features and/or components. The first discharge device bracket also includes a cylinder mounting portion 4780 that extends a distance away from the first bracket device mounting portion. In the illustrated embodiment, the cylinder mounting portion is an extension post that extends away from the first discharge device.

The positioning system also includes a second discharge device 4758 (shown in FIG. 49). Like the first discharge device, the second discharge device is coupled with second shaft via a second discharge device bracket 4718. The second discharge device bracket includes a second bracket bushing 4774 that receives the second shaft therein. The second discharge device bracket also includes a second bracket device mounting portion 4778. In one or more embodiments, the second discharge device is coupled with the second bracket device mounting portion via one or more coupling features and/or coupling components. The second discharge device bracket also includes a cylinder mounting portion 4782 that extends a distance away from the second bracket device mounting portion. Like the first discharge device bracket, the cylinder mounting portion of the second discharge device bracket is shown as an extension post that extends away from the second discharge device.

The positioning system also includes plural links that are coupled with the first and second shafts, and the first and second discharge devices via the first and second discharge device brackets. For example, the positioning system includes one or more first links 4736A, 4736B that are coupled with the first discharge device via the first discharge device bracket, and the positioning system includes one or more second links 4746A, 4746B that are coupled with the second discharge device via the second discharge device bracket. The first and second links control movement of the first and second discharge devices via the first and second discharge device brackets. For example, the first discharge device may move in a first direction 4742 of movement and a second direction 4744 of movement. The first direction of movement includes rotation of the first discharge device about the first axis, and the second direction of movement includes linear motion of the first discharge device along the first axis. Additionally, the second discharge device may move in a third direction 4752 of movement and a fourth direction 4754 of movement. The third direction of movement includes rotation of the second discharge device about the second axis, and the fourth direction of movement includes linear motion of the second discharge device along the second axis.

At least one of the first links 4736A, 4736B extends between the first and second shafts, and is coupled with the first discharge device. For example, in the illustrated embodiment, the first link 4736A extends between the first and second shafts and is operably coupled with the first discharge device via the first discharge device bracket. For example, the first link 4736A includes a first bushing 4738 disposed at a first end of the first link that is coupled with the first shaft, and a second bushing 4740 disposed at a second end of the first link that is coupled with the second shaft. The first bushing is coupled with a portion of the first discharge device bracket. The first bushing of the first link 4736A is also coupled with a first cylinder 4732 at a first end of the first cylinder. A second, opposite end of the first cylinder is coupled with the vehicle frame. For example, the first cylinder controls movement of the first link 4736A, in a linear direction, which controls movement of the first discharge device via the first discharge device bracket in the second direction of movement (e.g., the linear motion of the first discharge device). For example, movement of the first cylinder causes movement of the first and second bushings of the first link 4736A along the first and second shafts, respectively.

The first link 4736B includes a shaft mounting end 4788 that is coupled with the first shaft, and a cylinder mounting portion 4784 that is disposed a distance away from the first shaft. The first link 4736B is coupled with the first discharge device bracket via a third cylinder 4760 that extends between the cylinder mounting portion of the first link and the cylinder mounting portion of the first discharge device bracket. The third cylinder is a linear cylinder that controls rotational movement of the first discharge device in the first direction about the first shaft.

At least one of the second links 4746A, 4746B extends between the first and second shafts, and is coupled with the second discharge device. For example, the second link 4746A extends between the first and second shafts, and is operably coupled with the second discharge device via the second discharge device bracket. For example, the second link 4746A includes a first bushing 4748 disposed at a first end of the second link that is coupled with the second shaft, and a second bushing 4750 disposed at a second end of the second link that is coupled with the first shaft. The first bushing is coupled with a portion of the second discharge device bracket. The first bushing of the second link 4746A is also coupled with a second cylinder 4734 at a first end of the second cylinder. A second, opposite end of the second cylinder is coupled with a portion of the vehicle frame. For example, the second cylinder controls movement of the second link 4746A in a linear direction, which controls movement of the second discharge device via the second discharge device bracket in the fourth direction of movement (e.g., the linear motion of the second discharge device). For example, movement of the second cylinder causes movement of the first and second bushings of the second link 4746A along the second and first shafts, respectively.

The second link 4746B includes a shaft mounting end 4790 that is coupled with the second shaft, and a cylinder mounting portion 186 that is disposed a distance away from the second shaft. The second link 4746B is coupled with the second discharge device bracket via a fourth cylinder 4762 that extends between the cylinder mounting portion of the second link and the cylinder mounting portion of the second discharge device bracket. The fourth cylinder is a linear cylinder that controls rotational movement of the second discharge device in the third direction about the second shaft.

The first link 4736A allows movement of the first discharge device in the second direction separately or independent of movement of the first discharge device in the first direction (e.g., via the first link 4736B). Additionally, the first link 4736B allows movement of the first discharge device in the first direction separately or independent of movement of the first discharge device in the second direction (e.g., via the first link 4736A). The first links 4736A and 4736B also allow movement of the first discharge device separately or independently of movement of the second discharge device. For example, the first discharge device may move in the first direction independently of movement of the first discharge device in the second direction, and may move independently of movement of the second discharge device in any direction.

The second link 4746A allows movement of the second discharge device in the fourth direction separately or independently of movement of the second discharge device in the third direction. The second link 4746B allows movement of the second discharge device in the third direction separately or independently of movement of the second discharge device in the fourth direction. Additionally, the second links 4746A, 4746B allow movement of the second discharge device separately or independently of movement of the first discharge device. For example, the second discharge device may move in the third direction independently of movement of the second discharge device in the fourth direction, and may move independently of movement of the first discharge device in any direction.

For example, any movement of the first discharge device is independent of any movement of the second discharge device. The first and third cylinders may control movement of the first discharge device that does not change or cause any movement of the second discharge device. Similarly, the second and fourth cylinders may control movement of the second discharge device that does not change or cause any movement of the first discharge device. The one or more first links may control movement of the first discharge device to move to one or more positions relative to the first and second shafts, and independent of the second discharge device. Additionally, the one or more second links may control movement of the second discharge device to move to one or more positions relative to the first and second shafts, and independent of the first discharge device.

In one or more embodiments, the first, second, third, and fourth cylinders may be automatically and/or semi-automatically controlled by a controller, such as a controller (not shown) disposed onboard the vehicle system. Optionally, one or more of the cylinders may be controlled via a controller disposed off-board the vehicle system, such as a controller of a back-office server, a controller of a portable or transferable device (e.g., a tablet, a smart phone, an alternative hand-held electronic device, or the like), or the like. In another embodiment, one or more cylinders may be at least partially manually controlled, such as by an operator of the vehicle system, an operator of a remote vehicle system (e.g., the back-officer server), an operator disposed off-board the vehicle system (e.g., an operator that may be walking along the vehicle route), or the like. The controller receives data from various sensors (such as pressure sensors, optical sensors, and the like) and may initiate actuators (solenoids, hydraulics, pneumatics, and the like) and/or energize motors to effectuate the controls.

In one or more embodiments, the one or more cylinders may be controller (e.g., automatically, manually, semi-automatically, or the like), to move the first and second discharge devices toward target positions. For example, the first discharge device is allowed and controlled to move in the first and/or second directions to move toward a first target location 4704, and the second discharge device is allowed and/or controller to move in the third and/or fourth directions to move toward a second target location 4706 (shown in FIGS. 47 and 49). The first and second target locations may be disposed at different locations along the vehicle route. For example, the first target location may be a location of a first hole 4764 disposed in and/or alongside the vehicle route. The first hole may be shaped and/or sized to receive a first fastener (not shown) from the first discharge device. Similarly, the second target location may be a location of a second hole 4766 disposed in and/or alongside the vehicle route. The second hole may be shaped and/or sized to receive a second fastener (not shown) from the second discharge device.

In one or more embodiments, the holes may be holes that extend through rail plates, and the first and second fasteners may be rail spikes that may be directed into and/or out of the holes of the rail plates. The holes may be prefabricated into the rail plates, or optionally the rail spikes may be driven into the rail plates from the first and/or second discharge devices may form the holes in the rail plates. In one embodiment, the first and/or second discharge devices may be used to remove rail spikes from holes. Optionally, the positioning system may include an alternative device that may be used to remove rail spikes from the holes, such as while the vehicle system is moving along the vehicle route. For example, the positioning system may include one or more removal devices (not shown), and the first and/or second discharge devices. The removal devices may remove existing fasteners (e.g., rail spikes) from rail plates, and the first and/or second discharge devices may direct new fasteners into the holes of the rail plates. For example, the existing rail spikes may be broken, may be damaged, may be missing, may include rust or other contaminating material, or the like. In one embodiment, the fastener is a rivet and the holes are in structural supports (such as steel beams and plates). In another embodiment, the fasteners are nails and the holes are created by the fastener being pressed into a wood substrate.

In one or more embodiments, the positioning system may include one or more cameras (not shown) that may capture visual data of the positioning and/or placement of the first and/or second discharge devices. Optionally, the cameras may detect and/or confirm alignment or misalignment of the first and second discharge devices and the first and second holes into which the discharge devices may drive the fasteners. In one or more embodiments, a camera may obtain still images and/or video of the movement of the discharge devices toward the target locations, may capture images and/or video responsive to the first and second discharge devices being moved into fastener placement and/or fastener removal positions, such as to confirm alignment of the discharge devices with the holes, or the like.

In one or more embodiments, the positioning system may include one or more sensors 4770 that may sense the release of the first and/or second fasteners from the first and/or second discharge devices, respectively. For example, the one or more sensors may be visual sensors (cameras), positioning sensors, pressure sensors, impact sensors, or the like. The sensors may detect and/or sense that one or more fasteners have been released from the first and/or second discharge devices, an orientation of the fasteners and/or a direction in which the fasteners were released from the discharge devices, placement of the released fasteners, an amount or level of impact or force required to drive the fasteners into the holes, or the like. In one or more embodiments, the sensors may automatically communicate the sensed data, such as with a controller of the vehicle system, with an off-board controller, a remote controller device, or the like.

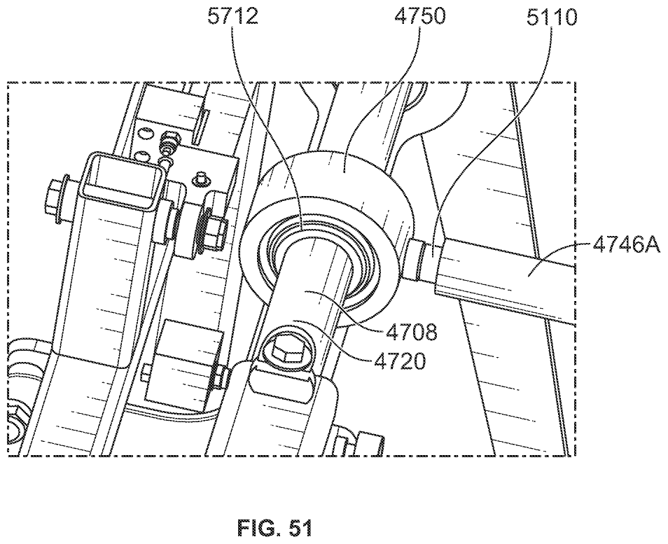

FIG. 51 illustrates a magnified portion 51-51 of the positioning system shown in FIG. 50. In the magnified portion illustrated in FIG. 51, the first shaft extends between the first end 4720 (shown) and the second end. The second bushing 4750 of the second link 4746A is operably coupled with the first shaft. In one or more embodiments, the first and second shafts may not be parallel with each other. For example, the first or second shaft may be radially offset from the other shaft in one or more of an X-direction a Y-direction, or a Z-direction. Movement of the second cylinder (shown in FIG. 50) causes linear movement of the second bushing along the first shaft. In one or more embodiments, the second bushing may include one or more bearings 5112, such as spherical bearings. Additionally, the second link may include a slip joint 5110 disposed proximate to the second bushing. Additionally or alternatively, the second link may include one or more bearings disposed within the first bushing 4748 of the second link. Optionally, the second link may additionally or alternatively include a slip joint disposed proximate to the first bushing.

The bearings and/or the slip joint(s) of the second link may be used to adjust placement of the second link relative to the first shaft and/or the second shaft, such as while the second link moves in the linear direction along the first shaft. For example, the bearings and/or the slip joint(s) may reduce the likelihood of the second bushing and/or the second link from jamming, getting stuck, or the like, in the event the first and second shafts are not parallel with each other, that the first and/or second shafts are out of tolerance, or the like, relative to a link that does not include the bearings and/or the slip joint(s). Additionally, the first link 4736A that extends between the first and second shafts may also include one or more bearings (e.g. disposed within the first and/or second bushings of the first link), may include one or more slip joints at locations between the first and second bushings of the first link, or the like.

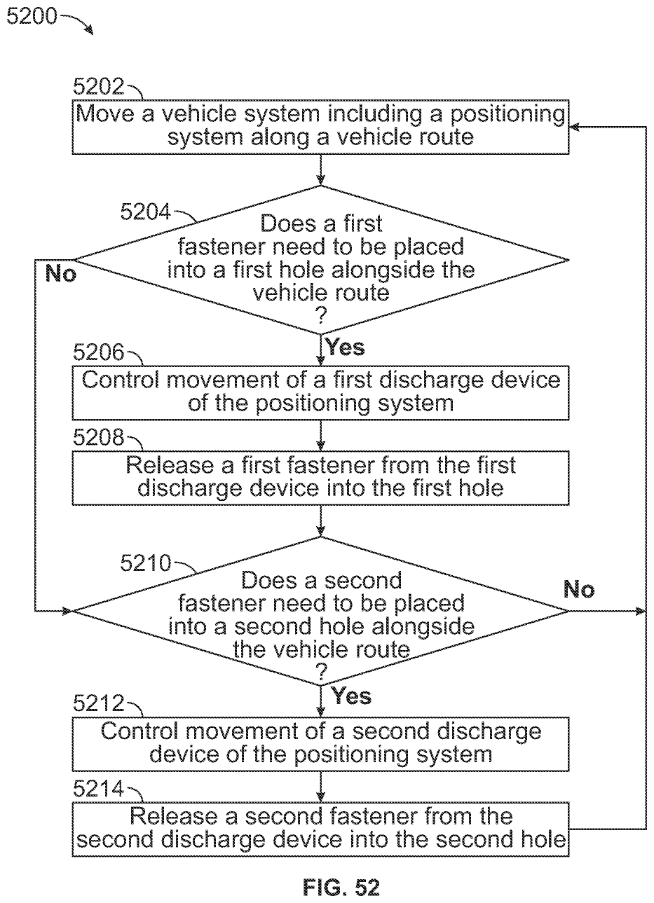

FIG. 52 illustrates one example of a flowchart 5200 of a method for controlling a positioning system, such as a positioning system coupled with a vehicle system. At step S208, a vehicle system that includes a positioning system coupled therewith is moved along a vehicle route. The vehicle system may be a vehicle that is used to repair, replace, install, or the like, railroad stakes, and the vehicle route may be a track. Optionally, the vehicle system may be an alternative vehicle system that may be used to repair, replace, install, or the like, other components or features of another route (e.g., paint lines of a road, fencing or guide rails or tracks along a route, or the like. The vehicle system may be controlled to move along the route. In one embodiment, the vehicle system may be automatically controlled, such as by an onboard controller, by an off-board remote controller, or the like. In another embodiment, the vehicle system may be manually and/or semi-manually controlled, such as by an operator onboard and/or off-board the vehicle system.

At step S204, a determination is made whether a first fastener needs to be placed into (or removed from and replaced) a first hole disposed alongside the vehicle route. For example, the first fastener may need to be positioned within a first hole of a rail plate disposed alongside the vehicle route. In one embodiment, the rail plate may include plural holes, and one or more of the plural holes may need to receive a first fastener. If one or more first fasteners need to be placed within one or more first holes, flow of the method proceeds toward step S206.

At step S206, movement of a first discharge device of the positioning system is controlled to move the first discharge device to align the first fasteners of the first discharge device with at least one of the first holes. For example, the vehicle system may move the positioning system toward one or more rail plates disposed at different distances along the vehicle route, and the positioning system may control movement of the first discharge device to align the first discharge device with the first hole(s) that will receive a first fastener. The positioning system may be similar to the positioning system shown in FIGS. 47-50, such that movement of the first discharge device is controlled by one or more cylinders controlling movement of one or more first links to move the first discharge device. For example, one of the first links may control and/or allow movement of the first discharge device in a first direction, and one or more other first links may separately control movement of the first discharge device in a different, second direction. For example, movement of the first discharge device in one direction is independent or separate from movement of the first discharge device in another direction.

At step S208, the first discharge device may release a first fastener from the first discharge device toward and/or into the first hole. Optionally, the first discharge device may remove a fastener from the first hole, such as a fastener that is damaged or otherwise compromised.

Returning to step S204, if no first fasteners need to be placed in any of the one or more first holes, then flow of the method proceeds toward step S210. At step S210, another determination is made whether a second fastener needs to be placed into a second hole alongside the vehicle route. For example, the first holes may be disposed on a first side of the vehicle route, and the second holes may be disposed on an opposite, second side of the vehicle route. If no second fastener needs to be placed into any of plural second holes, or if no second fasteners need to be removed from any of the plural second holes, then flow of the method returns to step S202, and the vehicle system may move along the vehicle route such as to advance the positioning system to another location along the vehicle route. Alternatively, if at least one second fastener needs to be placed into a second hole, flow of the method proceeds toward step S212.

At step S212, movement of a second discharge device of the positioning system is controlled to move the second discharge device to align the second fastener(s) of the second discharge device with at least one of the second holes. For example, the vehicle system may move the positioning system toward one or more rail plates disposed at different distances along the vehicle route, and the positioning system may control movement of the second discharge device to align the second discharge device with the second hole(s) that will receive a second fastener. In one embodiment, movement of the second discharge device may be controlled by one or more cylinders controlling movement of one or more second links to move the second discharge device. For example, one of the second links may control and/or allow movement of the second discharge device in a third direction, and one or more other second links may separately control movement of the second discharge device in a different, fourth direction. For example, movement of the second discharge device in one direction is independent or separate from movement of the second discharge device in another direction. Additionally, movement of the second discharge device in any direction is separate and independent of movement of the first discharge device. For example, the second discharge device may be moved to a different location without changing a position of the first discharge device.

At step S214, the second discharge device may release a second fastener from the second discharge device toward and/or into the second hole. Optionally, the second discharge device may remove a fastener from the second hole, such as a fastener that is damaged or otherwise compromised. Flow of the method may return to step S202, and the vehicle system may move the positioning system to another location along the route.

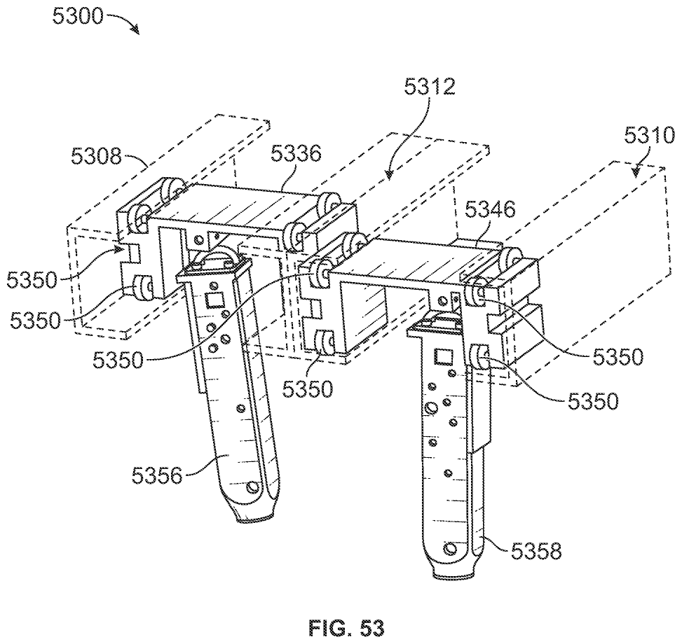

FIG. 53 illustrates a perspective view of a positioning system 5300 in accordance with one embodiment. Like the positioning system shown in FIGS. 47-50, the positioning system 5300 includes a first discharge device 5356 and a second discharge device 5358. Movement of the first discharge device is separate or independent from movement of the second discharge device. The system includes a first shaft 5308 and a second shaft 5310, and an additional third shaft 5312. The first discharge device is coupled with the first shaft and the third shaft via a first link 5336, and the second discharge device is coupled with the second shaft and the third shaft via a second link 5346. The first and second links each include one or more wheels or rollers 5350 that may rotate to move along the first, second, and third shafts to move the first and second discharge devices in forward and rearward directions. For example, the first, second, and/or third shafts may be or include tracks along which the wheels or rollers may rotate to move the first and second discharge devices in different directions. The first and second discharge devices are coupled with the shafts, respectively, in order to control and allow independent movement of the first and second discharge devices relative to the other.

The positioning system may also include one or more cylinders (not shown) extending between the first shaft and the first discharge device, and one or more cylinders (not shown) extending between the second shaft and the second discharge device. For example, the cylinders may control linear movement of the first and second discharge devices in rotational directions about the first and second shafts, respectively.

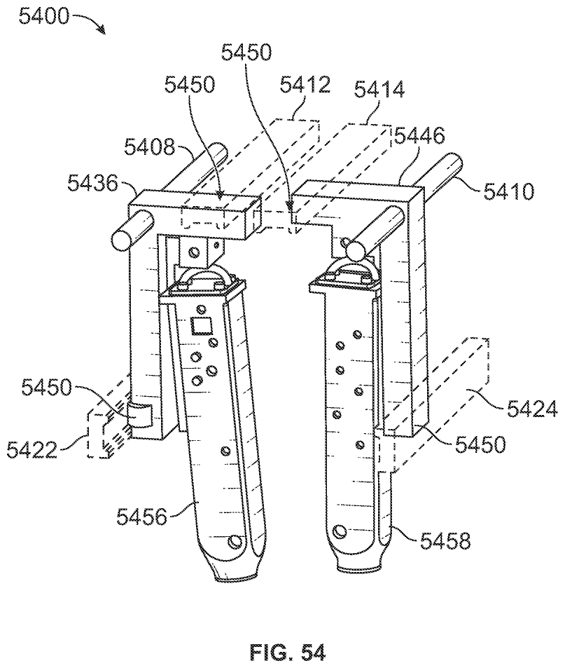

FIG. 54 illustrates a perspective view of a positioning system 5400 in accordance with another embodiment. The positioning system includes first and second discharge devices 5456, 5458 that dispense fasteners into holes along the vehicle route. The positioning system includes three sets of shafts, including first and second shafts 5408, 5410, third and fourth shafts 5412, 5414, and fifth and sixth shafts 5422, 5424. The first discharge device is operably coupled with the first, third, and fifth shafts via a first link 5436. The first and second discharge devices are coupled with the shafts, respectively, in order to control and allow independent movement of the first and second discharge devices relative to the other.

The first discharge device moves relative to the first, third, and fifth shafts via one or more wheels or rollers 5450. The second discharge device is operably coupled with the second, fourth, and sixth shafts via a second link 5446. The second discharge device moves relative to the second, fourth, and sixth shafts via one or more wheels or rollers 5450. For example, like the positioning system 5300 shown in FIG. 53, the positioning system 5400 shown in FIG. 54 includes one or more shafts that include tracks along which the wheels or rollers may rotate to move the first and second discharge devices in different directions.

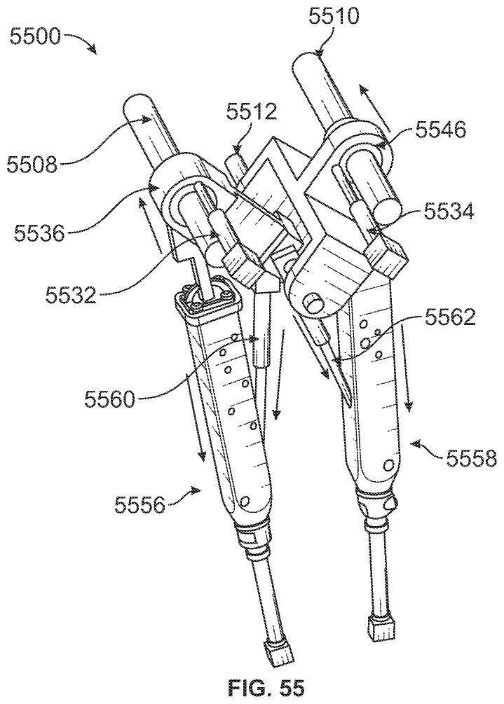

FIG. 55 illustrates a perspective view of a positioning system 5500 in accordance with one embodiment. The positioning system includes first and second discharge devices 5556, 5558 that are moved independent of each other. The first discharge device is coupled with a first shaft 5508, and the second discharge device is coupled with a second shaft 5510. The first and second discharge devices are each also coupled with a common third shaft 5512 via one or more first or second links 5536, 5546. The positioning system includes plural cylinders 5532, 5560 that control movement of the first discharge device to move in one or more directions relative to the first and third shafts. The positioning system includes plural cylinders 5534, 5562 that control movement of the second discharge device to move in one or more directions relative to the second and third shafts. For example, the first and second discharge devices are coupled with the first, second, and/or third shafts, respectively, in order to control and allow independent movement of the first and second discharge devices relative to the other.

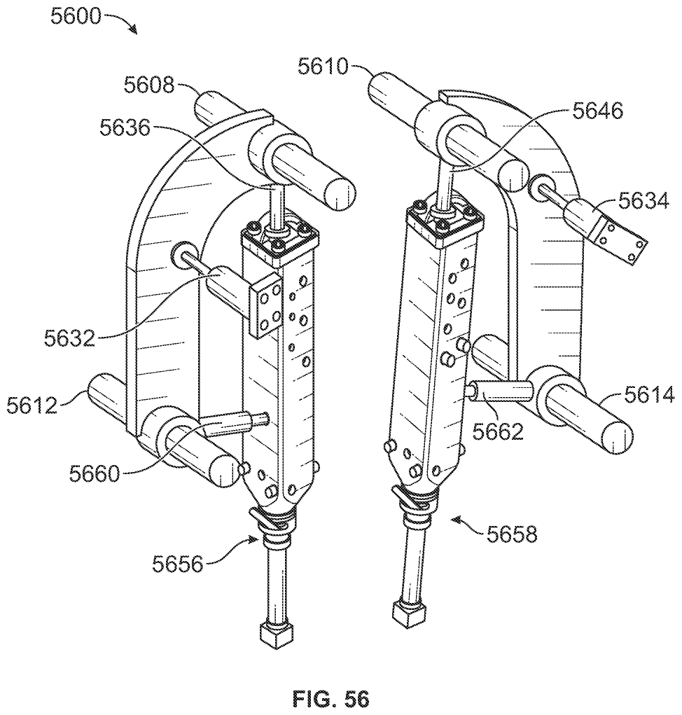

FIG. 56 illustrates a perspective view of a positioning system 5600 in accordance with one embodiment. The positioning system includes first and second discharge devices 5656, 5658 that are moved independent of each other. The positioning system includes two sets of shafts, including first and second shafts 5608, 5610, and third and fourth shafts 5612, 5614. The first discharge device is coupled with the first and third shafts via one or more first links 5636 and plural cylinders 5632, 5660. The second discharge device is coupled with the second and fourth shafts via one or more second links 5646 and plural cylinders 5634, 5662. The cylinders coupled with the first discharge device control movement of the first discharge device in two or more different directions, and the cylinders coupled with the second discharge device control movement of the second discharge device in two or more different directions. Movement of the first discharge device is controlled independent of movement of the second discharge device. Additionally, movement of the first discharge device in one direction is independent of movement of the first discharge device in another direction. Additionally, movement of the second discharge device in one direction is independent of movement of the second discharge device in another direction.

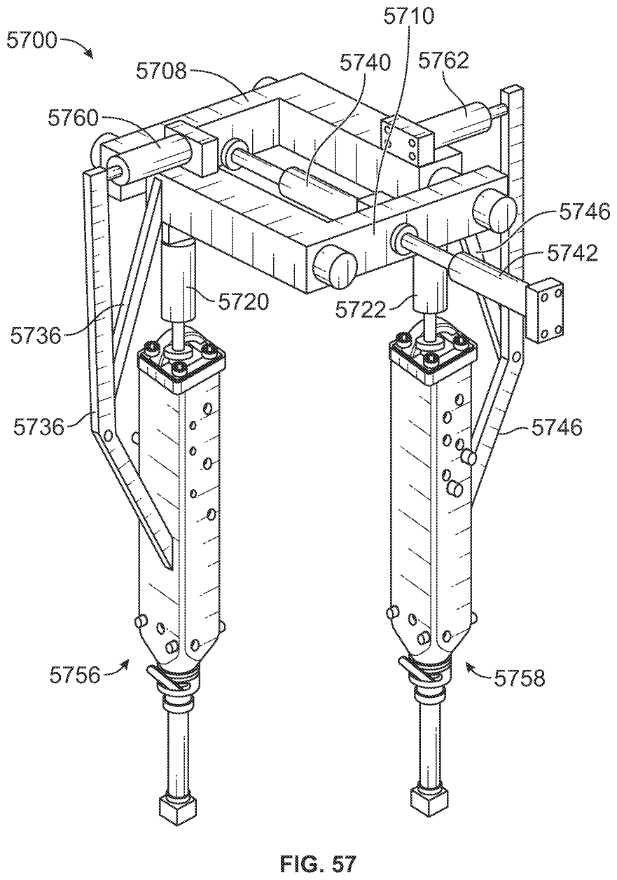

FIG. 57 illustrates a perspective view of a positioning system 5700 in accordance with one embodiment. The positioning system includes a first discharge device 5756 that is coupled with a first shaft 5708 via one or more first links 5736. In one or more embodiments, the positioning system may also or alternatively include a second discharge device 5758 that is coupled with a second shaft 5710 via one or more second links 5746. In the illustrated embodiment, the first and second shafts are L-shaped brackets. The positioning system includes plural cylinders 5720, 5760, that control movement of the first discharge device in two or more different directions, and the positioning system includes plural cylinders 5722, 5762 that control movement of the second discharge device in two or more different directions. In one embodiment, the positioning system may include plural additional cylinders 5740, 5742 that control movement of the first shaft relative to the second shaft. For example, the cylinders control up and down linear movement of the discharge devices, forward and backward linear movement of the discharge devices, and rotational movement of the discharge devices.

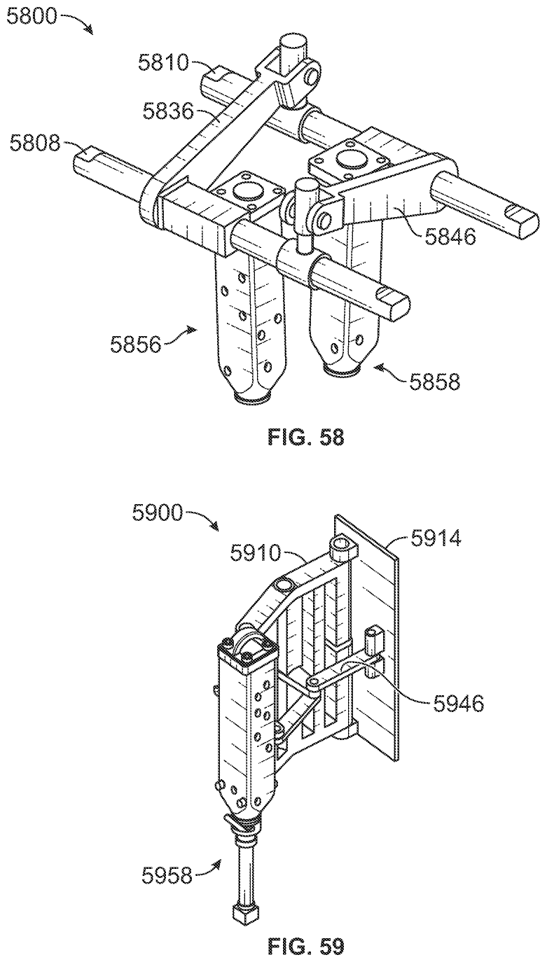

FIG. 58 illustrates a perspective view of a positioning system 5800 in accordance with one embodiment. The positioning system includes a first discharge device 5856 that is operably coupled with a first shaft 5808, and a second discharge device 5858 that is operably coupled with a second shaft 5810. The system also includes a first link 5836 that is operably coupled with the first discharge device, and extends between the first and second shafts, and a second link 5846 that is operably coupled with the second discharge device, and extends between the first and second shafts. In one embodiment, the positioning system may include one or more cylinders (not shown) that control movement of the first discharge device that is independent or separate from movement of the second discharge device relative to the first and/or second shafts.

FIG. 59 illustrates a perspective view of a positioning system 5900 in accordance with one embodiment. The positioning system includes a first discharge device 5958 that is operably coupled with a portion of a vehicle frame 5914 via one or more brackets 5910 and one or more links 5946. The positioning system may include one or more linear cylinders (not shown) that may control movement of the first discharge device relative to the portion of the vehicle frame. For example, the cylinders may control movement of the first discharge device in a circular direction relative to the vehicle frame. Additionally or alternatively, the brackets and/or links may be arranged to allow movement of the first discharge device in a linear up and down motion.

The above description is illustrative and not restrictive. For example, the above-described embodiments (and/or aspects thereof) may be used in combination with each other. In addition, modifications may be made to adapt a situation or material to the teachings of the inventive subject matter without departing from its scope. While the dimensions and types of materials described herein are intended to define the parameters of the inventive subject matter, they are not limiting and are example embodiments. Many other embodiments will be apparent to those of ordinary skill in the art upon reviewing the above description. The scope of the inventive subject matter should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

The foregoing description of certain embodiments of the inventive subject matter will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (for example, processors or memories) may be implemented in a single piece of hardware (for example, a general-purpose signal processor, microcontroller, random access memory, hard disk, and the like). Similarly, the programs may be stand-alone programs, may be incorporated as subroutines in an operating system, may be functions in an installed software package, and the like. The various embodiments are not limited to the arrangements and instrumentality shown in the drawings. As used herein, an element or step recited in the singular and proceeded with the word “a” or “an” should be understood as not excluding plural of said elements or steps, unless such exclusion is explicitly stated. Furthermore, references to “one embodiment” of the inventive subject matter are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the inventive subject matter and also to enable a person of ordinary skill in the art to practice the embodiments of the inventive subject matter, including making and using any devices or systems and performing any incorporated methods. The patentable scope of the inventive subject matter is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A fastener system, comprising:
a controller including one or more processors configured to obtain image information associated with a tie plate, the tie plate having one or more holes shaped to receive one or more fasteners; and
a fastener driving unit configured to drive the one or more fasteners into the one or more holes in the tie plate,
the controller configured to control movement of the fastener driving unit to move the fastener driving unit to a location corresponding to the one or more holes, and
the controller configured to control the movement of the fastener driving unit to drive the one or more fasteners into one or more holes.

2. The fastener system of claim 1, wherein the fastener driving unit is configured to be operably coupled with a fastener magazine that provides the one or more fasteners to the fastener driving unit.

3. The fastener system of claim 1, wherein the controller is configured to determine a hole pattern of the tie plate based on the image information, the controller configured to control the movement of the fastener driving unit to drive the one or more fasteners into the one or more holes based on the hole pattern of the tie plate.

4. The fastener system of claim 3, wherein the controller is configured to divide the hole pattern into one or more zones based at least in part on one or more locations of the one or more holes in the tie plate.

5. The fastener system of claim 1, wherein the controller is configured to compare the image information associated with the tie plate with one or more designated tie plate designs.

6. The fastener system of claim 1, further comprising a sensor configured to capture the image information, wherein the controller is configured to obtain the image information from the sensor.

7. The fastener system of claim 6, wherein the sensor is one or more of an infrared camera, a stereoscopic camera, or a digital video camera.

8. The fastener system of claim 6, wherein the controller is configured to analyze the image information and identify one or more vegetation features within a field of view of the sensor.

9. The fastener system of claim 1, wherein the fastener driving unit is configured to be operably coupled with a supporting frame of a vehicle system having a propulsion system configured to move the fastener driving unit along a route toward the tie plate.

10. The fastener system of claim 1, wherein the tie plate is configured to secure a wayside structure at a location alongside a route along which the fastener system is configured to move.

11. The fastener system of claim 1, wherein the image information is two-dimensional image information and the controller is configured to generate three-dimensional image information based at least in part on the two-dimensional image information.

12. The fastener system of claim 1, wherein the fastener driving unit includes a positing system comprising:
a first shaft configured to be coupled with a frame of a vehicle system, the first shaft elongated from a first end to an opposite second end along a first axis;
a second shaft configured to be coupled with the frame of the vehicle system, the second shaft elongated from a third end to a fourth end along a second axis;
a first discharge device coupled with the first shaft and configured to move in at least first and second directions toward a first target location;
a second discharge device coupled with the second shaft and configured to move in at least third and fourth directions toward a second target location; and
one or more first links operably coupled with the first discharge device, the one or more first links configured to control movement of the first discharge device in the first and second directions; and
one or more second links operably coupled with the second discharge device, the one or more second links configured to control movement of the second discharge device in the third and fourth directions, and
the one or more first links are configured to allow movement of the first discharge device in the first direction separately of movement of the first discharge device in the second direction and separately of movement of the second discharge device, and
the one or more second links are configured to allow movement of the second discharge device in the third direction separately of movement of the second discharge device in the fourth direction and separately of movement of the first discharge device.

13. A method comprising:
obtaining image information associated with a tie plate, the tie plate having one or more holes shaped to receive one or more fasteners;
controlling movement of a fastener driving unit to move the fastener driving unit to a location corresponding to the one or more holes; and
controlling the movement of the fastener driving unit to drive the one or more fasteners into the one or more holes.

14. The method of claim 13, further comprising:
determining a hole pattern of the tie plate based on the image information; and
controlling the movement of the fastener driving unit to drive the one or more fasteners into the one or more holes based on the hole pattern.

15. The method of claim 13, further comprising dividing the hole pattern into one or more zones based at least in part on one or more locations of the one or more holes in the tie plate.

16. The method of claim 13, further comprising comparing the image information associated with the tie plate with one or more designated tie plate designs.

17. The method of claim 13, wherein the image information is two-dimensional image information, and further comprising generating three-dimensional image information based at least in part on the two-dimensional image information.

18. The method of claim 13, wherein the tie plate is configured to secure a wayside structure at a location alongside a route along which the fastener system is configured to move.

19. The method of claim 13, further comprising:
obtaining the image information from a sensor configured to capture the image information;
analyzing the image information; and
identifying one or more vegetation features within a field of view of the sensor.

20. A method comprising:
initiating performance of a task on a target object, the task having an associated series of sub-tasks, the sub-tasks having one or more capability requirements;
assigning to a first robotic machine a first sequence of sub-tasks within the associated series of sub-tasks, the first robotic machine configured to operate according to a first mode of operation;
assigning a second robotic machine a second sequence of sub-tasks within the associated series of sub-tasks, the second robotic machine configured to operate according to a second mode of operation; and
operating the first robotic machine in the first mode of operation and operating the second robotic machine in the second mode of operation,
the first robotic machine being a vehicle system the second robotic machine being a fastener driving unit, and the target object being a tie plate having one or more holes, the first sequence of sub-tasks including assigning the vehicle system to move the fastener driving unit towards the tie plate, and the second sequence of sub-tasks including assigning the fastener driving unit to drive one or more fasteners into one or more holes in the tie plate.
